(19) United States
(12) Patent Application Publication
(10) Pub. No.: US 2026/0062157 A1
(43) Pub. Date: Mar. 5, 2026

(54) SYSTEMS, APPARATUS, AND METHODS FOR TREATMENT OF OUTDOOR AND INDOOR VERTICAL OR INCLINED SURFACES VIA AERIAL VEHICLES

(71) Applicant: Alert Venture Foundry, LLC, Boston, MA (US)

(72) Inventor: John Lert, Boston, MA (US)

(73) Assignee: Alert Venture Foundry, LLC, Boston, MA (US)

(21) Appl. No.: 19/381,939

(22) Filed: Nov. 6, 2025

Related U.S. Application Data
(63) Continuation of application No. PCT/US2024/028198, filed on May 7, 2024.
(60) Provisional application No. 63/500,609, filed on May 7, 2023.

(51) Int. Cl. B64U 50/34; B64U 10/14; B64U 101/29

(52) U.S. Cl. CPC B64U 50/34; B64U 10/14; B64U 2101/29; B64U 2201/10

(57) ABSTRACT

An outdoor system includes an aerial vehicle to perform one or more operations on an elevated surface with an end effector. The operation(s) performed include, but are not limited to, applying a cleaning fluid to a window, and removing a waste fluid (e.g., a mixture of cleaning fluid and detritus) from the window. In some operations, the aerial vehicle may place an end effector in physical contact with the elevated surface and controllably move the end effector across that surface along a desired trajectory. The system also includes a base station coupled to the aerial vehicle via an umbilical cord to supply the aerial vehicle cleaning fluid and electrical power. The system further includes an umbilical support system to carry and suspend the umbilical cord above the aerial vehicle during operation to appreciably reduce external (and dynamic) disturbances acting on the aerial vehicle and/or the umbilical cord.

### CROSS-REFERENCE TO RELATED APPLICATION

This application is a bypass continuation of International Application No. PCT/US2024/028198, filed May 7, 2024 and entitled, “SYSTEMS, APPARATUS, AND METHODS FOR TREATMENT OF OUTDOOR AND INDOOR VERTICAL OR INCLINED SURFACES VIA AERIAL VEHICLES,” which claims the priority benefit, under 35 U.S.C. 119 (e), of U.S. Application No. 63/500,609, filed May 7, 2024 and entitled, “SYSTEMS, APPARATUS, AND METHODS FOR CONTACT TREATMENT OF OUTDOOR AND INDOOR VERTICAL OR INCLINED SURFACES VIA AUTOMATED AUTONOMOUS VEHICLES.” Each of these applications is incorporated herein by reference in its entirety.

### BACKGROUND

A robot is a machine designed to perform one or more tasks in an automated manner with little to no human guidance. Robots are often deployed in controlled environments to perform repetitive tasks, such as fabricating parts for a product, fulfilling orders for goods, or preparing certain foods or drinks. The use of robots in these settings typically results in greater productivity, lower manufacturing and/or operating costs, and greater worker safety. More recent advances in robotics have also led to the deployment of robots in less controlled, more real-world environments. In these environments, robots are generally required to adapt to different and, in some instances, changing environments. Examples of these robots include robotic vacuum cleaners, lawnmowers, and automated construction equipment.

### SUMMARY

The Inventors have recognized and appreciated continued advancements in robotics have provided greater automation of tasks traditionally performed by humans. However, the Inventors have also recognized certain tasks that involve interactions with elevated vertical or inclined surfaces remain challenging for robots to perform (let alone automate). These tasks include, for example, cleaning the windows of a structure (e.g., a house, a multi-story building, a skyscraper), painting a structure (e.g., bridges, ships, building exteriors and interiors), or other types of contact treatments for surfaces (e.g., scrubbing, sanding, polishing, applying various coatings, etc.). As a result, human workers still perform these tasks manually, which is time consuming and, in some instances, exposes the workers to dangerous conditions.

For ground-based robots, the primary limitation lies in their inability to access elevated surfaces. Much like human workers, ground-based robots generally require a separate support system to change their vertical position with respect to a structure. For example, a suspended platform is often used to support a ground-based robot configured to clean or paint a building. The suspended platform typically includes a cable attached to a set of anchor points on the roof of the building and a motorized pulley system to change the vertical position of the platform.

Although the vertical position of a ground-based robot may be adjusted via the suspended platform, the horizontal position of the robot is typically fixed or at least limited to the width of the platform. In order for the robot to access other portions of the building, the platform and/or the robot should be detached from one set of anchor points and reattached to another set of anchor points, which is a time-consuming process that reduces the productivity of the robot. Additionally, buildings often provide a fixed set of anchor points to support a suspended platform, scaffolding, and/or the like, which limits the placement of the platform and, in some instances, prevent the robot from accessing all the surfaces of the building, particularly if the robot is fixed in position on the platform.

The challenge associated with accessing elevated surfaces may be mitigated, in part, by using an aerial vehicle capable of sustained flight. More specifically, aerial vehicles configured as robots (e.g., aerial robots capable of some amount of autonomous or automatic functionality) may provide significant advantages in accessing elevated surfaces; an aerial vehicle configured as a robot is also referred to herein and in the art as an “aerobot,” a “drone,” or an “autonomous aerial vehicle.” Compared to ground-based robots, an aerobot has appreciably more freedom to navigate and interact with the environment. In principle, an aerobot equipped with an end effector can fly to a desired surface of a structure and perform an operation on (e.g., treatment of) the surface (e.g., cleaning, painting) while remaining airborne.

Despite their potential, the Inventors have recognized aerobots have yet to be widely adopted to automate tasks that involve interactions with elevated, inclined, and/or vertical surfaces. This is due, in part, to several challenges associated with the use of an aerobot with an end effector (also referred to as a “tool”), particularly if the end effector is in physical contact with the surface. More specifically, in the context of contact treatment (e.g., window cleaning) of an elevated, inclined and/or vertical surface (e.g., a window), the Inventors have recognized and appreciated that conventional aerobots do not have the capability to perform translational and rotational movement with sufficient precision, while maintaining sufficient contact with the surface, to effectively perform the contact treatment of the surface.

For instance, the translational and rotational movement of commonly-employed conventional aerobots is unable to be controlled independently with six degrees of freedom (6-DOF). For example, one commonly-employed aerobot is a quadcopter, which includes four rotors that are each capable of producing thrust. The rotors are often rigidly affixed to a frame and arranged to generate thrust in the same direction, thus limiting the number of degrees of freedom that are independently controlled. As a result, a quadcopter is typically unable to perform certain maneuvers, such as pitching or rolling without changing position or moving laterally without rotating. This, in turn, limits the capability of commonly-employed conventional aerobots to maneuver an end effector while performing an operation. Additionally, if the aerobot is subjected to environmental or other external disturbances, such as wind, conventional aerobots may have to change their attitude and/or position to compensate, further compromising the aerobot's ability to perform an operation with sufficient precision.

Commonly-employed conventional aerobots are also typically less agile along certain degrees of freedom due to the arrangement of their thrusters. Referring again to the example of a quadcopter, the four rotors of the quadcopter are typically arranged to generate thrust along a vertical direction. This, in turn, allows the quadcopter to readily adjust its vertical position in response to external disturbances that act on the quadcopter vertically. However, the quadcopter is unable to generate a thrust in an arbitrary direction, which significantly limits its range of possible translational and rotational motion; thus, it is incapable of performing more sophisticated movement patterns that may significantly facilitate various types of contact treatment of surfaces, and is often unable to effectively compensate for external (and in some cases dynamic) disturbances (e.g., environmental conditions such as wind) acting upon the aerobot.

Additionally, the Inventors have appreciated that employing an end effector together with an aerobot would result in an outward extension of the end effector from the aerobot. Thus, any variability in the position and/or attitude of the aerobot is amplified at the end effector. For example, if the distal end of the end effector (e.g., the end that contacts the surface) is located 1 meter from the center of mass of the aerobot, an error in the attitude of the aerobot of #1 degree may result in a positioning error at the distal end of the end effector of about +2 centimeters. This error is sufficient to hinder or even prevent the aerobot from performing certain tasks, such as cleaning the edges of a window.

Moreover, if the end effector protrudes laterally (e.g., to interact with a vertical surface of a building), the weight of the end effector generally causes the aerobot to pitch or roll downwards. If the end effector physically contacts a surface, any contact force applied to the end effector (e.g., friction) also affects the attitude of the aerobot. These effects collectively result in a force and/or a torque being applied by the end effector to the aerobot, which can affect precision and accuracy with which an aerobot is positioned and/or oriented.

Some conventional aerobots also have a limited ability to carry a significant payload (e.g., fluid(s) for treating surfaces such as cleaning fluid, paint, surfactants, etc.). The limited payload of the aerobot can be addressed by connecting a cord to the aerobot that supplies any fluids required for the aerobot to perform a certain task. However, the attachment of a cord to the aerobot applies another external force and/or torque to the aerobot, thus affecting the aerobot's mobility. For example, the weight of the cord may pull the aerobot downwards. In another example, external forces applied to the cord may be directly transmitted to the aerobot. If the aerobot is operating in a windy outdoor environment, for instance, the wind can displace the cord and, in turn, the aerobot away from a desired position and/or attitude.

As a result of the above limitations, commonly-employed conventional aerobots are limited in their ability to precisely maneuver and control an end effector, particularly when the end effector is placed in physical contact with a surface. More specifically, commonly-employed conventional aerobots equipped with an end effector are notably limited in their ability to mimic the actions of a human worker using a tool to perform a task relating to contact treatment of a surface, and/or mimic the execution of a given task with the same performance result (in situations where this might be desirable). In particular, if a commonly-employed conventional aerobot equipped with an end effector is used to clean a window, the foregoing limitations (including intermittent contact of the end effector on the surface as the aerobot maneuvers around the window) may cause the aerobot to leave streaks on the window and/or miss portions of the window all together (e.g., near the edges of the window, which typically require more precise movement of the end effector). If such an aerobot is used to paint a structure, the foregoing limitations may cause the aerobot to apply an uneven coating of paint on a surface, such as a surface with patches of paint that is too thick or too thin, which is aesthetically undesirable.

In addition to the limitations of conventional aerobots, the Inventors recognized several challenges in deploying aerobots that utilize a consumable fluid (e.g., cleaning fluid, paint). For example, conventional aerobots can create a falling hazard if they lose power. Without adequate safety measures, the commercial deployment of aerobots is often limited to less populated areas where safety risks to people are appreciably less.

In view of the foregoing limitations, the present disclosure is thus directed to various inventive implementations of a system that utilizes one or more aerial vehicles, such as aerobots, configured to perform one or more operations on an elevated surface with an end effector, and various methods of using the system to perform the operation(s). The operation(s) performed by the system include, but are not limited to, applying a cleaning fluid to a window, removing a waste fluid (e.g., a mixture of cleaning fluid and detritus) from the window, and painting a structure. In particular, an operation may involve moving an end effector along an elevated surface, in some instances with the end effector in continuous physical contact with the surface. Additionally, the end effector may be configured to apply a fluid to a surface (e.g., a cleaning fluid, paint) or remove a fluid from the surface (e.g., waste fluid).

In one non-limiting implementation, an outdoor window cleaning system includes an aerial vehicle with one or more end effector(s) to perform various cleaning-related operations to a window of a structure. In one example, the aerial vehicle is an aerobot that may include an applicator end effector to apply a cleaning fluid to the window and a squeegee end effector with vacuum suction to remove waste fluid. The aerobot may be coupled to a base station on the ground via an umbilical cord (also referred to in the art as a “tether”). The base station supplies, via the umbilical cord, cleaning fluid and electrical power to the aerobot and retrieves, via the umbilical cord, waste fluid from the aerobot. The system may further include an umbilical support system to carry and suspend the umbilical cord above the aerobot during operation. Specifically, the umbilical support system may include a telescoping boom arm mounted to the base station and an umbilical pulley coupled to the distal end of the boom arm to support the umbilical cord. The system may also include a central control computer communicatively coupled to the aerobot, the base station, and the umbilical support system to retrieve various sensory data and/or transmit commands to the aerobot, the base station, and/or the umbilical support system to perform an action (e.g., change position or attitude, release or lock a winch to adjust a length of the umbilical cord, activate or deactivate respective pumps to supply cleaning fluid and/or to retrieve waste fluid).

In one aspect, the aerobot may be an omnidirectional aerobot that allows independent control of each of its six degrees of freedoms (i.e., three orthogonal translational degrees of freedom, three orthogonal rotational degrees of freedom). This may be accomplished, for example, by including four pairs of thrusters (i.e., eight thrusters total) where the thrusters in each pair are aligned to generate thrust in the same direction and the respective pairs of thrusters are oriented in different directions. During operation, different combinations of thrusters may be used to change the aerobot's position along any desired direction and/or attitude about any desired axis. Thus, the aerobot does not have to move and/or rotate about multiple axes in order to change its position and/or attitude along a single axis.

The aerobot may thus be capable of performing more complex maneuvers compared to commonly-employed conventional aerobots. For example, the aerobot may follow an arbitrary trajectory and independently rotate to change its attitude and, by extension, the orientation of an end effector. Additionally, the aerobot may change its position and/or attitude along any one of its six degrees of freedom more quickly than commonly-employed conventional aerobots. This allows the aerobot to more readily compensate for external (and dynamic) disturbances (e.g., wind) without appreciably changing its position and/or attitude during flight. Said another way, the aerobot may more readily maintain a desired trajectory and/or orientation with sufficient precision even when operating in an environment where external disturbances are present.

The improved mobility of the aerobot, in turn, may allow the aerobot to use an end effector more effectively compared to conventional aerobots, particularly if the orientation of the end effector with respect to the surface affects its performance. In other words, the aerobot may maintain a preferred orientation of an end effector while moving along any arbitrary trajectory. For example, the aerobot may orient a squeegee end effector at an angle relative to its direction of travel so that waste fluid is displaced towards one side of the squeegee. Additionally, the aerobot may maintain an end effector (e.g., an applicator end effector, a squeegee end effector) in continuous physical contact with a surface as it moves by pressing the end effector against the surface such that the contact pressure is maintained within a predetermined pressure range.

In another aspect, the magnitude of the force and/or torque applied by the end effector to the aerobot may be reduced, in part, by designing the end effector to protrude from the frame with only enough clearance to ensure the end effector is able to perform an operation without interference by other components of the aerobot. Said in another way, the end effectors may be designed such that their center of mass is located as close to the center of mass of the aerobot as allowed without causing interference between the end effector and the other components of the aerobot. In some implementations, an active end effector may be coupled to the aerobot. The active end effector includes one or more motors and one or more joints actuated by the motor(s). The motorized joints may allow the end effector to be positioned and/or oriented more precisely compared to an end effector that relies solely on the thrusters of the aerobot to control its position and/or attitude.

In yet another aspect, the umbilical support system may appreciably reduce or, in some instances, eliminate the transmission of undesirable forces and/or torques from the umbilical cord to the aerobot. For example, the umbilical pulley assembly may include a locking mechanism that, when engaged, clamps the umbilical cord in place. When the locking mechanism is engaged, the length of a first portion of the umbilical cord between the umbilical pulley assembly and the aerobot is fixed. Thus, the weight of a second portion of the umbilical cord between the umbilical pulley assembly and the base station, which may be appreciably longer than the first portion, is carried entirely by the umbilical support system and does not apply any force directly to the aerobot. Additionally, any vertical load associated with the first portion of the umbilical cord is also carried by the umbilical pulley assembly. The length of the first portion of the umbilical cord may be chosen to be sufficiently long to allow the aerobot to move within a desired operating range, but sufficiently short to reduce or, in some instances, mitigate the effect of wind on the first portion of the umbilical cord.

In another example, the umbilical support system may be configured to maintain some slack in the first portion of the umbilical cord to reduce transmission of any force and/or torque from the umbilical cord to the aerobot even as the aerobot changes position. This may be accomplished, for example, by the umbilical support system moving the umbilical pulley assembly as the aerobot moves such that the umbilical pulley assembly remains proximate to and, in some instances, directly above the aerobot. Specifically, the boom arm may extend or retract, an end pulley coupled to the umbilical pulley assembly may be lowered or raised, and/or a rotation stage supporting the boom arm may be rotated to change the position of the umbilical pulley assembly.

In yet another example, the umbilical support system may include a ballast to reduce the effect of external disturbances acting on the umbilical pulley assembly (and ultimately the aerobot). The external disturbances include, but are not limited to, a wind force and a force transmitted by the first portion of the umbilical cord between the clamp and the base station (e.g., the weight of the first portion of the umbilical cord, a tensile force if the first portion of the umbilical cord is taut). By coupling a ballast to the umbilical pulley assembly, the displacement of the umbilical pulley assembly in response to an external disturbance may be appreciably reduced, which, in turn, maintains slack in the first portion of the umbilical cord between the umbilical pulley assembly and the aerobot.

In yet another aspect, the payload of the aerobot may be reduced, in part, by using the umbilical support system and/or the base station to carry components used by the aerobot. For example, the base station may include one or more pumps to supply cleaning fluid to the applicator end effector and/or to retrieve waste fluid from the squeegee end effector. Thus, the aerobot may not include any pumps. In another example, one or more sensors (e.g., an anemometer) may be coupled to the umbilical pulley assembly instead of the aerobot. The umbilical pulley assembly may sufficiently close to the aerobot such that data obtained by the sensor(s) can be used by the aerobot to compensate for environmental conditions (e.g., wind speed and direction).

It should be appreciated that the above example implementation is non-limiting and that other example implementations of an outdoor window cleaning systems with an aerial vehicle such as an aerobot are contemplated herein. In another non-limiting implementation, the boom arm of the umbilical support system may be mounted to the roof of a structure via a roof anchor and the base station may remain on the ground. The roof anchor may be securely coupled to the roof, for example, via a suction system. In another non-limiting implementation, the base station may be deployed onto the roof and the boom arm of the umbilical support system may be directly mounted to the base station. In this example, the base station may supply only cleaning fluid and electrical power to the aerobot. In some implementations, the aerobot may include an onboard pump to suction waste fluid from the window being cleaned. In yet another non-limiting implementation, a support aerobot or an aerostat may be deployed in place of the boom arm to support and carry the umbilical cord above the aerobot used to clean the window.

It should also be appreciated that at least some of the concepts described above may be implemented in an indoor window cleaning system. For example, the aerobot may again be an omnidirectional aerobot. However, in this implementation, the aerobot may not be coupled to the base station via an umbilical cord, thus the system does not include an umbilical support system. Instead, the aerobot may have onboard pumps, onboard tanks to store cleaning fluid and/or waste fluid, and an energy storage module (e.g., a battery, a supercapacitor). The base station may include a docking port for the aerobot to land and empty its waste fluid tank, refill its cleaning fluid tank, and/or recharge the energy storage module.

It should also be appreciated that at least some of the concepts described above may be implemented in a painting system with an aerobot. For example, the aerobot may include a paint roller end effector to apply paint to a surface. The aerobot may be connected to a base station via an umbilical cord that supplies the paint to the aerobot. An umbilical support system may also be included to support the umbilical cord above the aerobot similar to the outdoor window cleaning systems.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows an example outdoor window cleaning system with an aerobot, a base station deployed on the ground, and an umbilical support system mounted directly to the base station with a boom arm and a support assembly with an umbilical pulley assembly to support an umbilical cord for the aerobot. The aerobot is shown applying a cleaning solution to a top window of the structure using an applicator end effector.

FIG. 1B shows the outdoor window cleaning system of FIG. 1A where the aerobot is shown removing waste fluid (e.g., a mixture of cleaning fluid and detritus) from a top portion of the top window using a squeegee end effector.

FIG. 1C shows the outdoor window cleaning system of FIG. 1B where the aerobot is shown removing waste fluid from a bottom portion of the top window using the squeegee end effector.

FIG. 1D shows the outdoor window cleaning system of FIG. 1C where the aerobot is shown applying the cleaning solution to a bottom window of the structure located below the top window using the applicator end effector. The support assembly is lowered with the aerobot.

FIG. 2 shows another example outdoor window cleaning system with an aerobot, a base station deployed on the ground, and an umbilical support system mounted directly to the base station with a boom arm and a support assembly with a clamp assembly to support an umbilical cord for the aerobot.

FIG. 3 shows another example outdoor window cleaning system with an aerobot, a base station deployed on the ground, and an umbilical support system deployed on a roof with a roof anchor, a boom arm, and a support assembly to support an umbilical cord for the aerobot.

FIG. 4 shows another example outdoor window cleaning system with an aerobot, a base station deployed on a roof, and an umbilical support system mounted directly to the base station with a boom arm and a support assembly with an umbilical pulley assembly to support an umbilical cord for the aerobot.

FIG. 5 shows another example outdoor window cleaning system with an aerobot, a base station deployed on the ground, and an umbilical support system that includes a support autonomous aerial vehicle (AAV) and an umbilical pulley assembly to support an umbilical cord for the aerobot.

FIG. 6A shows another example outdoor window cleaning system with an aerobot, a base station deployed on the ground, and an umbilical support system that includes a support AAV and a clamp assembly to support an umbilical cord for the aerobot.

FIG. 6B shows another example outdoor window cleaning system employing multiple aerobots based on the system shown in FIG. 6A.

FIG. 7 shows another example outdoor window cleaning system with an aerobot, a base station deployed on the ground, and an umbilical support system that includes an aerostat with an umbilical pulley assembly to support an umbilical cord for the aerobot.

FIG. 8 shows an example indoor window cleaning system with an aerobot and a base station.

FIG. 9A shows a top, front, left-side perspective view of the aerobot of FIG. 1A. The aerobot is shown with no end effectors.

FIG. 9B shows a top, front, left-side perspective view of the aerobot of FIG. 9A with an applicator end effector and a squeegee end effector.

FIG. 9C shows a front view of the aerobot of FIG. 9A.

FIG. 9D shows a rear view of the aerobot of FIG. 9A.

FIG. 9E shows a right-side view of the aerobot of FIG. 9A.

FIG. 10A shows a front view of the aerobot of FIG. 8.

FIG. 10B shows a rear view of the aerobot of FIG. 10A.

FIG. 10C shows a right-side view of the aerobot of FIG. 10A.

FIG. 11 shows a top view of another example aerobot with multiple thrusters each having rotary joints and a horizontal thruster.

FIG. 12A shows a frame in the aerobots of FIGS. 9A and 10A.

FIG. 12B shows a top view of the frame of FIG. 12A.

FIG. 12C shows a front view of the frame of FIG. 12A.

FIG. 12D shows a right-side view of the frame of FIG. 12A.

FIG. 13 shows a block diagram of an aerobot controller and its electrical connections to various components of the aerobots of FIGS. 9A and 10A.

FIG. 14 shows an example diagram of the electrical and fluidic connections between an aerobot controller and a fluid management subsystem for the aerobot of FIG. 9A.

FIG. 15 shows an example diagram of the electrical and fluidic connections between an aerobot controller and a fluid management subsystem for the aerobot of FIG. 10A.

FIG. 16A shows a perspective view of an example applicator end effector with a sponge fluid applicator.

FIG. 16B shows a partial cross-sectional side view of the applicator end effector of FIG. 16A.

FIG. 16C shows a magnified partial cross-sectional side view of the applicator end effector of FIG. 16B.

FIG. 17A shows a perspective view of an example applicator end effector with a brush fluid applicator.

FIG. 17B shows a partial cross-sectional side view of the applicator end effector of FIG. 17A.

FIG. 18A shows a perspective view of an example applicator end effector with a roller fluid applicator.

FIG. 18B shows a cross-sectional side view of the roller in the applicator end effector of FIG. 18A.

FIG. 19A shows a perspective view of an example squeegee end effector with a wide squeegee blade and a vacuum.

FIG. 19B shows a partial cross-sectional side view of the squeegee end effector of FIG. 19A.

FIG. 19C shows a magnified partial cross-sectional side view of the squeegee end effector of FIG. 19B.

FIG. 20A shows a perspective view of an example squeegee end effector with a narrow squeegee blade and a vacuum.

FIG. 20B shows a partial cross-sectional side view of the squeegee end effector of FIG. 20A.

FIG. 21A shows a partial cross-sectional side view of an example combined applicator and squeegee end effector. The applicator portion includes a roller and receives cleaning fluid. The squeegee portion includes a vacuum.

FIG. 21B shows a magnified partial cross-sectional side view of the combined applicator and squeegee end effector of FIG. 21A.

FIG. 22A shows a perspective view of an example squeegee end effector with a motorized joint connecting two support tubes.

FIG. 22B shows a perspective view of another example squeegee end effector with a motorized joint that includes an end effector connector.

FIG. 23 shows a perspective view of an example aerobot with a motorized squeegee end effector. The end effector includes multiple rotary joints in a serial arrangement.

FIG. 24 shows a perspective view of an example aerobot with a motorized squeegee end effector. The end effector includes multiple rotary joints in a parallel arrangement.

FIG. 25A shows a perspective view of an example male end effector connector.

FIG. 25B shows a perspective view of an example female end effector connector.

FIG. 26 shows an example list of hardware components for the aerobot of FIGS. 9A and 10A.

FIG. 27 shows a magnified view of the base station of FIGS. 1A, 2, 3 and 7.

FIG. 28 shows a block diagram of a base station controller and its electrical connections to various components of a base station and an umbilical support system.

FIG. 29 shows a magnified view of the umbilical support system of FIG. 1A.

FIG. 30 shows a magnified view of the umbilical support system of FIG. 3.

FIG. 31A shows a perspective view of an example male umbilical cord connector.

FIG. 31B shows a perspective view of an example female umbilical cord connector.

FIG. 32 shows a block diagram of an umbilical support controller and its electrical connections to various components of an umbilical support system.

FIG. 33A shows an example horizontal sweeping trajectory for an aerobot to apply a cleaning fluid onto a window.

FIG. 33B shows an inset view of FIG. 33A indicating how the applicator is applied to the window during a portion of the trajectory.

FIG. 34A shows an example of an “S-technique” trajectory for an aerobot to clean a window using a squeegee.

FIG. 34B shows an inset view of FIG. 34A indicating how the squeegee is applied to the window during a portion of the trajectory.

FIG. 34C shows an example of a “fanning” trajectory (which in part incorporates the S-technique) for an aerobot to clean a window using a squeegee.

FIG. 35A shows an example horizontal sweeping trajectory for an aerobot to clean a window using a squeegee.

FIG. 35B shows an inset view of FIG. 35A indicating how the squeegee is applied to the window during a portion of the trajectory.

FIG. 36A shows an example vertical sweeping trajectory for an aerobot to clean a window using a squeegee.

FIG. 36B shows an inset view of FIG. 36A indicating how the squeegee is applied to the window during a portion of the trajectory.

FIG. 37 shows an example control loop diagram for an aerobot.

FIG. 38 shows an example control loop diagram for an umbilical support system with a boom arm.

FIG. 39 shows a flow chart diagram for a method of generating one or more trajectories corresponding to one or more operations performed by an aerobot to clean a window.

FIG. 40 shows a flow chart diagram for a method of executing an S-shaped sweeping trajectory.

### DETAILED DESCRIPTION

Following below are more detailed descriptions of various concepts related to, and implementations of, systems, apparatus, and methods for treatment of outdoor and indoor vertical or inclined surfaces (which may be elevated surfaces) via one or more aerial vehicles. Examples of treatments contemplated by the present disclosure include, but are not limited to, contact treatments such as cleaning (e.g., including application of a cleaning fluid, agitating/scrubbing of the surface, removal of waste fluid, and/or drying), coating (e.g., with a surfactant), painting, sanding, and polishing. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of a system with an aerial vehicle having one or more end effectors to perform one or more operations on an elevated surface are provided, wherein a given example or set of examples showcases one or more features of an aerial vehicle, a base station, an umbilical support system, a central control computer, and an end effector, and one or more control systems to generate and execute a trajectory or method of performing an operation. It should be appreciated that one or more features discussed in connection with a given example of a system may be employed in other examples of systems according to the present disclosure, such that the various features disclosed herein may be readily combined in a given system according to the present disclosure (provided that respective features are not mutually inconsistent).

Certain dimensions and features of the system and its components and/or subsystems are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. EXAMPLE WINDOW CLEANING SYSTEMS

In some example implementations disclosed herein, an aerial vehicle (e.g., an aerobot) may be deployed as part of a window cleaning system to clean one or more windows of a structure. Herein, a structure may include a building or any man-made structure with an opening fitted with glass or another transparent material. This may be accomplished by the aerial vehicle performing one or more operations that involve physically contacting the surface of the window with an end effector. For example, the aerial vehicle may use an applicator end effector to apply a cleaning fluid and/or scrub the surface to agitate and release detritus (e.g., dust, dirt, water spots) from the surface of the window. In another example, the aerial vehicle may use a squeegee end effector to remove the resulting waste fluid (e.g., a mixture of the cleaning fluid and the detritus) from the surface of the window by either displacing the waste fluid (e.g., towards the bottom of the window) or removing the waste fluid using a vacuum.

Following below are several example implementations of a window cleaning system that include an aerial vehicle to clean an interior surface or an exterior surface of a window. In multiple examples provided below, the aerial vehicle is an aerobot; however, it should be appreciated that, more generally, aerial vehicles that are controlled at least in part, or primarily, by one or more other control systems disclosed herein (e.g., a central control computer, a base station controller, an umbilical support system controller) are also contemplated in various example implementations pursuant to the inventive concepts disclosed herein. It should also be appreciated that multiple window cleaning systems may be deployed to clean multiple windows in parallel. The multiple window cleaning systems may further be controlled by a single central control computer.

It should also be appreciated that one or more components and/or subsystems of one window cleaning system may be readily combined or substituted with one or more components and/or subsystems of another window cleaning system provided the combination or substitution does not result in mutually inconsistent features. It should be further appreciated that one or more components and/or subsystems of the window cleaning systems disclosed herein alternatively may be used in other types of contact treatment of one or more surfaces that employs one or more aerobots to facilitate execution of the contact treatment. For example, a painting system may be substantially similar or the same as the window cleaning system with the exception of the aerobot having a different end effector to facilitate painting and the aerial vehicle being supplied with paint.

1.1 An Example Outdoor Window Cleaning System with a Ground-Based Base Station and a Boom Arm

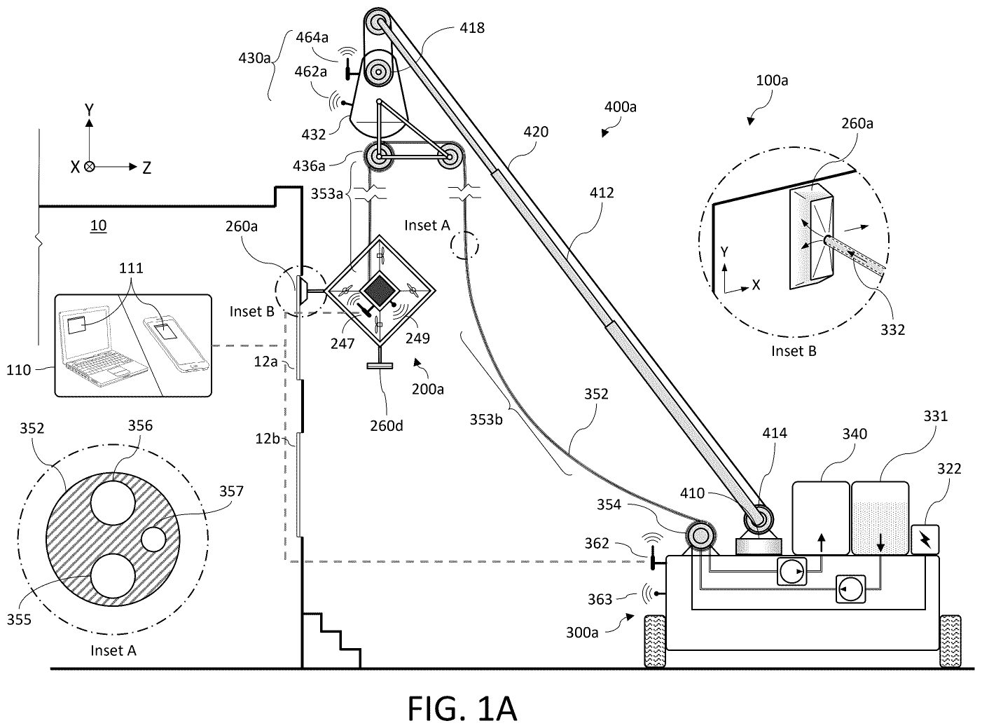

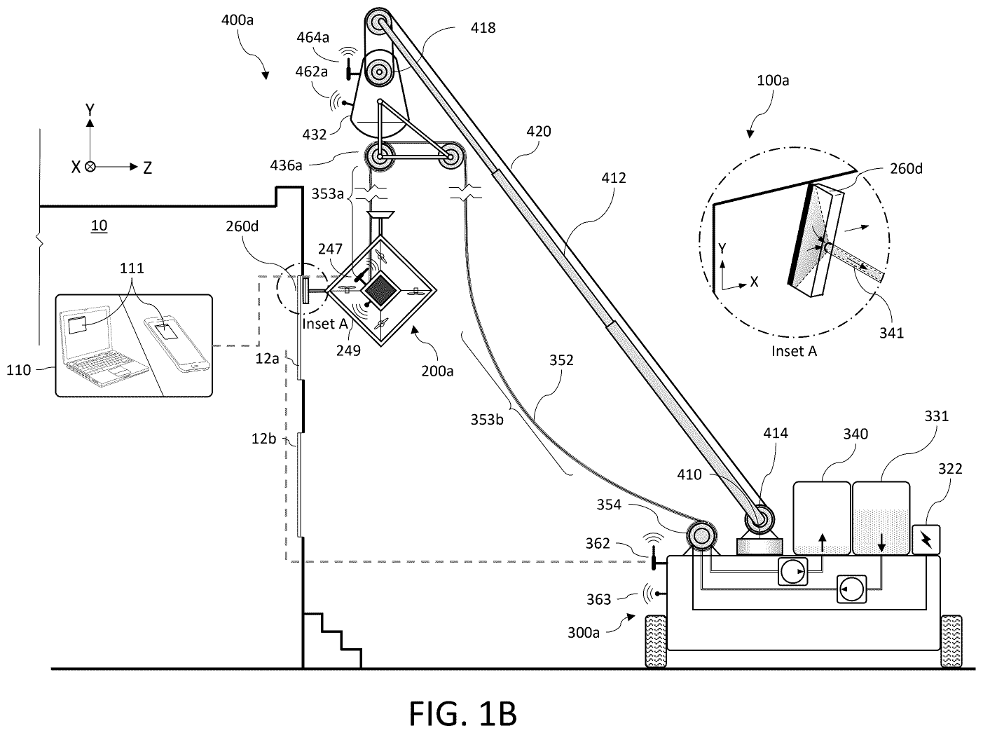

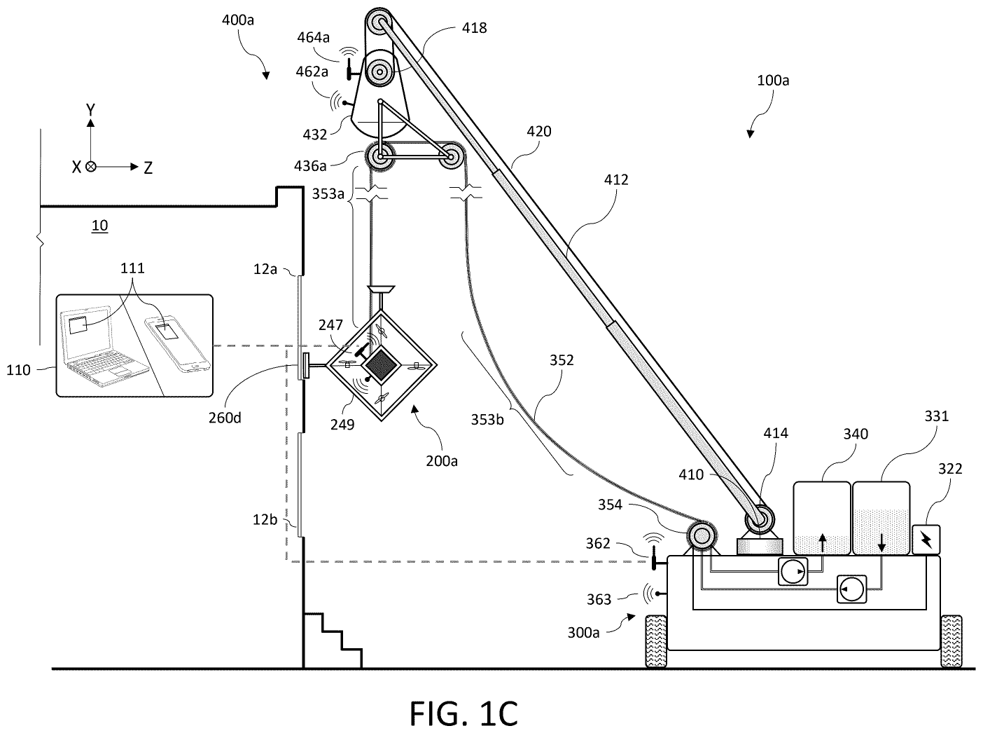

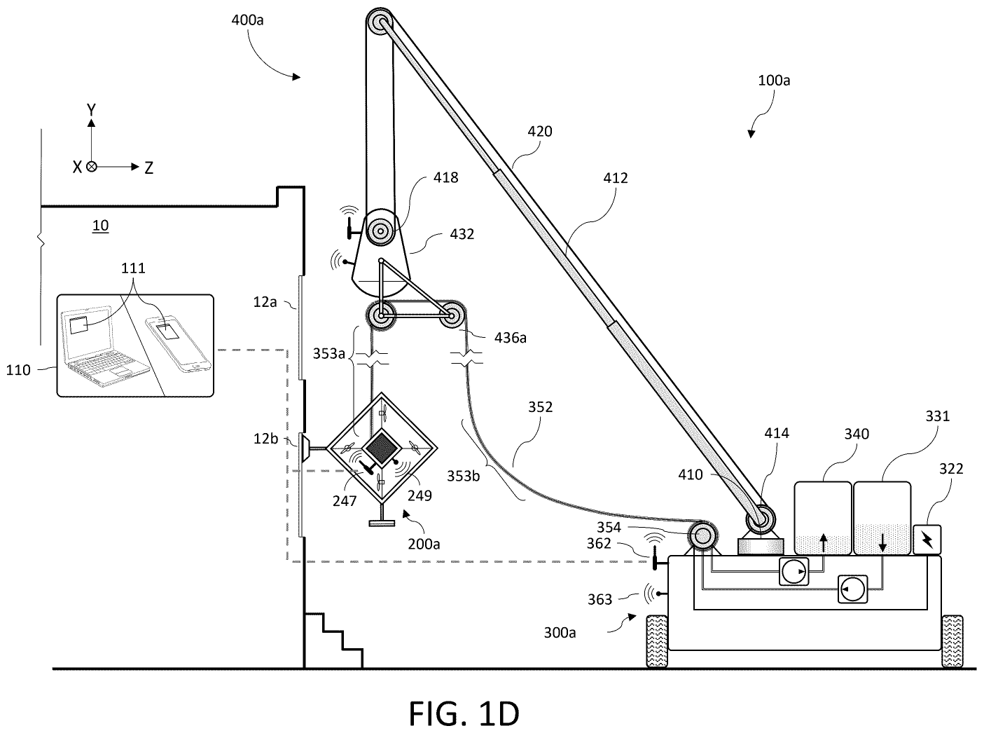

FIGS. 1A-1D show an example outdoor window cleaning system 100a that includes an aerobot 200a to perform one or more operations to clean an exterior surface of a window (e.g., windows 12a and 12b of the structure 10). The system 100a also includes a base station 300a to supply cleaning fluid 332 and electrical power to the aerobot 200a and retrieve waste fluid 341 from the aerobot 200a via an umbilical cord 352 and an umbilical support system 400a with a boom arm 412 and a suspended support assembly 430a to support the umbilical cord 352. As shown, the base station 300a is deployed on the ground and the umbilical support system 400a is mounted directly to the base station 300a. The boom arm 412 is configured to position the support assembly 430a above the aerobot 200a as the aerobot 200a cleans the windows 12a and 12b. In one example implementation, the system 100a may be suitable for low-rise buildings that are a few stories tall (e.g., a single-story house, a multi-story house, a low-rise apartment building or commercial building).

Herein, various implementations of the aerobot are referred to more generally as an aerobot 200. Various implementations of the base station controller are referred to more generally as a base station controller 300. Various implementations of the umbilical support system are referred to more generally as an umbilical support system 400.

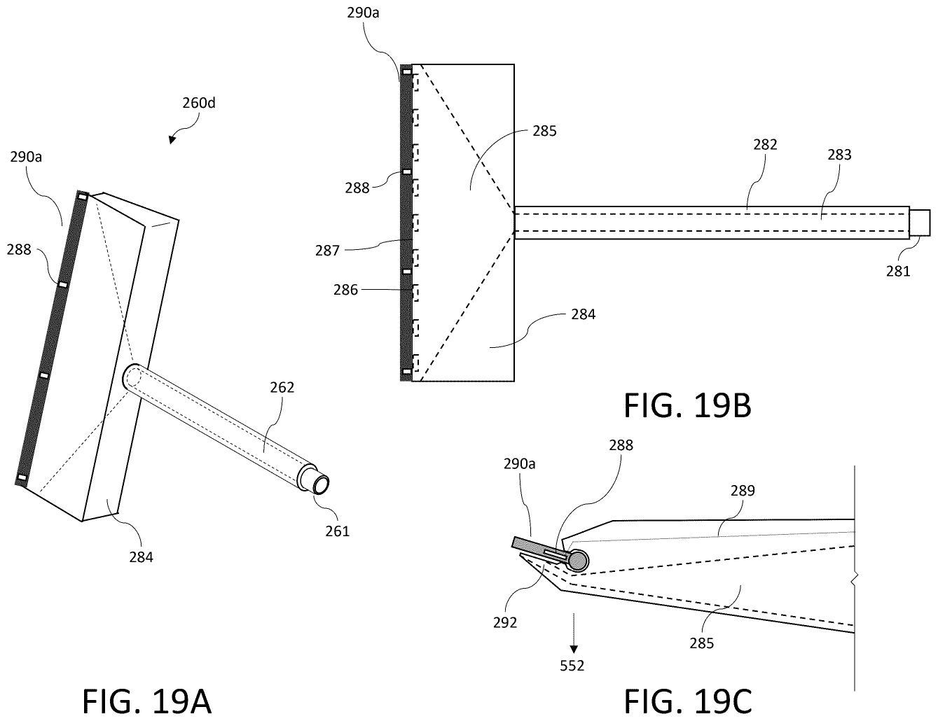

In this example, the aerobot 200a is shown equipped with an applicator end effector 260a to apply a cleaning fluid 332 to the window 12a and scrub the window 12a to remove and suspend surface contaminates (e.g., detritus) in the cleaning fluid 332. The aerobot 200a also includes a squeegee end effector 260d to remove the resulting waste fluid 341 (e.g., a mixture of cleaning fluid 332 and detritus from the window 12a). Specifically, the squeegee end effector 260d may provide vacuum suction to remove and capture waste fluid 341 as it is removed by a squeegee blade (see, for example, squeegee blade 290a in FIGS. 19A-19C), thus reducing or, in some instances, eliminating run off of waste fluid 341. This, in turn, may eliminate a separate operation to clean a frame of the window 12a, thus reducing cleaning time and costs and improving the quality of service. In some implementations, as discussed further below, the captured waste fluid 341 may be recycled (e.g., continuously, or in a batch, using an in-line filtration system) to recover water that can be reused by the system 100a (e.g., while executing an operation, for a later executed operation). Herein, the applicator end effector 260a and the squeegee end effector 260d may be more generally referred to as an end effector 260.

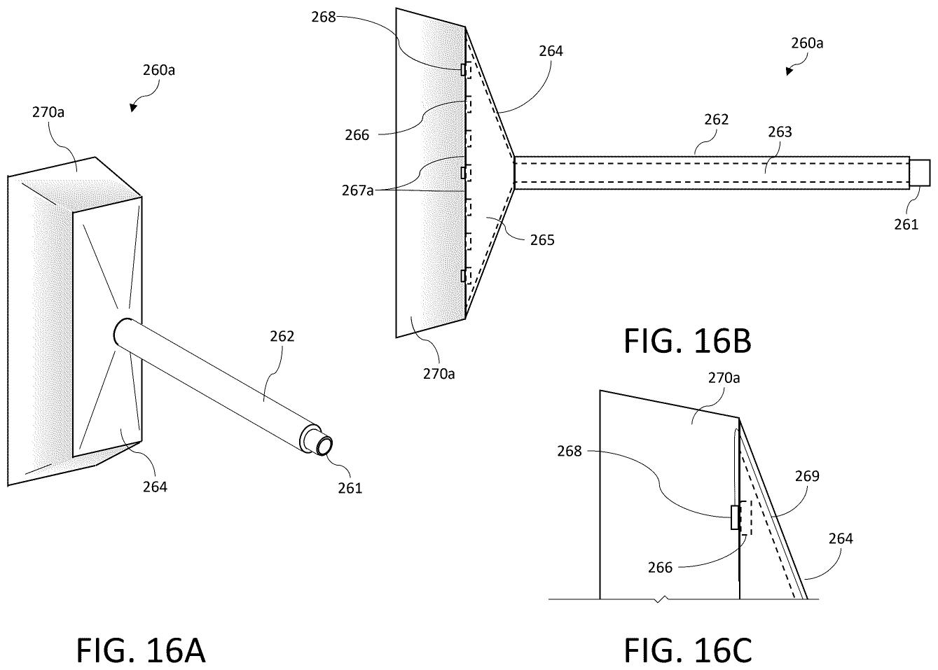

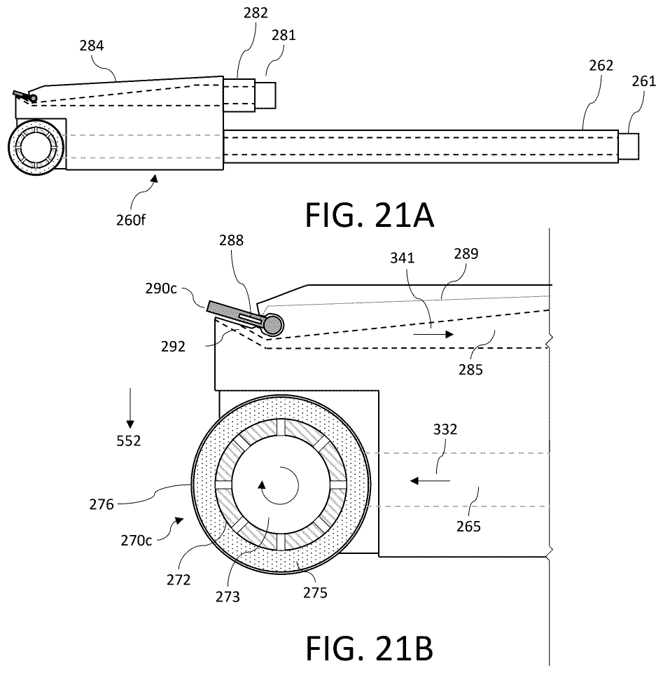

It should be appreciated that in other implementations, the aerobot 200a may have a different configuration of end effectors 260 to perform a different set of operations. For example, the aerobot 200a may have multiple squeegee end effectors with different sized squeegee blades to remove waste fluid 341 from different portions of a window, e.g., a wide squeegee blade (e.g., squeegee blade 290a) to remove waste fluid 341 from a center portion of the window 12a and a narrow squeegee blade (e.g., squeegee blade 290b) to remove waste fluid 341 from an edge portion of the window 12a. Generally, the aerobot 200a may be equipped with one or more end effectors 260 including, but not limited to, the applicator end effector (see, for example, FIGS. 16A-18B), the squeegee end effector (see, for example, FIGS. 19A-20B, and 22A-24), and/or a combined applicator and squeegee end effector configured to apply cleaning fluid and remove waste fluid simultaneously (see, for example, FIGS. 21A and 21B).

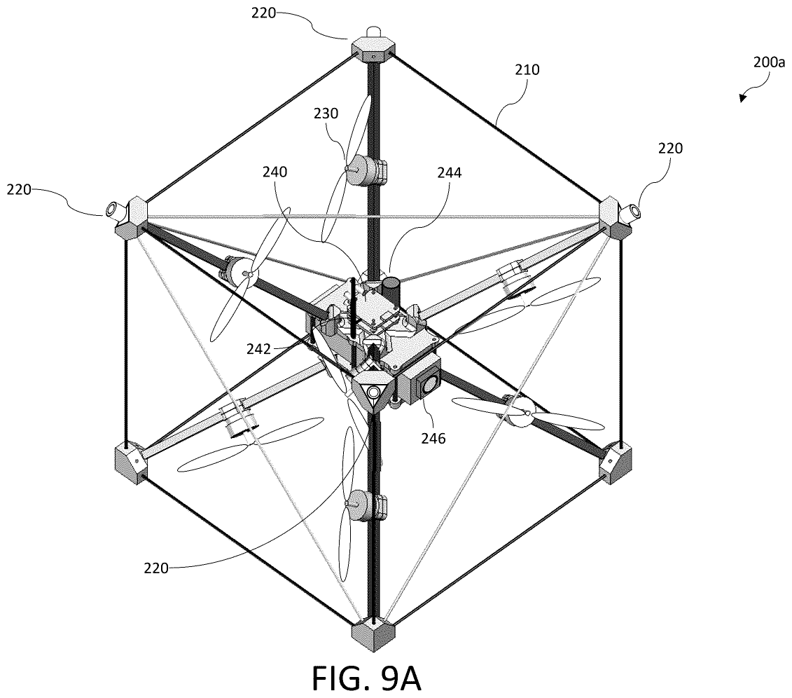

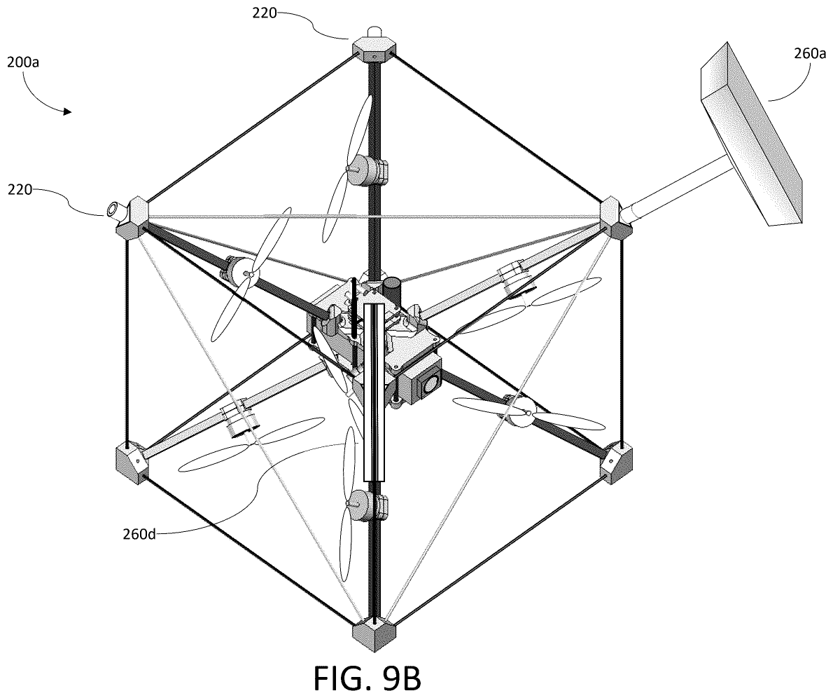

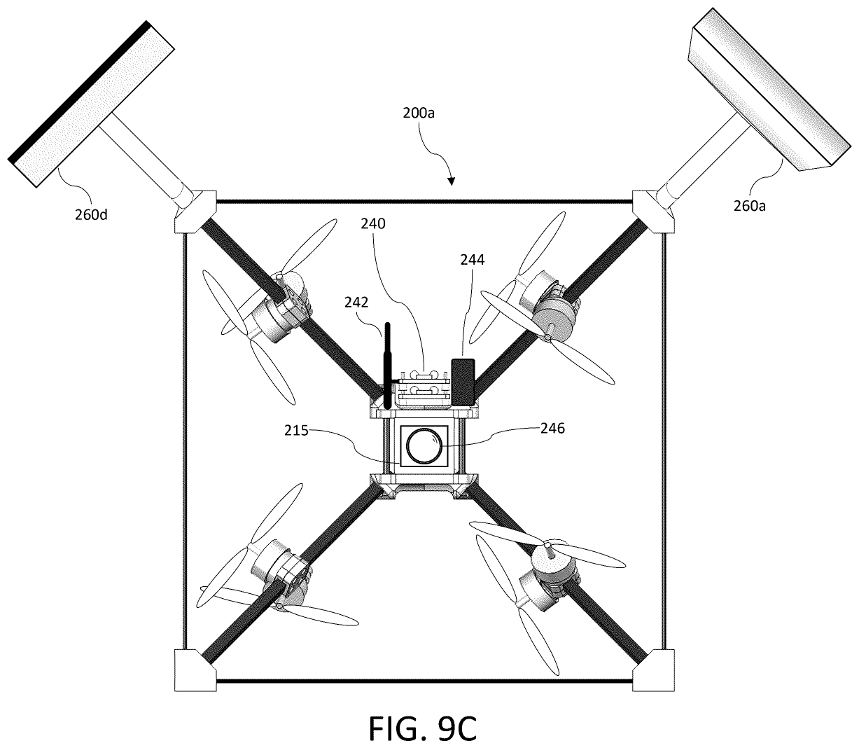

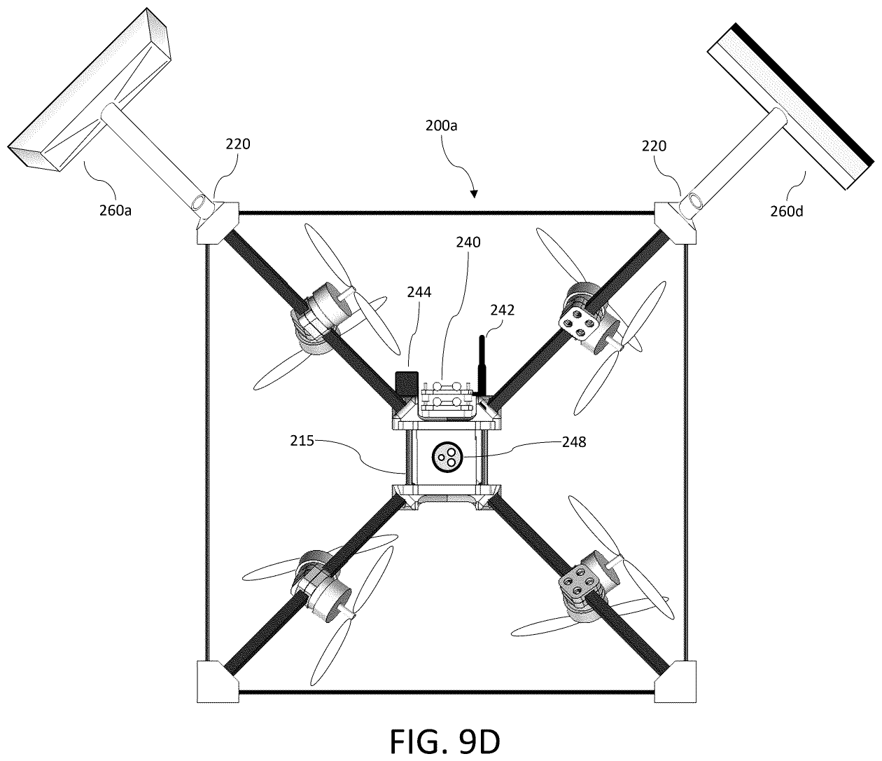

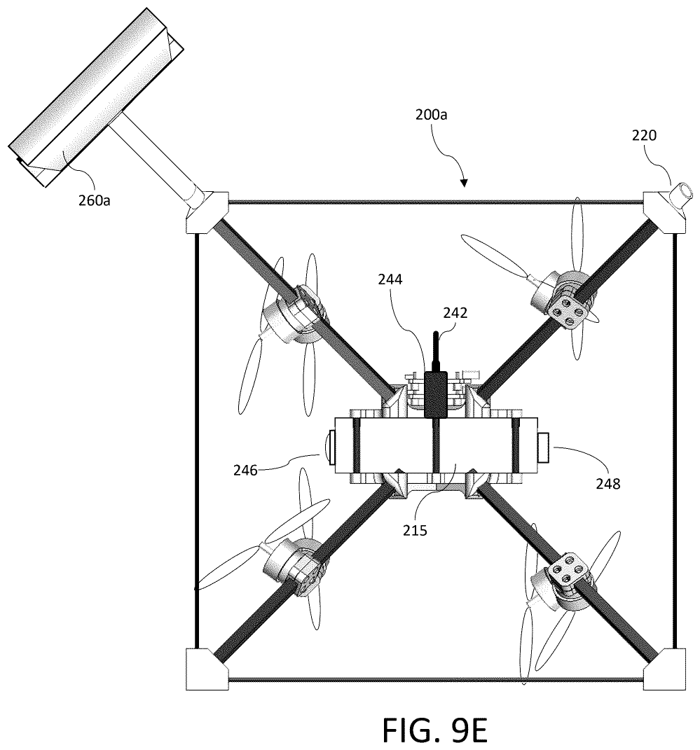

The aerobot 200a may be an omnidirectional aerobot capable of independently controlling each of its six degrees of freedom, i.e., three orthogonal translational degrees of freedom (X, Y, and Z axes), and three orthogonal rotational degrees of freedom (about the X, Y, and Z axes). This may be accomplished by the aerobot 200a having multiple thrusters 230 oriented in different directions and arranged such that, by generating varying levels of thrust from one or more of the thrusters 230, the position and/or the attitude of the aerobot 200a may be changed along any desired direction or about any desired axis, respectively. In one non-limiting example, the aerobot 200a may include four pairs of thrusters 230 arranged such that the thrusters 230 in each pair generate thrust in the same direction and the respective pairs of thrusters 230 are oriented in different directions (see, for example, FIGS. 9A-9E). The aerobot 200a may further include an onboard aerobot controller 240 to control the operation of each of the thrusters 230. In particular, the aerobot controller 240 may facilitate movement of the aerobot 200a along a desired trajectory and/or orient the aerobot 200a to a desired attitude (even in the presence of environmental factors such as wind) by individually controlling each of the thrusters 230. It should be appreciated that the aerobot 200a may include other components and/or subsystems to facilitate operation and the aerobot controller 240 may control these other components and/or subsystems of the aerobot 200a, as discussed in Section 2.1.

The mobility of the aerobot 200a may allow the aerobot 200a to position and/or orient an end effector with respect to the surface of the window as desired while remaining stationary (e.g., at a particular position) and/or while moving along a desired trajectory. For example, the applicator end effector 260a may include a fluid applicator 270a. The aerobot 200a may orient the applicator end effector 260a such that an axis parallel to the width of the fluid applicator 270a is orthogonal to the direction of travel at any point along the trajectory of the aerobot 200a (see, for example, Inset B of FIG. 1A). In this manner, the applicator end effector 260a may apply cleaning fluid 332 over a larger area of the window 12a as the end effector 260a moves along the window 12a, which in turn shortens the trajectory followed by the aerobot 200a to apply cleaning fluid 332 to the entire the window 12a. In another example, the squeegee end effector 260d may include a squeegee blade 290a to remove waste fluid 341 from the surface of the window 12a as the squeegee blade 290a is moved along the surface. The aerobot 200a may orient the squeegee blade 290a at an angle relative to the direction of travel so that waste fluid 341 is preferably displaced to one side of the squeegee blade 290a (see, for example, Inset A of FIG. 1B).

Additionally, the aerobot 200a may change its position and/or attitude along any one of its six degrees of freedom more quickly (i.e., with a faster response time) than conventional aerobots. For example, conventional aerobots, such as a quadcopter, must often rotate before moving in a horizontal direction, which results in a slower response time when a change in the horizontal position is desired. In contrast, the aerobot 200a may change its position and/or attitude along a particular axis without requiring any intermediate movement about another axis, resulting in a faster response time. This is accomplished by the aerobot 200a adjusting the thrust generated by one or more of the thrusters 230 to produce a combined thrust that induces motion about the desired axis. In this manner, the aerobot 200a may move, for example, along a horizontal direction without changing its attitude. The faster response time of the aerobot 200a may allow the aerobot 200a to more readily react to external disturbances acting on the aerobot 200a, such as wind. For example, the aerobot 200a may measure the wind speed and direction over time using an onboard anemometer and actively adjust the thrusters 230 such that a portion of the thrust always opposes the wind acting on the aerobot 200a, thus reducing or, in some instances, mitigating the effect of wind on the position or attitude of the aerobot 200a.

Combined with the capability of the aerobot 200a to independently control each of its six degrees of freedom, the aerobot 200a may readily maintain a desired trajectory and/or orientation in the presence of one or more external disturbances. This, in turn, allows the aerobot 200a to maintain an end effector (e.g., the applicator end effector 260a, the squeegee end effector 260d) in continuous physical contact with a surface of the window as the end effector is moved along the surface. Herein, continuous physical contact may be defined to mean at least a portion of the end effector remains in physical contact with the surface of the window (i.e., the contact pressure is greater than 0 psi) for at least a portion, if not a substantial portion of the desired trajectory (e.g., a duration that the end effector is used to perform a single operation). In some implementations, continuous physical contact may be more narrowly defined to mean the entirety of the end effector that is used to perform an operation (e.g., the entirety of a fluid applicator, the entirety of a squeegee blade) remains in physical contact with the surface of the window for at least a portion, if not a substantial portion of the desired trajectory (e.g., a duration that the end effector is used to perform a single operation).

For example, the aerobot 200a may maintain physical contact between the applicator end effector 260a and the surface of the window 12a until the surface is substantially covered or, in some instances, entirely covered in cleaning fluid 332 and the corresponding operation is considered complete. Herein, the surface of the window 12a may be considered to be substantially covered in cleaning fluid 332 if the cleaning fluid 332 covers, for example, greater than or equal to 90% of the area of the surface, greater than or equal to 95% of the area of the surface, or greater than or equal to 99% of the area of the surface. In another example, the aerobot 200a may maintain physical contact between the squeegee end effector 260d and the surface of the window 12a until the waste fluid 341 on the surface is substantially removed or, in some instances, entirely removed and the corresponding operation to remove the waste fluid 341 is considered complete. Herein, the waste fluid 341 on the window may be considered to be substantially removed if the remaining waste fluid 341 covers, for example, less than or equal to 10% of the area of the surface, less than or equal to 5% of the area of the surface, or less than or equal to 1% of the area of the surface.

In some implementations, the aerobot 200a may maintain an end effector in physical contact with a surface by applying the end effector against the surface such that the contact pressure between the end effector and the surface of the window is within a predetermined pressure range. The lower limit of the pressure range may be chosen to provide a sufficient buffer to ensure the end effector remains in contact with the surface in the event a sudden external disturbance (e.g., a gust of wind) acts on the aerobot 200a in a manner that pushes or pulls the aerobot 200a away from the surface and the aerobot 200a is unable to respond. The upper limit of the pressure range may be chosen to limit the mechanical forces applied to the end effector or the surface to prevent, for example, mechanical failure of the end effector and/or damage to the surface. The pressure range may further vary depending on the end effector being used. For example, an applicator end effector with a more compliant fluid applicator may have a larger pressure range compared to an applicator end effector with a less compliant fluid applicator. In another example, the applicator end effector may have a larger pressure range compared to a squeegee end effector.

In some implementations, the contact pressure range for the applicator end effector may range from about 0.1 pounds per square inch (psi) to about 1 psi, including all values and sub-ranges in between. In some implementations, the contact pressure range for the squeegee end effector may range from about 0.1 psi to about 0.5 psi, including all values and sub-ranges in between. The term “about,” when used to describe the contact pressure between the end effector and a surface, is intended to cover the precision at which the contact pressure may be controlled by the aerobot 200a or the end effector. For example, “about 1 psi” may correspond to the following dimensional ranges: 0.99 to 1.01 psi (+/−1% variability), 0.98 to 1.02 psi (+/−2% variability), 0.97 to 1.03 psi (+/−3% variability), 0.96 to 1.04 psi (+/−4% variability), 0.95 to 1.05 psi (+/−5% variability), including all values and sub-ranges in between.

To control the contact pressure between the end effector and the surface of the window, the end effector may include one or more sensors to measure the contact pressure at different locations along the portion of the end effector that contacts the surface (see, for example, the sensor(s) 268 in FIGS. 16A-16C and the sensor(s) 288 in FIGS. 19A-19C). The sensor(s) may further be communicatively coupled to the aerobot controller 240 to provide data on the contact pressure. The aerobot controller 240, in turn, may monitor the contact pressure and adjust the contact pressure if the contact pressure falls outside the predetermined pressure range for that end effector, e.g., by using the thrusters 230 of the aerobot 200a and/or one or more motorized joints of an end effector, if present, to increase or decrease the contact pressure.

In one illustrative example, a squeegee end effector 260d may include multiple strain sensors 288 integrated into and distributed along a squeegee blade 290a. When the squeegee blade 290a is pressed against a surface, the squeegee blade 290a deforms (e.g., bends). The deformation at a particular portion of the squeegee blade 290a may be measured by a strain sensor 288 located near or at that portion. The measured deformation may then be used to determine a contact pressure using the aerobot controller 240, e.g., by using previous calibration data that correlates deformation of the squeegee blade 290a to a known contact pressure. By acquiring contact pressure from the multiple strain sensors 288, a pressure distribution along the length of the squeegee blade 290a may be determined. In another illustrative example, an applicator end effector 260a may include a compliant portion (e.g., a sponge 260d) to facilitate application of a cleaning fluid 332 to the surface. Multiple strain sensors 268 may be integrated into and distributed along the compliant portion and to measure contact pressure based on the extent the compliant portion is compressed. In another illustrative example, the aerobot 200a may include a camera, a range-finding sensor (e.g., a LiDAR sensor), and/or the like as part of an imaging subsystem 246 to measure a distance between the surface and the aerobot 200a. The measured distance may be used by the aerobot controller 240 to determine the location of the end effector relative to the surface.

As described above, the base station 300a supplies cleaning fluid 332 and electrical power to the aerobot 200a and retrieves waste fluid 341 from the aerobot 200a. As shown in FIG. 1A, the aerobot 200a may be coupled to the base station 300a via an umbilical cord 352. The umbilical cord 352 may include separate fluid conduits for cleaning fluid (e.g., the cleaning fluid conduit 355) and waste fluid (e.g., the waste fluid conduit 356), and an electrical conduit for electrical power (e.g., the electrical conduit 357), as shown in Inset A of FIG. 1A. The base station 300a may further include a cleaning fluid tank 331 to store cleaning fluid 332, a cleaning fluid pump 334 to generate a pressurized flow of cleaning fluid 332 to the aerobot 200a, a waste fluid tank 340 to store waste fluid 341, and a waste fluid pump 343 to generate a vacuum to suction waste fluid 341 from the aerobot 200a. In one example implementation, the base station 300a may include an in-line filtration system disposed between the waste fluid tank 340 and the cleaning fluid tank 331 to effectively recycle at least some, if not a substantial portion of, the waste fluid 341.

By using the base station 300a to store the cleaning fluid 332 and the waste fluid 341 and to supply electrical power to the aerobot 200a, the aerobot 200a may operate continuously without requiring resupply (e.g., refill of cleaning fluid 332, removal of waste fluid 341, or recharge of power). For example, the aerobot 200a may perform the first operation to apply a cleaning fluid 332 to one or more windows (e.g., via the applicator end effector 260a) without interruption until completion. In another example, the aerobot 200a may perform the second operation to remove waste fluid 341 from one or more windows (e.g., via the squeegee end effector 260d) without interruption until completion. Additionally, the aerobot 200a in the system 100a is not required to carry A) any onboard tanks to store cleaning fluid 332 or waste fluid 341, B) any onboard pumps to generate a flow of cleaning fluid 332 or to suction waste fluid 341, or C) an onboard energy storage module, such as a battery, thus appreciably reducing the payload of the aerobot 200a.

Additionally, when a conventional aerobot is connected to a cord, the cord may transfer undesirable forces and/or torques directly to the aerobot. For example, when the cord is suspended off the ground, the weight of the cord causes tension in the cord. This tensile force is often transmitted directly to the aerobot, thus pulling the aerobot downwards and/or away from a desired position and/or attitude. In another example, if the aerobot is operating in a windy environment, the wind may displace the cord in different directions over time and thus pull the aerobot away from a desired position and/or attitude.

In the system 100a, the transfer of any undesirable forces and/or torques from the umbilical cord 352 to the aerobot 200a may be appreciably reduced or, in some instances, mitigated by the umbilical support system 400a, which supports at least a portion of the umbilical cord 352. FIG. 1A shows the umbilical support system 400a includes a boom arm 412 supporting a support assembly 430a at its distal end via a cable 420. The support assembly 430a may include an end pulley 418 suspended by the cable 420 from a boom pulley 416 located at the distal end of the boom arm 412. The support assembly 430a further includes a ballast 432 coupled to the end pulley 418 and an umbilical pulley assembly 436a coupled to the ballast 432 to carry a portion of the umbilical cord 352.

The umbilical pulley assembly 436a may suspend the umbilical cord 352 above the aerobot 200a such that a first portion 353a of the umbilical cord 352 is located between the umbilical pulley assembly 436a and the aerobot 200a and a second portion 353b of the umbilical cord 352 is located between the umbilical pulley assembly 436a and the base station 300a. Additionally, the umbilical pulley assembly 436a may allow an operator to adjust the length of the first portion 353a of the umbilical cord 352 before the aerobot 200a is deployed, for example, by allowing rotation of one or more pulleys 438 to facilitate movement of the umbilical cord 352 through the umbilical pulley assembly 436a. Generally, limits may be imposed on the length of the first portion 353a to reduce or, in some instances, mitigate external disturbances acting on the first portion 353a affecting the operation of the aerobot 200a, as discussed in further detail below.

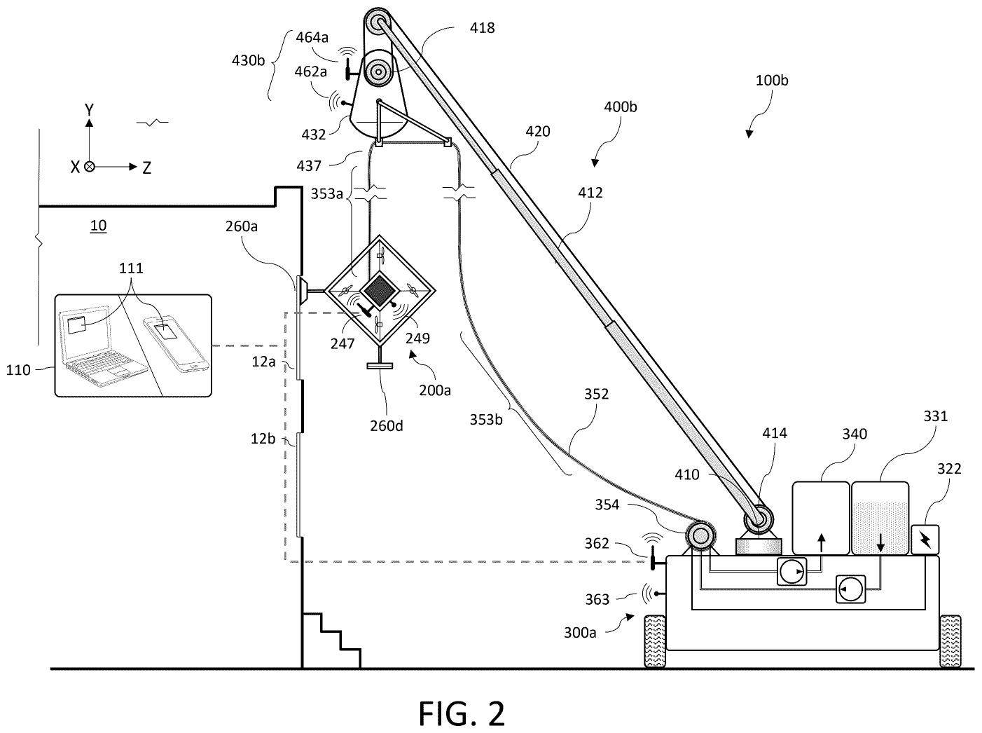

It should also be appreciated that the umbilical pulley assembly 436a of the umbilical support system 400a is one non-limiting example. In other implementations, the umbilical pulley assembly may be replaced by a clamp assembly that securely affixes the umbilical cord 352 to the support assembly. For example, FIG. 2 shows an example outdoor window cleaning system 100b with an umbilical support system 400b that includes a clamp assembly 437 instead of an umbilical pulley assembly. The clamp assembly 437 may include one or more clamps to securely couple the umbilical cord 352 to the support assembly 430b.

The umbilical support system 400a reduces the forces and/or torques transferred from the umbilical cord 352 to the aerobot 200a in the following ways.

First, the umbilical pulley assembly 436a may include a locking mechanism (e.g., a brake coupled to a pulley), which when engaged, keeps the length of the first portion 353a of the umbilical cord 352 and the length of the second portion 353b of the umbilical cord 352 fixed. Under these constraints, the load carried by the second portion 353b of the umbilical cord 352 (e.g., the weight of the second portion 353b of the umbilical cord 352 and any fluid carried by the second portion 353b of the umbilical cord 352) is transmitted directly to the support assembly 430a (e.g., via the umbilical pulley assembly 436a) instead of the aerobot 200a. In other words, by locking the umbilical pulley assembly 436a, the second portion 353b of the umbilical cord 352 cannot pull on the first portion 353a of the umbilical cord 352 and, by extension, the aerobot 200a. Additionally, the support assembly 430a may support any vertical load and at least a portion of the horizontal load carried by the first portion 353a of the umbilical cord 352. For example, the weight of the first portion 353a of the umbilical cord 352, any fluid carried by the first portion 353a of the umbilical cord 352, and/or the weight of the aerobot 200a may be supported by the support assembly 430a (e.g., via the umbilical pulley assembly 436a). Generally, the load associated with the first and second portions 353a and 353b of the umbilical cord 352 is supported by the support assembly 430a and the support assembly 430a, in turn, is supported by the cable 420 via the end pulley 418. It should also be appreciated that the locking mechanism may function as a safety mechanism. In the event the aerobot 200a loses power and, hence, lift, the aerobot 200a may remain suspended by the first portion 353a of the umbilical cord 352 rather than falling to the ground.

Second, the umbilical support system 400a may be configured to maintain some slack in the first portion 353a of the umbilical cord 352. Said another way, the umbilical pulley assembly 436a may be positioned such that the first portion 353a of the umbilical cord 352 is not pulled taut during operation. Also, if the umbilical pulley assembly 436a is offset horizontally from the aerobot 200a, a portion of the horizontal load carried by the first portion 353a of the umbilical cord 352 may be transferred to the aerobot 200a. Thus, the umbilical support system 200a may be configured to position the umbilical pulley assembly 436a above the aerobot 200a with a relatively small horizontal offset or, in some instances, directly above the aerobot 200a with zero horizontal offset such that the vertical component of the load carried by the first portion 353a of the umbilical cord 352 is appreciably greater than the horizontal component of the load.

The above conditions may be met by the umbilical support system 400a moving the support assembly 430a and, in particular, the umbilical pulley assembly 436a to follow the aerobot 200a during operation. Specifically, the umbilical pulley assembly 436a may be positioned above or, in some instances, directly above the aerobot 200a and sufficiently close to the aerobot 200a such that the first portion 353a of the umbilical cord 352 is not taut (i.e., the first portion 353a of the umbilical cord 352 does not transfer a force that pulls the aerobot 200a upwards) as the aerobot 200a moves horizontally and/or vertically.

The umbilical support system 400a may provide several degrees of freedom to adjust the position of the support assembly 430a and, by extension, the umbilical pulley assembly 436a. For example, the umbilical support system 400a may include a stage 410 to directly couple the boom arm 412 to the base station 300a. The stage 410 may be a rotation stage that rotates the boom arm 412 and, by extension, the support assembly 430a about a vertical axis. The stage 410 may also be a linear stage that shifts the boom arm 412 along the X axis or the Z axis. In another example, the boom arm 412 may be telescoping. Its length may be changed by extending or retracting the boom arm 412, which, in turn, changes the distance the support assembly 430a is located relative to the base station 300a. In yet another example, the umbilical support system 400a includes a cable winch 414 to raise or lower the support assembly 430a via the end pulley 418.

Additionally, the umbilical support system 400a may include one or more sensor(s) 462a to monitor various operating parameter(s) associated with the umbilical support system 400a and/or environmental conditions near the umbilical support system 400a. In some implementations, the sensor(s) 462a may include a location tracker disposed at or near the umbilical pulley assembly 436a. The location tracker may be used to monitor the location of the umbilical pulley assembly 436a relative to the aerobot 200a. The aerobot 200a may also include one or more sensor(s) 249 to monitor various operating parameter(s) associated with the aerobot 200a and/or environmental conditions near the aerobot 200a. The sensor(s) 249 may include a location tracker. In one non-limiting example, the location trackers of the umbilical support system 400a and the aerobot 200a may each include a global navigation satellite system (GNSS) receiver to determine X and Z coordinates and a laser range finder directed to the ground to determine a Y coordinate. The location tracker of the umbilical support system 400a may measure a first set of coordinates corresponding to the location of the umbilical pulley assembly. The location tracker of the aerobot 200a may measure a second set of coordinates corresponding to the location of the aerobot 200a.

An umbilical support system controller 460 in the umbilical support system 400a or, alternatively, a base station controller 360 in the base station 300a communicatively coupled to the umbilical support system 400a may receive the first and second sets of coordinates and adjust the position of the support assembly 430a based on the difference between the first and second sets of coordinates. For example, the position of the support assembly 430a may be continuously adjusted as the aerobot 200a performs an operation such that: A) the difference between the X and Z coordinates of the umbilical pulley assembly 436a and the aerobot 200a is below a first predetermined threshold (e.g., less than 10 centimeters) and B) the difference between the Y coordinates of the umbilical pulley assembly 436a and the aerobot 200a is less than a second predetermined threshold (e.g., the length of the first portion of the umbilical cord 352).

The system 100a may also include an umbilical cord winch 414 mounted to the base station 300a to adjust the length of the second portion 353b of the umbilical cord 414 as the position of the umbilical pulley assembly 436a changes. The operation of the umbilical cord winch 414 may be synchronized with the operation of the other degrees of freedom of the umbilical support system 400a. For example, the umbilical cord winch 414 may release the umbilical cord 352 as the umbilical pulley assembly 436a is moved away from the base station 300a to maintain slack in the second portion 363b of the umbilical cord 352 or prevent the second portion 353b of the umbilical cord 352 being pulled taut. In another example, the umbilical cord winch 414 may retract the umbilical cord 352, thus reducing the length of the second portion 353b of the umbilical cord 352 as the umbilical pulley assembly 436a is moved closer to the base station 300a to prevent the second portion 353b of the umbilical cord 352 from touching the ground or any obstacles near the ground. The umbilical support controller 460 or the base station controller 360 may control the operation of the umbilical cord winch 414.

Third, the support assembly 430a includes a ballast 432 rigidly coupled to the umbilical pulley assembly 436a to reduce the effect of external disturbances on the support assembly 430a. In particular, external disturbances, such as wind, or any loads transferred to the umbilical pulley assembly 436a from the first and second portions 353a and 353b of the umbilical cord 352, may change the position and/or orientation of the umbilical pulley assembly 436a relative to the aerobot 200a. This, in turn, may lead to horizontal loading if the umbilical pulley assembly 436a is offset horizontally from the aerobot 200a or tension in the first portion 353a of the umbilical cord 352 if the umbilical cord 352 is pulled taut. The additional weight of the ballast 432 may help to counteract the external disturbances acting on the support assembly 430a. For example, the ballast 432 may counteract any vertical upward forces that are externally applied to the support assembly 430a (e.g., an updraft of air). In another example, the ballast 432 may oppose any lateral forces (e.g., a lateral wind force) applied to the support assembly 430a that cause the support assembly 430a to swing about the distal end of the boom arm 412 via the cable 420. In this manner, the ballast 432 may appreciably reduce or, in some instances, mitigate changes to the position and/or orientation of the support assembly 430a in response to any external disturbances acting on the support assembly 430a.

As a result, the umbilical pulley assembly 436a may be substantially stationary or, in some instances, stationary during operation except when the position of the support assembly 430a is changed via the various degrees of freedom described above. For example, the umbilical pulley assembly 436a may move less than about 10 centimeters, less than about 5 centimeters, or less than about 1 centimeter in response to an external disturbance that applies a force to the support assembly 430a with a magnitude of 1 pound-force. In another example, the orientation of the umbilical pulley assembly 436a about any axis may change less than 3 degrees, less than 2 degrees, or less than 1 degree in response to an external disturbance that applies a torque to the support assembly 430a with a magnitude of 1 pound-foot.

It should be appreciated that external disturbances may also act on the aerobot 200a, the first portion 353a of the umbilical cord 352, and the second portion 353b of the umbilical cord 352. As described above, the umbilical support system 400a may appreciably mitigate loads carried by the second portion 353b of the umbilical cord 352. Thus, external disturbances acting on the second portion 353b of the umbilical cord 352 may not affect the aerobot 200a.

The external disturbances acting on the first portion 353a of the umbilical cord 352 may be appreciably reduced, in part, by configuring the length of the first portion 353a of the umbilical cord 352 to be sufficiently short such that the magnitude of any forces and/or torques arising from these external disturbances do not appreciably affect the operation of the aerobot 200a. The length of the first portion 353a may be adjusted via the umbilical pulley assembly 436a before deployment of the aerobot 200a, as described above. Generally, the length of the first portion 353a may be adjustable to accommodate different environmental conditions. For example, if the system 100a is deployed to clean a building in an environment with little to no wind, the length of the first portion 353a may be configured to be relatively longer to increase the operating range of the aerobot 200a. In other words, the aerobot 200a may be allowed to move farther from the umbilical pulley assembly 436a. In another example, if the system 100a is deployed to clean a building in an environment with an appreciable wind force, the length of the first portion 353a may be configured to be relatively shorter to reduce the effect of the wind on the aerobot 200a.

In one example, the length of the first portion 353a may range from about 1 meter to about 10 meters, including all values and sub-ranges in between. In another example, the length of the first portion 353a may range from about 1 meter to about 5 meters, including all values and sub-ranges in between. The term “about,” when used to describe the length of the first portion 353a of the umbilical cord 352, is intended to cover variations due to manual or motorized adjustment of the umbilical cord 352 using the umbilical pulley assembly 436a and/or the umbilical cord winch 414. For example, “about 1 m” may correspond to the following dimensional ranges: 0.99 to 1.01 m (+/−1% variability), 0.98 to 1.02 m (+/−2% variability), 0.97 to 1.03 m (+/−3% variability), 0.96 to 1.04 m (+/−4% variability), 0.95 to 1.05 m (+/−5% variability), including all values and sub-ranges in between.

Fourth, the umbilical pulley assembly 436a may reduce or, in some instances, mitigate entanglement of the umbilical cord 352 with the aerobot 200a. For example, FIG. 1A shows the umbilical pulley assembly 436a includes multiple umbilical pulleys 438 to support the umbilical cord 352. The pulleys 438 may be arranged such that the second portion 353b of the umbilical cord 352 does not wrap around and/or fall onto the aerobot 200a. It should be appreciated that, in some implementations, the aerobot 200a may also be constrained in its movement to reduce the likelihood of the aerobot 200a becoming entangled with the umbilical cord 352. For example, when the aerobot 200a changes orientation to use the applicator end effector 260a or the squeegee end effector 260d (see FIGS. 1A and 1B), the aerobot 200a may not be allowed to rotate in a manner that would cause the umbilical cord 352 to wrap around the aerobot 200a.

The system 100a may further be communicatively coupled to a central control computer 110. This may be accomplished, for example, by a communication subsystem 362 for the base station 300a, a communication subsystem 464a for the umbilical support assembly 400a, and/or a communication subsystem 247 for the aerobot 200a. The central control computer 110 may be used by an operator to manage the operation of the system 100a. Specifically, the central control computer 110 may include at least one software application 111 that provides a user interface for an operator to monitor the system 100a (e.g., operating status, sensor readings, error notifications) and/or to control the system 100a (e.g., input commands that are transmitted as one or more instructions for execution by the aerobot 200a, the base station 300a, and/or the umbilical support system 400a), as shown in FIG. 1A. For example, the central control computer 110 may be a portable device, such as a tablet or a phone, carried by the operator during operation of the system 100a. In another example, the central control computer 110 may be a computer integrated into the base station 300a with one or more user input devices (e.g., a pointing device (a mouse), tactile buttons, a keyboard, a touchscreen) to facilitate control of the central control computer 110.

The central control computer 110 may facilitate execution of one or more operations to clean a set of windows of a structure. The set of windows may include a subset of the windows of the structure or, in some instances, all the windows of the structure. This may be accomplished, for example, by the software application 111 generating a work plan for the system 100a to execute the one or more operations according to a predetermined schedule.

The work plan may specify, for example, one or more operations to be performed by the system 100a at each window in the set of windows. As described above, the operations may include, but are not limited to, applying a cleaning fluid 332 to a window and removing waste fluid 341 from the window. Each operation may specify a particular end effector 260 that should be used, thus informing the operator which end effectors 260 should be connected to the aerobot 200a before deployment. Additionally, the work plan may specify the order of the windows to be cleaned by the system 100a. For example, the order may correspond to the vertical position of the windows, where the topmost windows are cleaned first and the aerobot 200a progressively moves downwards to clean windows at a lower elevation with the bottommost windows being cleaned last. In another example, the order may correspond to the shortest overall path for the aerobot 200a to access each window in the set of windows. The work plan may also specify to the operator where the base station 300a should be placed with respect to the structure to ensure the aerobot 200a can access each of the windows in the set of windows. For example, the work plan may indicate a particular area near a building where the operator should deploy the base station 300a.

In one non-limiting example, an operation may utilize the aerobot 200a to apply a cleaning fluid 332 to at least a portion of a particular window of the structure. The central control computer 110 may transmit instructions to the aerobot 200a that include, for example, an indication of the end effector 260 to be used for the operation (e.g., the applicator end effector 260a), a coordinate location of the window in the environment to facilitate navigation to that window and/or provide a starting point to begin the operation (e.g., a GPS coordinate and altitude corresponding to a corner or center point of the window), and a predetermined trajectory for the aerobot 200a to follow in order to apply the cleaning fluid 332 to the surface of that window. The trajectory may be determined, in part, based on the geometry of the window, which may be obtained in a separate process (see Section 3 for further details). In view of the foregoing, it should be appreciated that, in some other example implementations, the aerobot 200a (as well as other aerobots disclosed herein) may be replaced by a more generic aerial vehicle that is not necessarily fully autonomous but which instead receives commands from one or more other controllers (e.g., the central control computer) to cause the aerial vehicle to perform at least one action (e.g., to facilitate the cleaning of one or more windows).

In another example, an operation may utilize the aerobot 200a to remove waste fluid 341 from at least a portion of a particular window of the structure. The central control computer 110 may transmit instructions to the aerobot 200a that include, for example, an indication of the end effector 260 to be used for the operation (e.g., the squeegee end effector 260d), a coordinate location of the window in the environment to facilitate navigation to that window and/or provide a starting point to begin the operation (e.g., a GPS coordinate and altitude corresponding to a corner or center point of the window), and a predetermined trajectory for the aerobot 200a to follow in order to remove the waste fluid 341 from the surface of that window. The trajectory, as described above, may be determined, in part, based on the geometry of the window. It should be appreciated that the trajectories used to respectively apply cleaning fluid 332 and to remove waste fluid 341 may be different.

It should be appreciated that, in some implementations, multiple operations may be performed to apply cleaning fluid 332 and/or remove waste fluid 341 from different portions of a window. For example, the removal of waste fluid 341 may be performed using two operations: 1) an operation to remove waste fluid 341 from a center portion of the window where the aerobot 200a is configured to move at a higher velocity at the expense of lower precision in the placement of the squeegee end effector 260d against the window; and 2) an operation to remove waste fluid 341 from an edge portion of the window where the aerobot 200a is configure to move at a lower velocity in favor of achieving a higher precision in the placement of the squeegee end effector 260d against the window.

When the aerobot 200a executes an operation, the umbilical support system 400a may automatically position the support assembly 430a to follow the aerobot 200a. The base station 300a may also automatically provide a continuous supply of cleaning fluid 332 to the aerobot 200a (e.g., via the cleaning fluid pump 334) and/or continuous suction to remove waste fluid 341 from the aerobot 200a (e.g., via the waste fluid pump 343). Thus, in some implementations, the central control computer 110 may only transmit an indication to the base station 300a and/or the umbilical support system 400a that an operation is starting. Thereafter, the base station 300a and/or the umbilical support system 400a may perform their respective functions without further instructions from the central control computer 110. The base station 300a and/or the umbilical support system 400a may stop once they receive an indication that a work plan is complete (e.g., by the aerobot 200a or the central control computer 110).

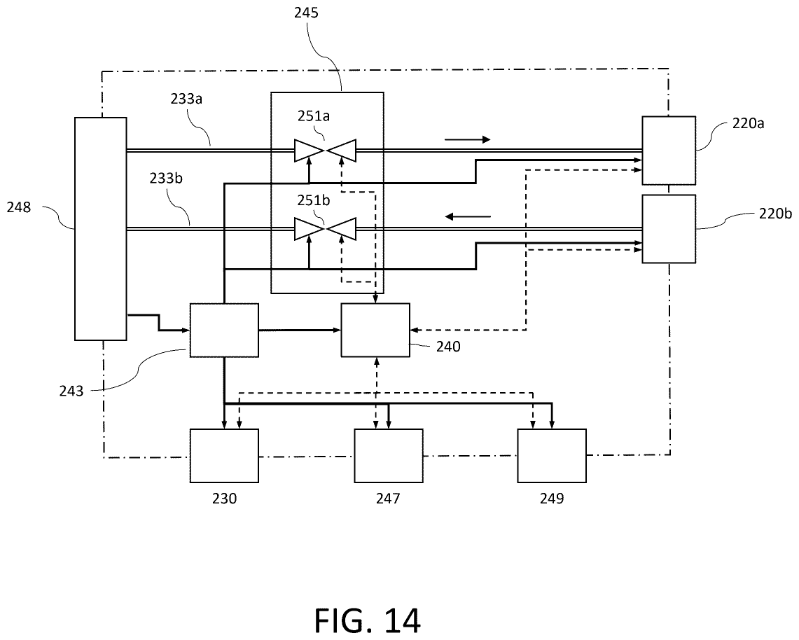

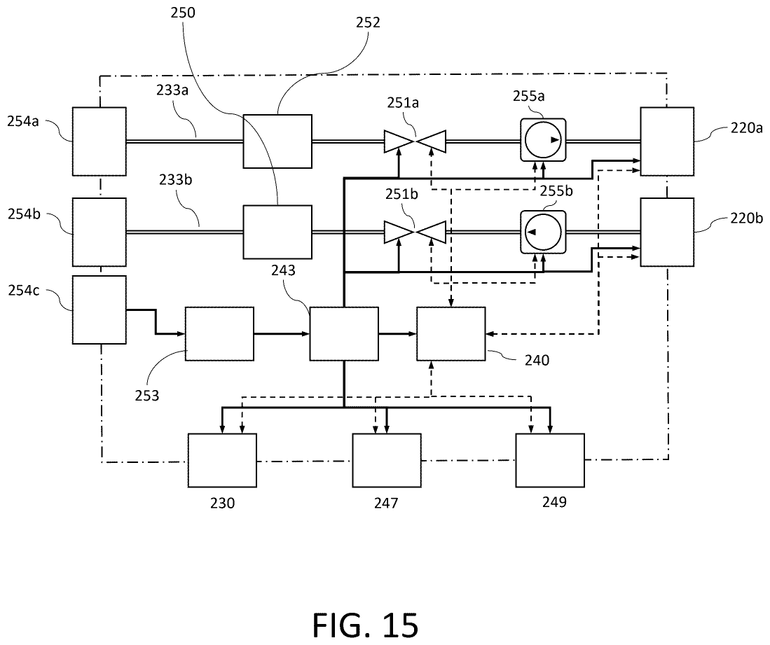

It should be appreciated that the aerobot 200a may include one or more valves to control the application of cleaning fluid 332 and/or suction of waste fluid 341 (see, for example, the valves 251a and 251b in FIGS. 14 and 15). For example, the valve for the cleaning fluid 332 may be opened and the valve for the waste fluid 341 may be closed when the aerobot 200a is performing the operation to apply the cleaning fluid 332. In another example, the valve for the cleaning fluid 332 may be closed and the valve for the waste fluid 341 may be open when the aerobot 200a is performing the operation to remove waste fluid 341. In yet another example, the valves for both the cleaning fluid 332 and the waste fluid 341 may be closed when the aerobot 200a is moving between windows. The operation may specify when respective valves should be opened or closed along the trajectory.

In one illustrative example, FIGS. 1A-ID show several operations that may be performed on a structure 10 according to a work plan. In FIG. 1A, the aerobot 200a is shown executing an operation to apply cleaning fluid 332 to a top window 12a using an applicator end effector 260a. Specifically, Inset B of FIG. 1A shows a fluid applicator 270a of the applicator end effector 260a is brought into physical contact with the exterior surface of the top window 12a and moved laterally across the top window 12a in a positive X direction. The movement of the fluid applicator 270a may also scrub the exterior surface of the top window 12a. Once the fluid applicator 270a reaches the other side of the top window 12a, the aerobot 200a may move down and thereafter move in the negative X direction. This process may be repeated (e.g., alternating movement along the positive and negative X direction) until the top window 12a is substantially covered in cleaning fluid 332. In some implementations, when the fluid applicator 270a contacts the exterior surface of the top window 12a, which may be detected based on measurements of contact pressure using a pressure sensor integrated into the fluid applicator 270a (see, for example, sensor(s) 268 in FIG. 16B), the aerobot controller 240 of the aerobot 200a may open a valve (e.g., valve 251a) to allow cleaning fluid 332 to flow out of the fluid applicator 270a.

After the operation to apply cleaning fluid 332 to the top window 12a is complete, the aerobot 200a may then execute another operation to remove the resulting waste fluid 341 from the exterior surface of the top window 12a. FIG. 1B shows the aerobot 200a may change its orientation and position such that squeegee blade 290a of the squeegee end effector 260d is brought into physical contact with a top portion of the exterior surface. Thereafter, the squeegee end effector 260d is moved laterally across the window 12a in the positive X direction while suctioning waste fluid 341, as shown in Inset A of FIG. 1B. Once the squeegee blade 290a reaches the other side of the top window 12a, the aerobot 200a may move down and thereafter move in the negative X direction in a manner that keeps the squeegee blade 290a in contact with the window 12a. This process may be repeated (e.g., alternating movement along the positive and negative X direction) until the waste fluid 341 from the top window 12a is substantially removed. For example, FIG. 1C shows the aerobot 200a at a lower vertical position with the squeegee end effector 260d contacting a bottom portion of the top window 12a. In some implementations, when the squeegee blade 290a contacts the exterior surface of the window 12a, which may be detected based on measurements of contact pressure using a pressure sensor integrated into the squeegee blade 290a (see, for example, sensor(s) 288 in FIG. 19B), the aerobot controller 240 of the aerobot 200a may open a valve (e.g., valve 251b) to allow suction of waste fluid 341 from the squeegee end effector 260d.

In FIGS. 1A-1C, the support assembly 430a may remain at the same position above the aerobot 200a even as the aerobot 200a moves from the top portion to the bottom portion of the top window 12a. This may be achieved, in part, by the first portion 353a of the umbilical cord 352 providing sufficient slack to allow the aerobot 200a to move to each respective corner of the window 12a without the first portion 353a of the umbilical cord 352 being pulled taut. Once the aerobot 200a completes the operation to remove waste fluid 341 from the top window 12a, the aerobot 200a may then move downwards to begin another operation to apply cleaning fluid 332 to a bottom window 12b. As this occurs, the umbilical support system 400a may also lower the support assembly 430a, as shown in FIG. 1D (e.g., via automated activation of the cable winch 414). In this manner, the umbilical support system 400a may keep the distance between the aerobot 200a and the umbilical pulley assembly 436a within a predetermined range to ensure the first portion 353a of the umbilical cord 352 is not pulled taut.

1.2 an Example Outdoor Window Cleaning System with a Ground-Based Base Station and a Roof Anchor with a Boom Arm

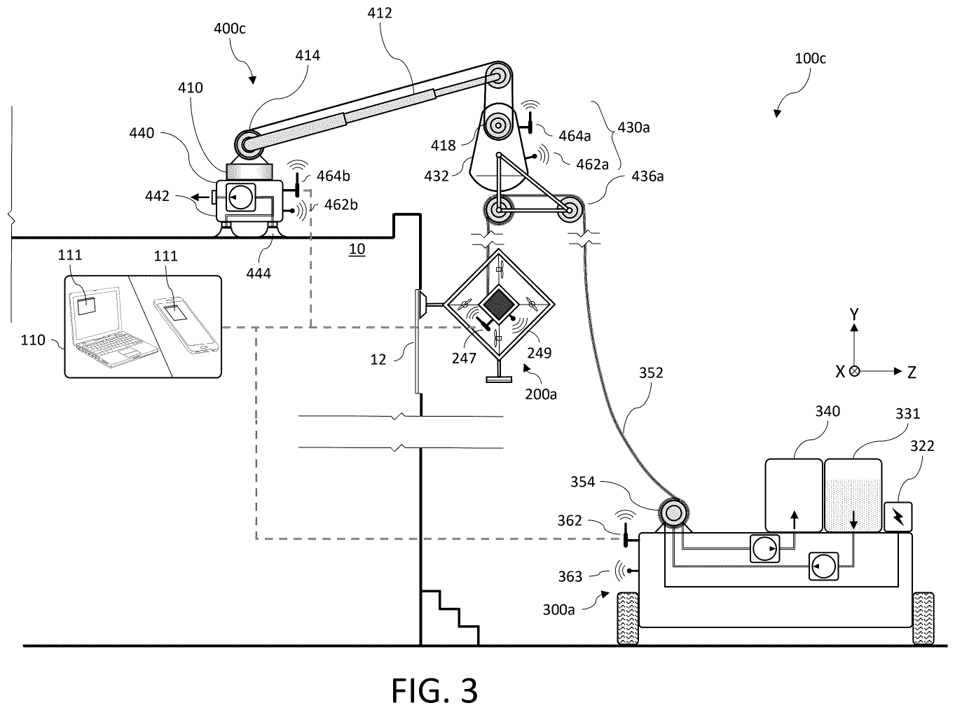

FIG. 3 shows another example outdoor window cleaning system 100c that includes a base station 300a deployed on the ground near a structure 10 and an umbilical support system 400c with a boom arm 412 and a suspended support assembly 430a deployed on a roof of the structure 10. The system 100c may include several of the same features, components, and/or subsystems as the systems 100a and 100b. The system 100c may further operate in a similar manner as the systems 100a and 100b unless indicated otherwise. For brevity, repeated discussions of these features may not be provided below.

As shown, the umbilical support system 400c may include a roof anchor 440 to support the rotation stage 410, the boom arm 412, and the support assembly 430a. The roof anchor 440 may include a suction system 442 with one or more suction cups 444 to securely couple the umbilical support system 400c to the roof. The suction system 442 may include a pump 450 to remove air from within the suction cup(s) 444, thus creating a vacuum to hold the umbilical support system 400c to the surface of the roof. Further details of the roof anchor 440 are discussed in Section 2.3 regarding FIG. 30. It should be appreciated that the suction system 442 is one non-limiting example of a mechanism that may be used to securely couple the roof anchor 440 to the roof the structure 10. More generally, the roof anchor 440 may provide any coupling mechanism that securely couples the umbilical support system 400c to the surface of the roof including, but not limited to, one or more clamps, one or more bolted mounts, one or more wheels with respective brakes to prevent rotation when engaged, and/or the like. The roof anchor 440 may further include a communication subsystem 464b to communicatively couple the umbilical support system 400c to the aerobot 200a, the base station 300a, and/or the central control computer 110. The roof anchor 440 may also include one or more senor(s) 462b to monitor various operating parameter(s) associated with the roof anchor 440 and/or environmental conditions near the roof anchor 440.

The system 100c may be suitable for both low-rise and high-rise buildings (e.g., skyscrapers) provided the roof anchor 440 of the umbilical support system 400c can be mounted to the roof or at least an elevated surface of the building. For high-rise buildings, the length of the second portion of the umbilical cord 352 may be appreciably long (e.g., the length of the second portion 353b may span the height of the building). Thus, a suitable cleaning fluid pump 334 may be used in the base station 300a to ensure cleaning fluid 332 is provided at a desired pressure and/or flow rate.

1.3 an Example Outdoor Window Cleaning System with a Roof-Based Base Station and a Boom Arm

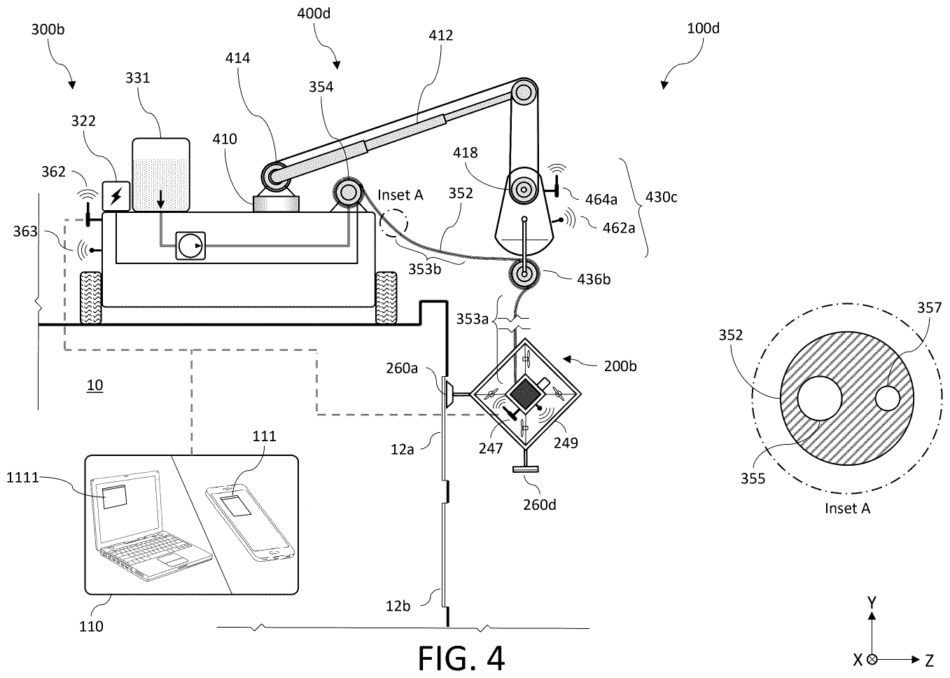

FIG. 4 shows another example outdoor window cleaning system 100d that includes an aerial vehicle (e.g., an aerobot) 200b, a base station 300b deployed on the roof of a structure 10, and an umbilical support system 400d with a boom arm 412 and a suspended support assembly 430c directly mounted to the base station 300b. The system 100d may include several of the same features, components, and/or subsystems as the systems 100a through 100c. The system 100d may further operate in a similar manner as the systems 100a through 100c unless indicated otherwise. For brevity, repeated discussions of these features may not be provided below.

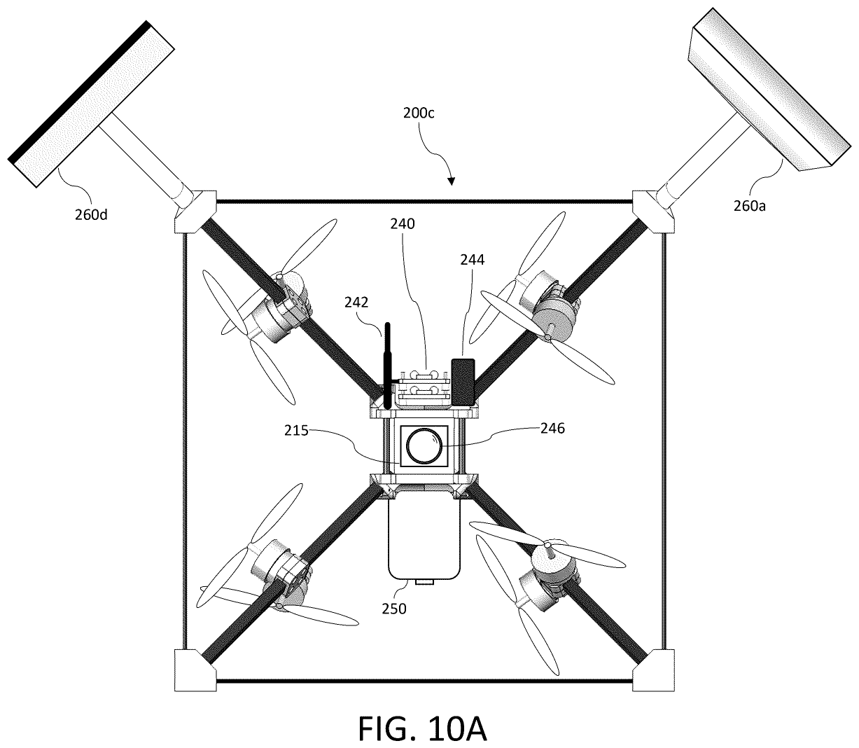

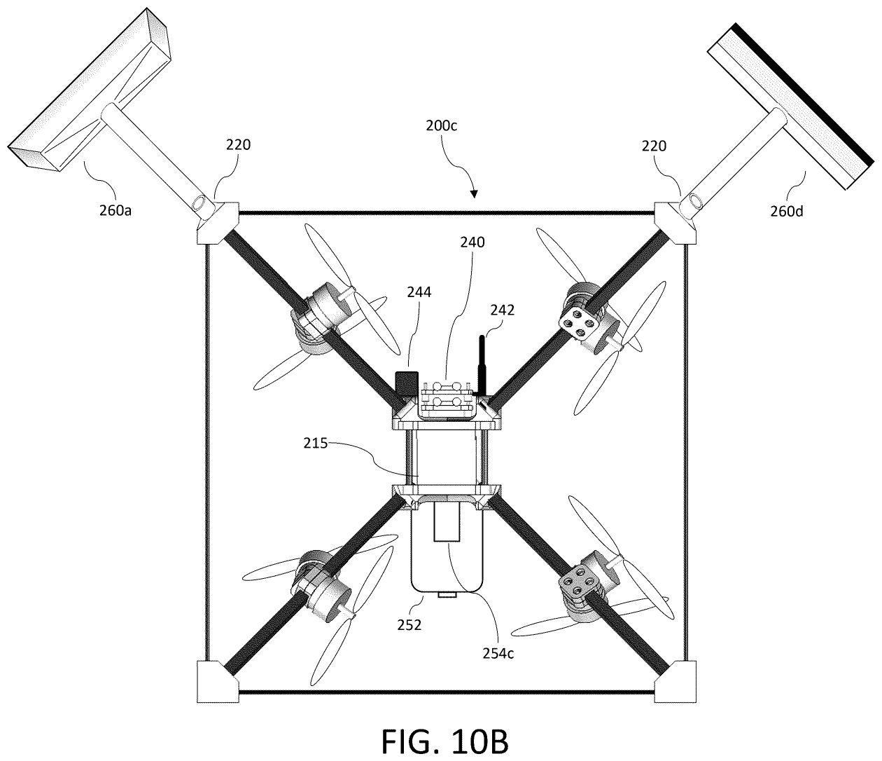

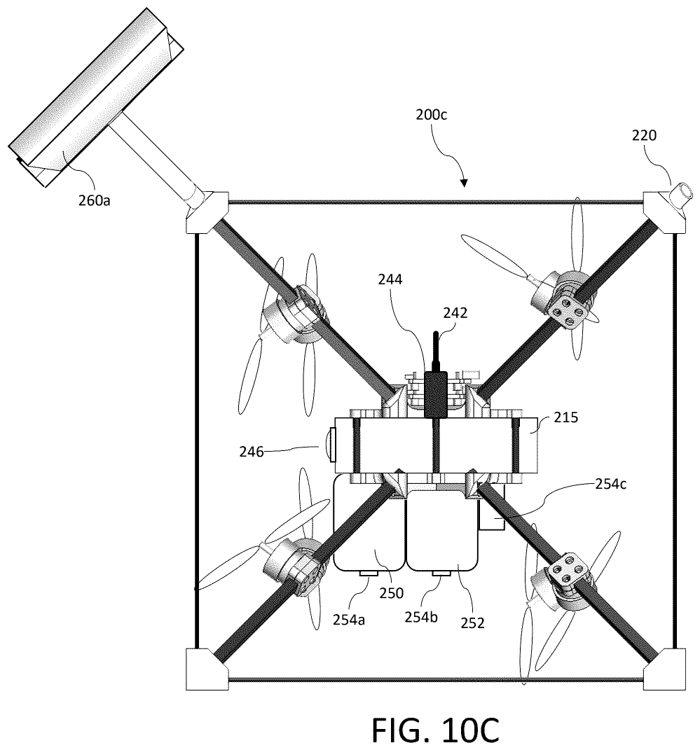

As shown, the base station 300b may generally be disposed above the aerobot 200b as the aerobot 200b cleans the windows of the structure 10. As a result, the base station 300b may be unable to suction waste fluid 341 from the aerobot 200b if the vertical length of the umbilical cord 352 between base station 300b and the aerobot 200b exceeds a threshold of about 10.3 meters (i.e., the height of a column water supported by ambient pressure at sea level). Therefore, the base station 300b may not include a waste fluid tank, a waste fluid pump, and a corresponding waste fluid conduit. Additionally, the umbilical cord 352 may only include a fluid conduit 355 to carry cleaning fluid 332 and an electrical conduit 357 to carry electrical power to the aerobot 200b, as shown in Inset A of FIG. 4. Instead, the aerobot 200b may include an onboard waste fluid pump (not shown) and an onboard waste fluid tank (see, for example, the waste fluid tank 250 onboard the aerobot 200c in FIGS. 10A-10C).

It should be appreciated that the system 100d represents one non-limiting approach to address the above issue of limited suction when a base station (e.g., the base station 300b) is deployed on an elevated surface of a structure above the aerobot 200a. In another approach, the waste fluid pump may be integrated into the support assembly 430c to provide suction to remove waste fluid from the aerobot 200a provided the length of the first portion 353a of the umbilical cord 352 remains less than 10.3 meters. In some implementations, a waste fluid tank may also be integrated into the support assembly 430c to store the waste fluid 341. For example, the waste fluid tank may continue to accumulate waste fluid 341 during operation and may be emptied after the system 100d completes a work plan. In some implementations, the support assembly 430c may include a second pump configured to pump the waste fluid 341 up the umbilical cord 352 to the base station 300b for storage in a waste fluid tank onboard the base station 300b. For this approach, the umbilical cord 352 in the system 100a may be used.

FIG. 4 also shows the umbilical support system 400d may include an umbilical pulley assembly 436b with a single umbilical pulley 438. During operation, the second portion 353b of the umbilical cord 352 may be disposed above the aerobot 200b since the base station 300b is disposed above the aerobot 200b and thus unlikely to fall onto and/or entangle with the aerobot 200b. Thus, the single umbilical pulley 438 may be sufficient to support the umbilical cord 352.

The system 100d may be suitable for high-rise buildings (e.g., skyscrapers). In some implementations, the aerobot 200b, the base station 300b, and the umbilical support system 400d may be dimensioned to fit within an elevator of the building (e.g., a freight elevator) to facilitate greater ease of deployment on the roof or an elevated surface of the building. Additionally, the base station 300b may include one or more wheels (e.g., wheels 312) to allow the operator readily position and orient the base station 300b as desired. In some implementations, the base station 300b may have sufficient weight to counteract the weight of the support assembly 430c and/or the aerobot 200b. Thus, it may be sufficient to lock the wheels of the base station 300b during operation. In some implementations, the base station 300b may include a coupling mechanism to couple to a structural member of the roof (e.g., a clamp coupled to a hook on the roof).

1.4 an Example Outdoor Window Cleaning System with a Support AAV

In the systems 100a-100d, the respective support assemblies may compensate for external disturbances, in part, by including a ballast 432 that increases the overall mass of the support assembly. The ballast 432 represents a passive approach to mitigate the effects of external disturbances. It should be appreciated, however, that external disturbances may also be compensated using an active approach, e.g., the support assembly actively generates a force to counteract an external disturbance.

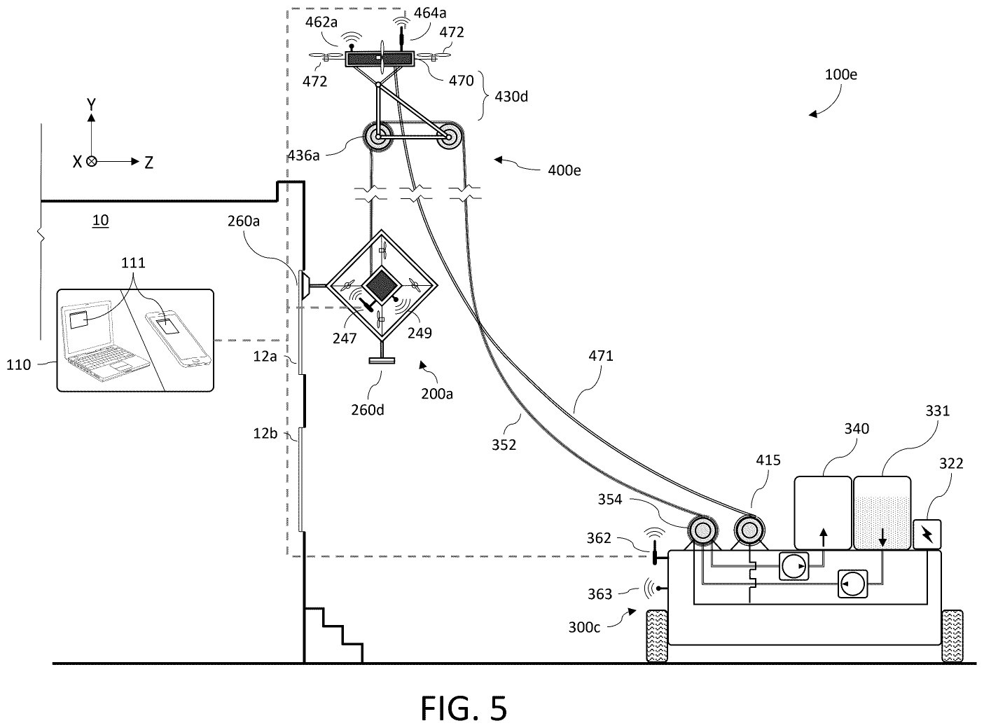

For example, FIG. 5 shows an outdoor window cleaning system 100e with an umbilical support system 400e that includes a support autonomous aerial vehicle (AAV) 470 to support at least a portion of the umbilical cord 352. It should be appreciated that the system 100e may include several of the same features, components, and/or subsystems as the systems 100a through 100d. The system 100e may further operate in a similar manner as the systems 100a through 100d unless indicated otherwise. For brevity, repeated discussions of these features may not be provided below.

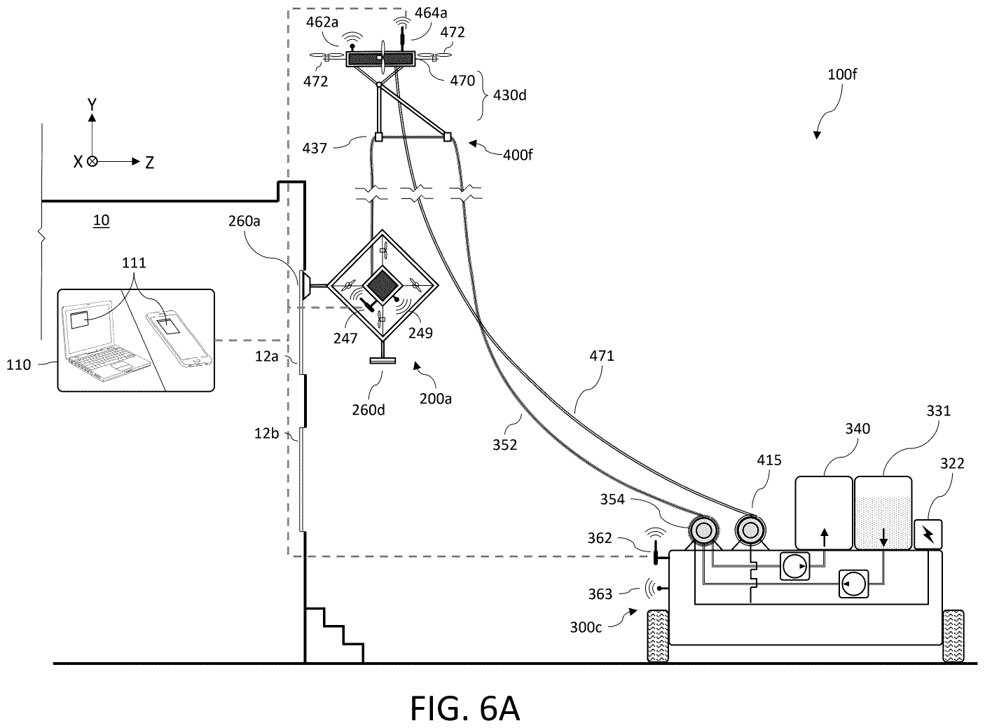

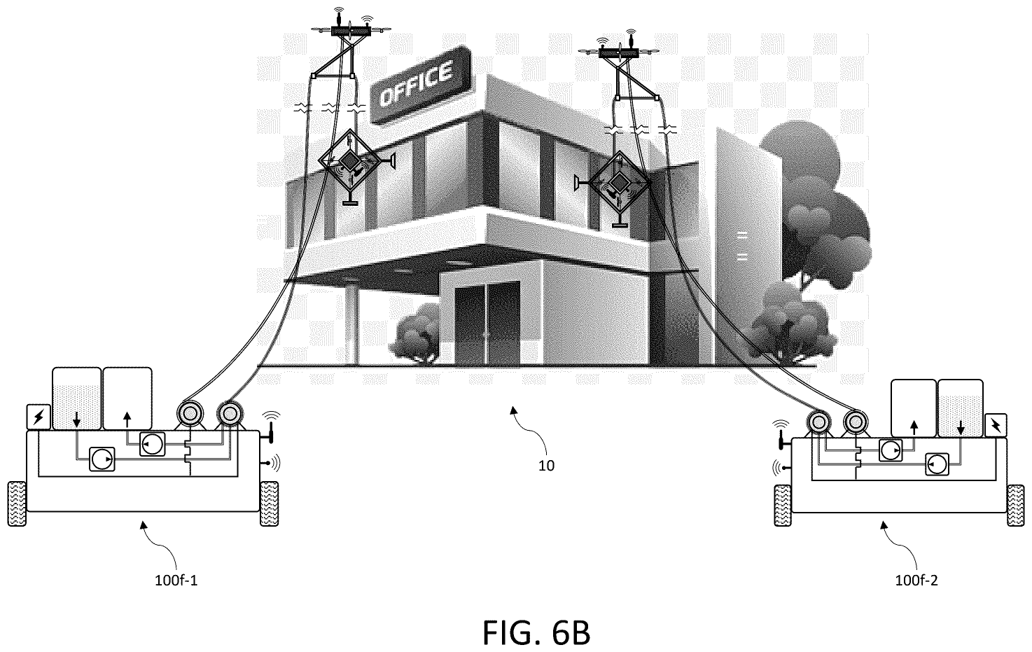

As shown, an umbilical pulley assembly 436a may be directly mounted below the support AAV 470 to suspend a portion of the umbilical cord 352 above the aerobot 200a. Alternatively, the support AAV 470 may support a clamp assembly 437, as shown in the umbilical support system 400f of the system 100f in FIG. 6A. Thus, the support AAV 470 may generally be disposed above the aerobot 200a during operation. The support AAV 470 may include one or more thrusters 472 (e.g., a brushless electric motor with a rotor) configured to generate thrust in different directions to facilitate flight and/or to maintain a particular position and/or attitude of the support AAV 470 (e.g., when supporting the umbilical cord 352 above the aerobot 200a during operation). Thus, the thrusters 472 may simultaneously A) provide sufficient lift to support the weight of, for example, the umbilical cord 352, the aerobot 200a, the umbilical pulley assembly 436a, the support AAV 470 itself, and a support cord 471, which supplies electrical power to the support AAV 470, and B) counteract any external disturbances (e.g., wind) acting on the support AAV 470 and/or the umbilical pulley assembly 436a.

During operation, the thrusters 472 of the support AAV 470 may be actively adjusted by an onboard controller such that the umbilical pulley assembly 436a is substantially stationary or, in some instances, stationary. The support AAV 470 may also be configured to follow the aerobot 200a as the aerobot 200a flies to different windows so that the support AAV 470 is disposed above the aerobot 200a with a small horizontal offset or, in some instances, the support AAV 470 is disposed directly above the aerobot 200a. In this manner, the first portion 353a of the umbilical cord 352 disposed between the aerobot 200a and the umbilical pulley assembly 436a may remain substantially vertically oriented with some slack. This may be accomplished, for example, by the support AAV 470 having sensor(s) 462a that includes an onboard location tracker where the controller is configured to monitor and maintain a particular distance to the aerobot 200a based on the difference between the measured coordinates of the aerobot 200a and the support AAV 470. In this manner, the support AAV 470 and the umbilical pulley assembly 436a may provide a similar function as the support assembly 430a-430c in the umbilical support systems 400a-400d in terms of reducing or, in some instances, mitigating transfer of undesirable forces to the aerobot 200a from the umbilical cord 352.

The support AAV 470 may receive electrical power from a base station 300c via the support cord 471 separate from the umbilical cord 352. This may allow the support AAV 470 to maintain continuous flight together with the aerobot 200a. FIG. 5 shows the system 100f may include a support cord winch 415 to extend or retract the support cord 471. Similar to the umbilical cord winch 414, the support cord winch 415 may actively adjust the length of the support cord 471 between the support AAV 470 and the base station 300c to maintain slack in the support cord 471 while preventing the support cord 471 from touching the ground and/or getting caught on environmental obstacles.

1.5 An Example Outdoor Window Cleaning System with an Aerostat

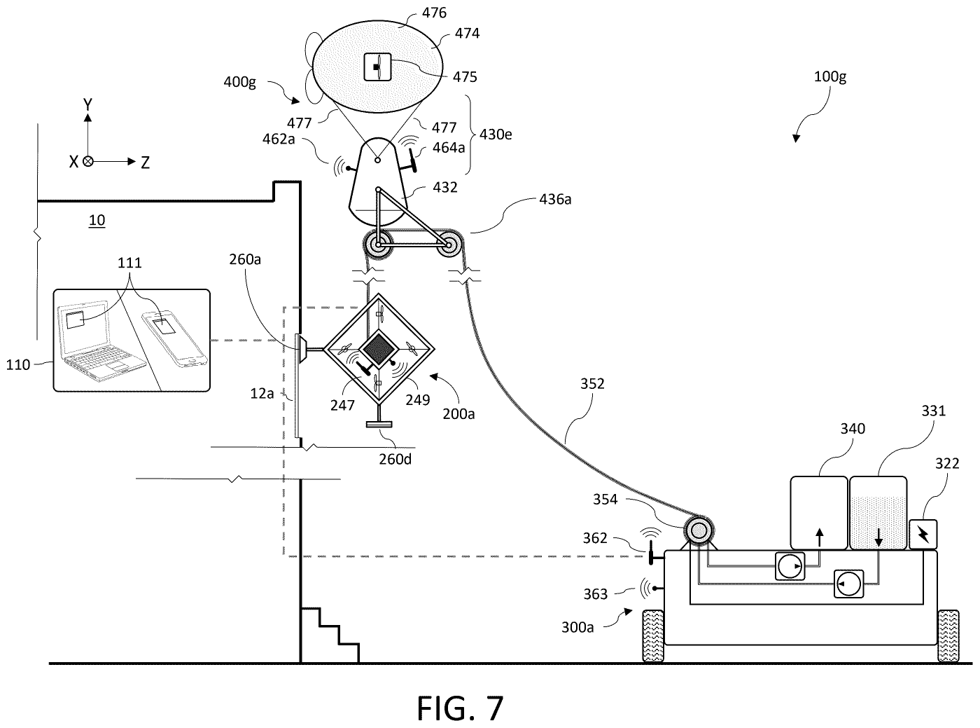

FIG. 7 shows another example outdoor window cleaning system 100g with an umbilical support system 400g that includes an aerostat 474 to support at least a portion of the umbilical cord 352. It should be appreciated that the system 100g may include several of the same features, components, and/or subsystems as the systems 100a through 100f. The system 100g may further operate in a similar manner as the systems 100a through 100f unless indicated otherwise. For brevity, repeated discussions of these features may not be provided below.

As shown, the aerostat 474 may include a balloon 476 that contains a lighter-than-air gas, such as helium, which provides lift. The aerostat 474 may further support a ballast 432 and an umbilical pulley assembly 436a via one or more cables 477 to support at least a portion of the umbilical cord 352 in a manner similar to the support AAV 470 in systems 100e and 100f. Compared to the support AAV 470, however, the balloon 476 of the aerostat 474 provides a passive source of lift, resulting in less power consumption, or, in some instances, no power consumption for the aerostat 474 to remain afloat. Said in another way, the lift provided by the gas may be sufficient to carry the weight of, for example, the ballast 432, the umbilical pulley assembly 436a, the umbilical cord 352, the aerobot 200a, and/or the balloon 476 and thrusters 475.

The aerostat 474 may adjust its elevation by adding gas to the balloon 476 (i.e., inflating the balloon 476) or removing gas from the balloon 476 (i.e., deflating the balloon 476). This may be accomplished, for example, by including an onboard supply of gas (e.g., a tank of compressed gas) and a pump mechanism (e.g., a two-way pump) that may be configured to inflate and deflate the balloon 476. When deflating the balloon 476, the gas may be recompressed and stored in the tank. The aerostat 474 may further include one or more thrusters 475 (e.g., a brushless electric motor with a rotor) configured to generate thrust along a horizontal direction (e.g., forward or reverse). For example, the aerostat 474 may include at least one pair of thrusters 475 disposed on opposing sides of the aerostat 474 such that, when one thruster 475 is activated, the aerostat 474 may rotate. In another example, the aerostat 474 may include a steerable thruster 475 (e.g., a thruster 475 that is rotatable about one or more axes). The combination of the balloon 474 and the thrusters 475 may thus provide control over multiple degrees of freedom to adjust the position and/or attitude of the umbilical pulley assembly 436a.

The aerostat 474 may actively use the pumping mechanism and/or the thrusters 475 to actively follow the aerobot 200a during operation. The pumping mechanism and/or the thrusters 475 may also be used to counteract external disturbances (e.g., wind) acting on the aerostat 474, the ballast 432, or the umbilical pulley assembly 436a. In some implementations, the balloon 476 may also be shaped to turn towards the wind (e.g., the front of the balloon 476 is oriented towards a direction opposite the direction of the wind) or away from the wind (e.g., the front of the balloon 476 is oriented towards a direction that is the same as the direction of the wind). That way, the thrusters 475 that are mounted to the balloon 474 and oriented to generate thrust to move the balloon 474 forwards or backwards may be used to counteract the wind. Thus, the balloon 476 itself may provide a passive mechanism to compensate for external disturbances.

In some implementations, the umbilical cord 352 may function as a tether to prevent, for example, the aerostat 474 from floating away from the base station 300a. Additionally, the passive manner in which the aerostat 474 achieves lift may also prevent the aerobot 200a from falling to the ground in the event the aerobot 200a loses power and lift.

### 1.6 An Example Indoor Window Cleaning System

As described above, the window cleaning systems 100a-100g are generally configured for outdoor applications. However, it should be appreciated that the various concepts disclosed herein may be applied for indoor applications as well. Compared to outdoor environments, indoor environments typically contain more obstacles (e.g., furniture, pendant lighting, etc.) that may pose a risk for entanglement with an umbilical cord. Thus, in some implementations, the indoor window cleaning systems contemplated herein may forego an umbilical cord and instead incorporate the various subsystems to supply cleaning fluid, power, and/or retrieve waste fluid onto the aerobot directly.

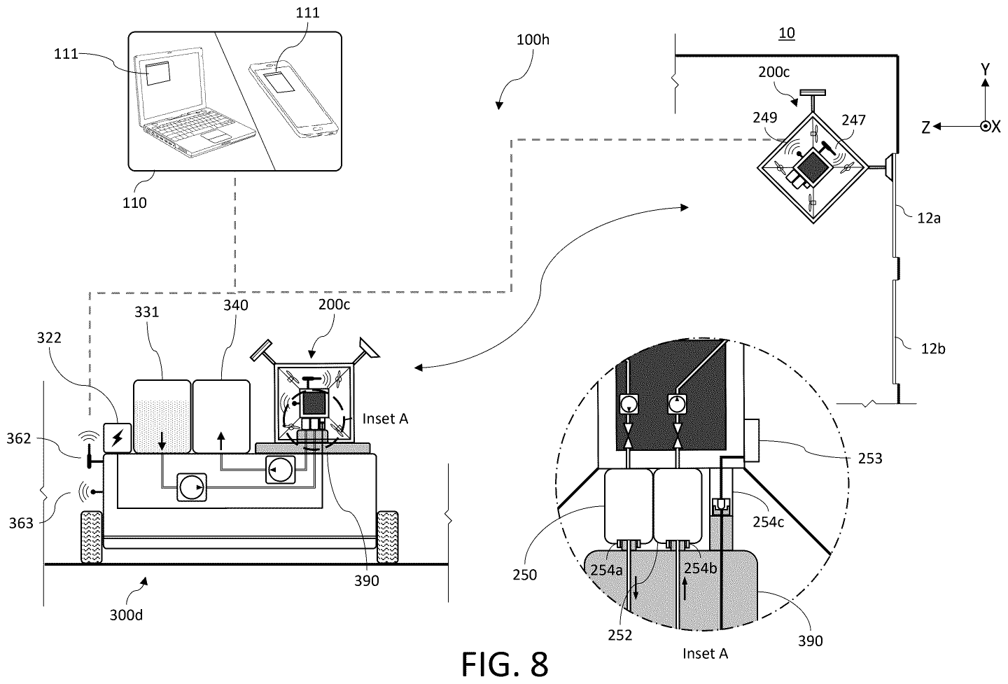

For example, FIG. 8 shows an indoor window cleaning system 100h that includes an aerobot 200c to perform one or more operations to clean an interior surface of a window (e.g., windows 12a and 12b). It should be appreciated that the system 100h may include several of the same features, components, and/or subsystems as the systems 100a through 100g. For brevity, repeated discussions of these features may not be provided below.

As shown, the aerobot 200c may include a cleaning fluid tank 252 to store cleaning fluid 332, a cleaning fluid pump 255a to supply cleaning fluid 332 to an applicator end effector 260a, a waste fluid tank 250 to store waste fluid 341, a waste fluid pump 255b to suction waste fluid 341 from a squeegee end effector 260d, and an energy storage module 253 (e.g., a battery, a supercapacitor) to provide a source of electrical power. The system 100h may further include a base station 300d with a docking port 390 to simultaneously refill the cleaning fluid tank 252 with cleaning fluid 332 via a cleaning fluid port 254a, remove waste fluid 341 from the waste fluid tank 250 via a waste fluid port 254b, and recharge the energy storage module 253 via a charging port 254c. The processes of supplying cleaning fluid 332 to the aerobot 200c and removing waste fluid 341 from the aerobot 200c may be facilitated, in part, by respective cleaning fluid and waste fluid pumps 334 and 343 integrated into the base station 300d. In some implementations, the cleaning fluid port 254a and the waste fluid port 254b may directly connect to respective fluidic connections on the docking port 390 of the base station 300d.

Although the duration that the aerobot 200c can operate may be limited by the energy capacity of the energy storage module 253 and/or the capacity of the cleaning fluid or waste fluid tanks 252 and 250, it should be appreciated that the distance between the aerobot 200c and the base station 300d is typically smaller in indoor settings compared to outdoor settings. Moreover, the base station 300d may support multiple aerobots 200c. For example, one aerobot 200c may dock with the base station 300d while another aerobot 200c performs an operation. The two aerobots 200c may be configured to perform operations such that the likelihood that both aerobots 200c require docking to the base station 300d is small or, in some instances, negligible.

### 1.7 Deployment of Multiple Window Cleaning Systems

It should be appreciated that the window cleaning systems disclosed herein (e.g., the systems 100a-100h) may generally be used in multiples and/or in various combinations. In one illustrative example, FIG. 6B shows a pair of outdoor window cleaning systems 100f-1 and 100f-2 deployed to clean different portions of a building 10. In some implementations, the workplans for each systems 100f-1 and 100f-2 may divide the windows of the building 10 to be cleaned and executed simultaneously, thus reducing the total time required to clean all the windows of the building 10. In another example, the system 100a and the system 100d may be deployed together. The system 100a may be configured to clean the windows on the lower floors of a building and the system 100d may be configured to clean the windows on the upper floors of the building.

### 2. EXAMPLE COMPONENTS OF A WINDOW CLEANING SYSTEM

This section provides additional discussion on respective components and subsystems of the window cleaning systems 100a-100g described in Section 1. It should also be appreciated that one or more features of the components and/or subsystems described in this section may be readily combined or substituted with other features of other components and/or subsystems provided the combination or substitution does not result in mutually inconsistent features.

### 2.1 Example Aerobots for Window Cleaning Systems

As described above, the aerobots 200a-200c used in the window cleaning systems 100a-100h may be configured to control each of its six degrees of freedom independently. In other words, the aerobots may be omnidirectional aerobots. The aerobots disclosed herein may be based, in part, on previous demonstrations of omnidirectional aerobot as disclosed in, for example, Brescianini et al., “An omni-directional multirotor vehicle,” Mechatronics, vol. 55, pp. 76-93, 2018, Brescianini et al., “Design, modeling and control of an omni-directional aerial vehicle,” 2016 IEEE International Conference on Robotics and Automation (ICRA), Stockholm, Sweden, pp. 3261-3266, 2016, Brescianini et al., “Computationally Efficient Trajectory Generation for Fully Actuated Multirotor Vehicles,” in IEEE Transactions on Robotics, vol. 34, no. 3, pp. 555-571, June 2018, or Omnicopter. PX4 Autopilot. (n.d.). Retrieved Mar. 20, 2023, from https://docs.px4.io/main/en/frames_multicopter/omnicopter.html. Each of the aforementioned references is incorporated by reference herein in its entirety.

For example, FIGS. 9A-9E show several views of the aerobot 200a. As shown, the aerobot 200a includes a frame 210 to mechanically support and/or protect various components of the aerobot 200a. In some implementations, the frame 210 may have a tesseract geometry. Specifically, the frame 210 may include a cubic-shaped inner frame 214 and a cubic-shaped outer frame 212 concentrically aligned with the inner frame 214. The respective vertices of the inner frame 214 are connected to the nearest vertices of the outer frame 212 via a strut 216. The aerobot 200a may include eight thrusters 230 rigidly mounted to respective struts 216 of the frame 210 and arranged such that the aerobot 200a can move in any desired direction and/or rotate about any desired axis by adjusting the thrust generated by the one or more of the thrusters 230.

Each thruster 230 may include a DC brushless electric motor with a rotor, which rotates at variable speeds to generate a variable amount of thrust. In some implementations, half of the thrusters 230 may have one handedness and the remaining half of the thrusters 230 may have another handedness. For example, four of the eight thrusters 230 may rotate counterclockwise to generate positive thrust and the remaining four thrusters 230 may rotate clockwise to generate positive thrust. The thrusters 230 may be fixed-pitch rotors where the thruster 230 switches between positive and negative thrust by reversing the direction of rotation of the rotor. The thrusters 230 may be variable-pitch rotors where the thruster 230 switches between positive and negative thrust by using an actuator to adjust the angle of attack of the rotors between positive to negative. It should be appreciated that the aerobot 200a is not limited to only having eight thrusters 230. More generally, the aerobot 200a may include fewer thrusters (e.g., at least six thrusters) or more thrusters.

The inner frame 214 may also include a housing 215 to support various components of the aerobot 200a. For example, the aerobot 200a may further include a communication subsystem 247 to communicatively couple the aerobot 200a, for example, to the central control computer 110, the umbilical support system 400a, and/or the base station 300a in the outdoor window cleaning system 100a. It should be appreciated that the aerobot 200a may be communicatively coupled to other variants of the umbilical support system (e.g., the umbilical support systems 400b-400g) and the base station (e.g., the base stations 300b-300d). The communication subsystem 247 may include, for example, radio frequency (RF) antenna 242. In another example, the aerobot 200a may include one or more sensors 249 to measure various operation parameters of the aerobot 200a and/or environmental conditions near the aerobot 200a. The sensor(s) 249 may generally include, but are not limited to, an inertial measurement unit (IMU) (e.g., accelerometer(s), gyroscope(s), magnetometer(s)), a location tracker 244 (e.g., a GNSS receiver, such as a global positioning system (GPS) receiver, an altimeter), one or more imaging systems 246 (e.g., a camera, a LiDAR imager), a temperature sensor, a relative humidity sensor, and an anemometer. In some implementations, some of the sensors 249 (e.g., the anemometer) may be deployed onto the support assembly of an umbilical support system to measure, for example, environmental conditions that, in turn, are used by the aerobot 200a. That way, the payload on the aerobot 200a may be reduced.

The aerobot 200a may support one or more end effectors 260. This may be accomplished by the aerobot 200a having one or more end effector connectors 220 with each connector 220 supporting an end effector 260. For example, FIG. 9A shows the aerobot 200a may support up to four end effectors 220. Generally, each end effector connector 220 may provide a secure mechanical connection between the end effector 260 and the aerobot 200a, a fluidic connection to transfer at least one fluid, and an electrical connection to electrically couple, for example, one or more sensors in the end effector 260 to the aerobot controller 240 of the aerobot 200a or to power one or more motorized joints in the end effector 260. Thus, the aerobot 200a may be equipped with multiple end effectors 260 to perform multiple operations. Compared to conventional aerobots that may only support one end effector, the aerobot 200a may appreciably reduce or, in some instances, eliminate any downtime associated with swapping out end effectors to perform different operations.

The aerobot 200a may further include an umbilical port 248 that couples to an umbilical connector 370 on the umbilical cord 352, which provides electrical power to the aerobot 200a, cleaning fluid 332 from the base station, and/or a conduit to transfer waste fluid 341 from the aerobot 200a to the base station. The umbilical port 248 may include, for example, an electrical power port 384 to receive electrical power, a cleaning fluid port 382 to receive cleaning fluid 332 from the base station, and/or a waste fluid port 383 to transfer waste fluid 341 to the base station. The aerobot 200a may further include a fluid management subsystem 245 to facilitate distribution of fluid (e.g., cleaning fluid 332, waste fluid 341) to and from the aerobot 200a via the umbilical port 248 and a power supply subsystem 243 to distribute electrical power to various components in the aerobot 200a.

The aerobot 200a may also include an aerobot controller 240 communicatively coupled to the thrusters 230, the communication subsystem 247, the sensor(s) 249, the end effectors 260, the fluid management subsystem 245, and/or the power supply subsystem 243. The aerobot controller 240 may be responsible for managing the operation of these various components and/or subsystems. For example, the aerobot controller 240 may facilitate transmission of sensory data to the central control computer 110. In another example, the aerobot controller 240 may facilitate execution of an operation, e.g., by adjusting the respective electric motors of each thruster 230 to produce different thrusts so that the aerobot 200a moves along a desired trajectory. In yet another example, the aerobot controller 240 may activate or deactivate application of a cleaning fluid 332 via an applicator end effector (e.g., the applicator end effector 260a) or removal of waste fluid 341 via a squeegee end effector (e.g., the squeegee end effector 260d).

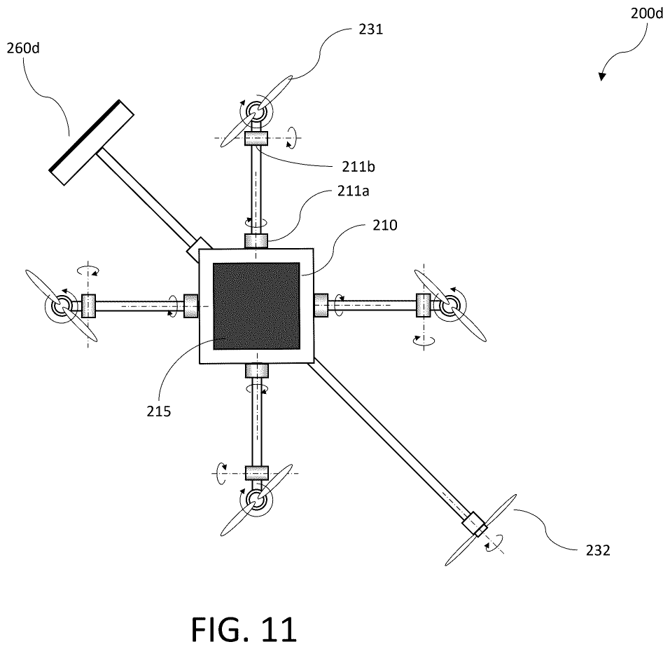

It should be appreciated that the aerobots 200a-200c are non-limiting examples and that other omnidirectional aerobots are also contemplated herein for use in the window cleaning systems 100a-100h. For example, FIG. 11 shows another example aerobot 200d with four thrusters 231 that are each coupled to a frame 310 via two rotary joints 211a and 211b. The rotary joints 211a and 211b may thus independently orient each thruster 231 in different directions to produce thrust in any desired direction to change the position and/or attitude of the aerobot 200d. Additionally, the aerobots disclosed herein may include at least one thruster in a fixed orientation to provide additional thrust along a desired direction during operation. For example, the aerobot 200d may include a horizontal thruster 232 disposed opposite to an end effector 260 (e.g., the squeegee end effector 260d) a to generate additional thrust to increase the contact pressure between the end effector 260 and a window surface during operation.

Additional examples and details of omnidirectional aerobots, particularly omnidirectional aerobots with rotatable thrusters, may be found in Allenspach et al., “Design and optimal control of a tiltrotor micro-aerial vehicle for efficient omnidirectional flight,” The International Journal of Robotics Research. 2020; 39 (10-11): 1305-1325, Zhang et al., “Learning Dynamics for Improving Control of Overactuated Flying Systems,” in IEEE Robotics and Automation Letters, vol. 5, no. 4, pp. 5283-5290 October 2020, Zhang et al., “Active Model Learning using Informative Trajectories for Improved Closed-Loop Control on Real Robots,” 2021 IEEE International Conference on Robotics and Automation (ICRA), Xi'an, China, pp. 4467-4473, 2021, Pantic et al., “Mesh Manifold Based Riemannian Motion Planning for Omnidirectional Micro Aerial Vehicles,” in IEEE Robotics and Automation Letters, vol. 6, no. 3, pp. 4790-4797 July 2021, and Allenspach et al., “Towards 6DoF Bilateral Teleoperation of an Omnidirectional Aerial Vehicle for Aerial Physical Interaction,” 2022 International Conference on Robotics and Automation (ICRA), Philadelphia, PA, USA, pp. 9302-9308, 2022. Each of the aforementioned references is incorporated by reference herein in its entirety.

### 2.1.1 An Example Frame

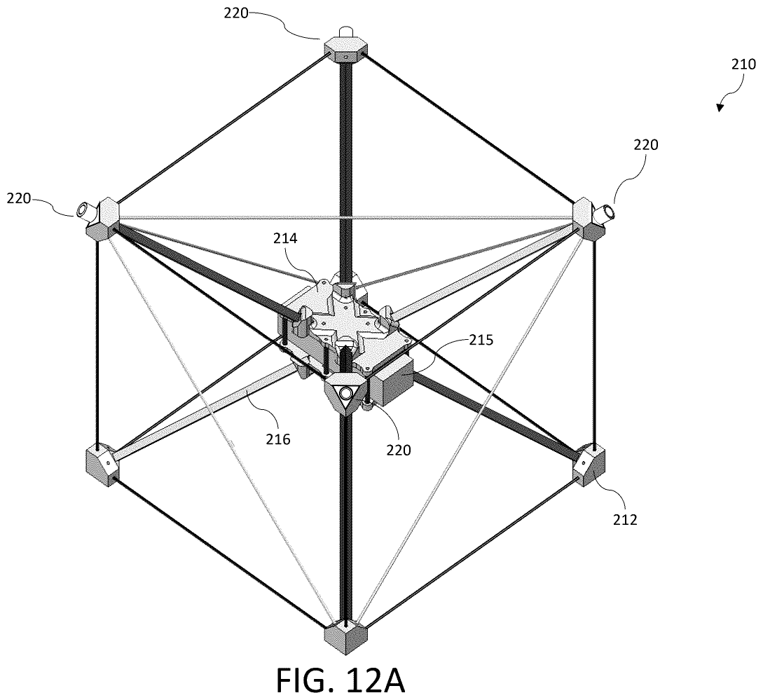

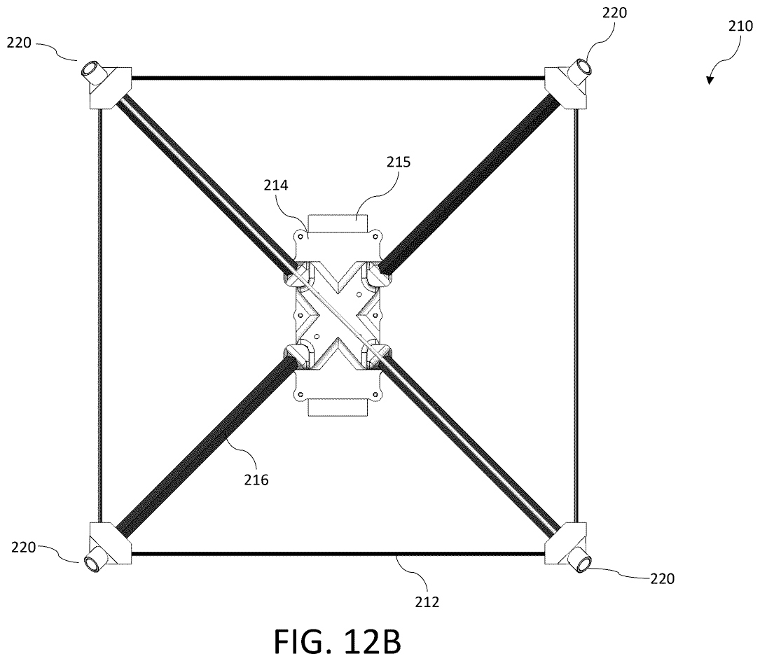

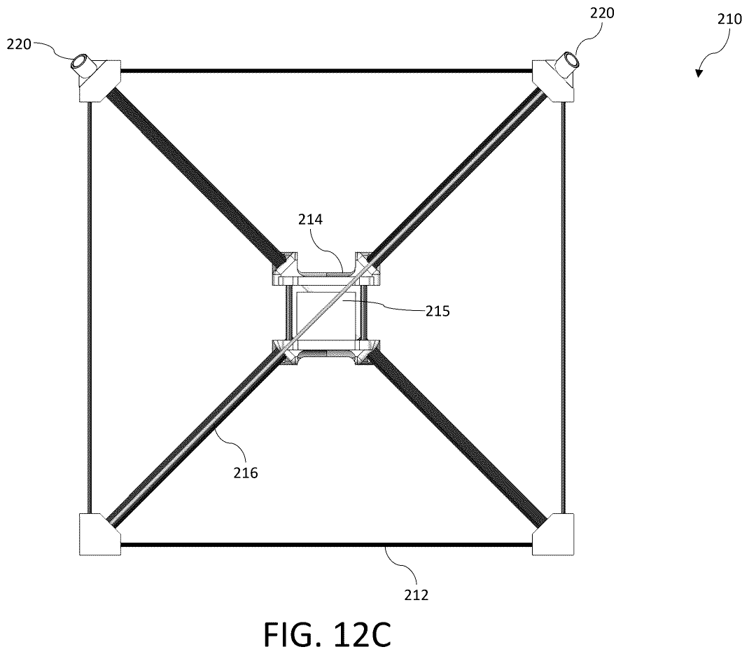

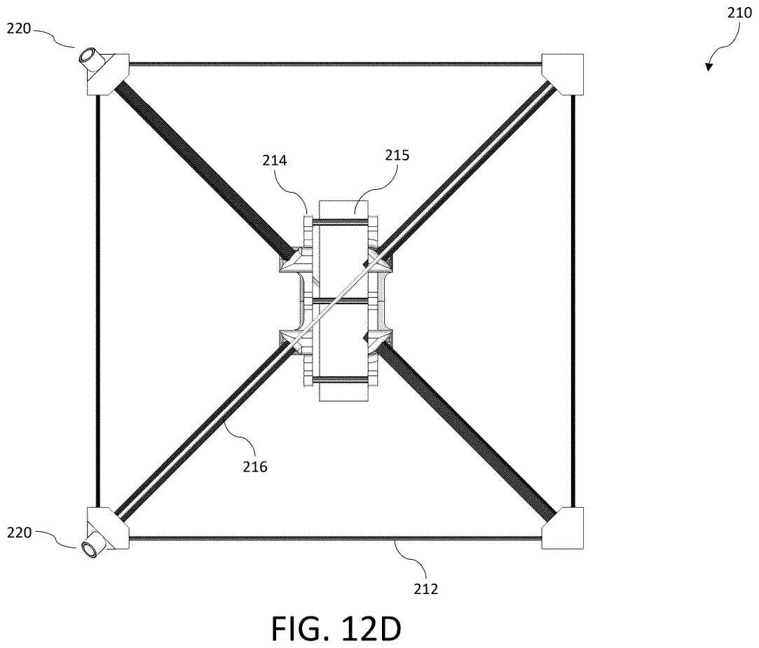

FIGS. 12A-12D show additional views of the frame 210 in the aerobots 200a and 200b. As described above, the frame 210 may include an inner frame 214 and an outer frame 212 coupled to the inner frame 214 via one or more struts 216. The inner frame 214 may include one or more inner frame members coupled together via one or more fasteners, snap-fit connections, corner joints, and/or the like. The inner frame 214 may also include a housing 215. The inner frame 214 may support the umbilical port 248, one or more sensors 249, the communication subsystem 247, and/or the onboard control computer 240.

The struts 216 may be directly coupled to at least one inner frame member using, for example, one or more screw fasteners, welding, an adhesive, and/or the like. Each strut 216 may also mechanically support at least one thruster 230. For example, the thruster 230 may be mounted to the strut 216 via a clamp (e.g., a railing clamp). In some implementations, the strut 216 may have a substantially uniform cross section along its length, which allows the thruster 230, via the clamp, to be positioned at any desired location along the length of the strut 216.

The outer frame 212 may include one or more outer frame members coupled together via one or more fasteners, snap-fit connections, corner joints, and/or the like. In some implementations, the outer frame 212 may be shaped and/or dimensioned to increase the mechanical rigidity of the frame 210 and/or to provide a physical barrier to protect the components mounted to the inner frame 214 and/or the strut(s) 216 (e.g., against collisions with the environment). In some implementations, the outer frame 212 may mechanically support one or more end effectors 260. This may be accomplished, for example, by the outer frame 212 having one or more end effector connectors 220 that can each connect to a different end effector 260.

In some implementations, the frame 210 may provide the necessary fluidic connections to facilitate A) a flow of cleaning fluid 332 from the umbilical port 245 to an end effector connector 220 coupled to an applicator end effector (e.g., the applicator end effector 260a) and B) a flow of waste fluid 341 from a squeegee end effector (e.g., the squeegee end effector 260d) coupled to an end effector connector 220 to the umbilical port 245. For example, the struts 216 may also function as a fluid conduit by carrying waste fluid 341 and/or cleaning fluid 332 internally within a cavity of the strut 216. In another example, a hose may connect to one fluidic connector on the inner frame 214 to another fluidic connector disposed at the corner of the outer frame 212 where the end effector connector 220 is located.

The various components of the frame 210 may be formed of lightweight, high strength materials including, but not limited to, carbon fiber composites, and plastic.

It should be appreciated that the tesseract frame is one non-limiting example and that other frames with different geometries are also contemplated herein. For example, the outer frame 212 may be spherical in shape instead of cubic. In another example, the frame 210 may not include an outer frame, e.g., the frame 210 may only include struts 216 protruding outward away from a housing 215 (see, for example, the aerobot 200c in FIG. 11).

### 2.1.2 An Example Control System

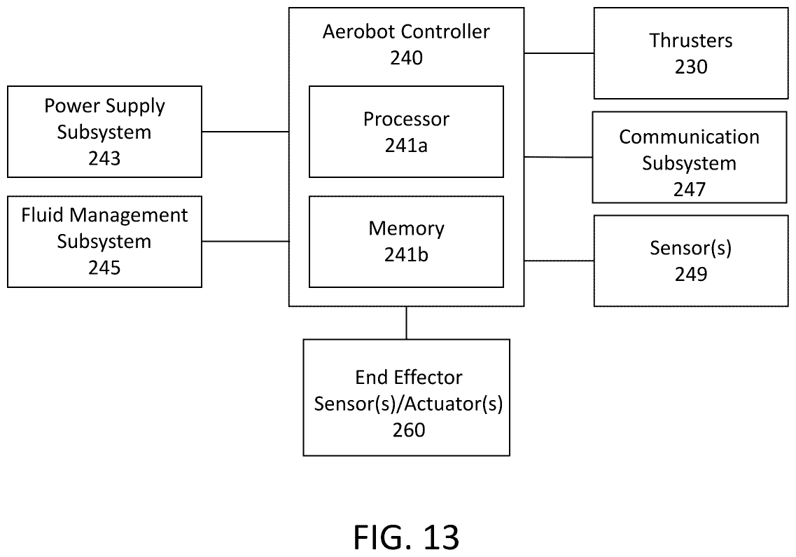

FIG. 13 shows a block diagram of the aerobot controller 240 and the various subsystems controlled by the aerobot controller 240 during operation of the aerobot. As shown the aerobot controller 240 may manage an onboard power supply subsystem 243, a fluid management subsystem 245, one or more thrusters 230, a communication subsystem 247, one or more sensors 249, and one or more end effectors 260 (e.g., triggering and receiving sensor readings, actuating one or more joints if present).

FIG. 14 shows a more detailed diagram of the fluidic management and power supply subsystems 245 and 243 in the aerobot 200a. As shown, the fluidic management subsystem 245 may include fluid conduits 233a and 233b coupled to the umbilical port 248 and respective end effector connectors 220a and 220b for an applicator end effector and a squeegee end effector, respectively. The fluid conduits 233a and 233b may respectively include valves 251a and 251b that are electrically controlled by the aerobot controller 240. During operation, the base station may provide a continuous supply of cleaning fluid 332 and continuous suction to the aerobot. Thus, the valves 251a and 251b may determine whether the cleaning fluid 332 is dispensed by the applicator end effector via the end effector connector 220a or if waste fluid 341 is suctioned from the squeegee end effector via the end effector connector 220b. Said another way, the valves 251a and 251b may operate as a binary switch where the aerobot controller 240 either opens the valve to allow fluid flow or closes the valve to block fluid flow.

FIG. 15 shows a more detailed diagram of the fluidic management and power supply subsystems 245 and 243 in the aerobot 200b. As described above, the aerobot 200b does not include an umbilical port, but rather a separate cleaning fluid port 254a to refill the onboard cleaning fluid tank 252, a waste fluid port 254b to empty the onboard waste fluid tank 250, and a power port 254c to recharge the energy storage module 253 of the aerobot 200b. The fluid conduit 233a for the cleaning fluid 332 may thus include the cleaning fluid tank 252, a valve 251a, and a pump 255a. The valve 251a may be opened to allow the pump 255a to flow cleaning fluid 332 from the cleaning fluid tank 252 to an applicator end effector (via the end effector connector 220a) and closed when the applicator end effector is not used or if the cleaning fluid tank 252 is being refilled with cleaning fluid 332. The fluid conduit 233b for the waste fluid 341 may include the waste fluid tank 250, a valve 251b, and a pump 255b. The valve 251b may be opened to allow the pump 255b to flow waste fluid 341 from the squeegee end effector (via the end effector connector 220b) to the waste fluid tank 250 and closed when the squeegee end effector is not used or if the waste fluid tank 250 is being emptied of waste fluid 341.

### 2.1.3 Example End Effectors

The aerobots disclosed herein may generally support one or more end effectors 260 to perform one or more operations associated with cleaning a window. The end effectors 260 may be modular components that may be readily swapped out and/or replaced with other end effectors 260 depending on the operations to be performed at a particular work site. In other words, the operator may customize the aerobot according to the demands of an operation.

The end effectors 260 disclosed herein may be passive or active. A passive end effector relies on the thrusters of the aerobot 200 to position and/or orient the end effector. An active end effector may include one or more motors and one or more joints actuated by the motor(s) to adjust the position and/or attitude of the end effector relative to the aerobot 200. In some implementations, an active end effector may be preferable in situations where controlling the position and/or orientation of the end effector with greater precision is desired. For example, the edges of a window may require greater precision to apply cleaning fluid or remove waste fluid.

FIGS. 16A-16C show an example of a passive applicator end effector 260a with a sponge fluid applicator 270a. As shown, the end effector 260a may include a support tube 262 to provide mechanical support to a manifold 264 and the fluid applicator 270a. The support tube 262 may further include an end effector connector 261 to facilitate mechanical, fluidic, and electrical coupling to the aerobot 200, e.g., via a corresponding end effector connector 220 on the aerobot 200. In some implementations, the support tube 262 may include a fluid conduit 263 to carry cleaning fluid 332 to the fluid applicator 270a. As shown in FIG. 16B, the manifold 264 may include a manifold cavity 265 and a manifold interface 266 coupled to the fluid applicator 270a with multiple openings 267a. The manifold cavity 265 may disperse the cleaning fluid 332 to different portions of the fluid applicator 270a so that cleaning fluid 332 may be uniformly applied by the fluid applicator 270a to a surface of a window.

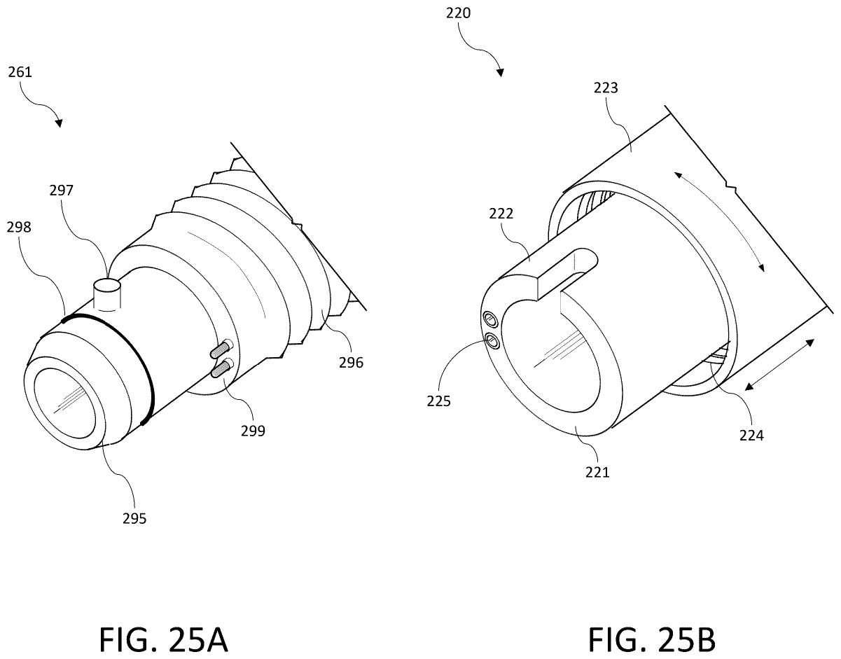

In some implementations, the end effector 260a may include one or more contact pressure sensors 268 disposed, for example, at the manifold interface 266, to measure the contact pressure applied to the surface of a window at different locations along the fluid applicator 270a. FIG. 16C shows each sensor 268 may be electrically coupled to a wire 269, which is routed through the support tube 262 to an electrical connection port in the end effector connector 261 (see, for example, the electrical pins 299 in FIG. 25A). The contact pressure sensors 268 may be various sensors capable of measuring pressure via deformation of a compliant material including, but not limited to, a strain sensor.

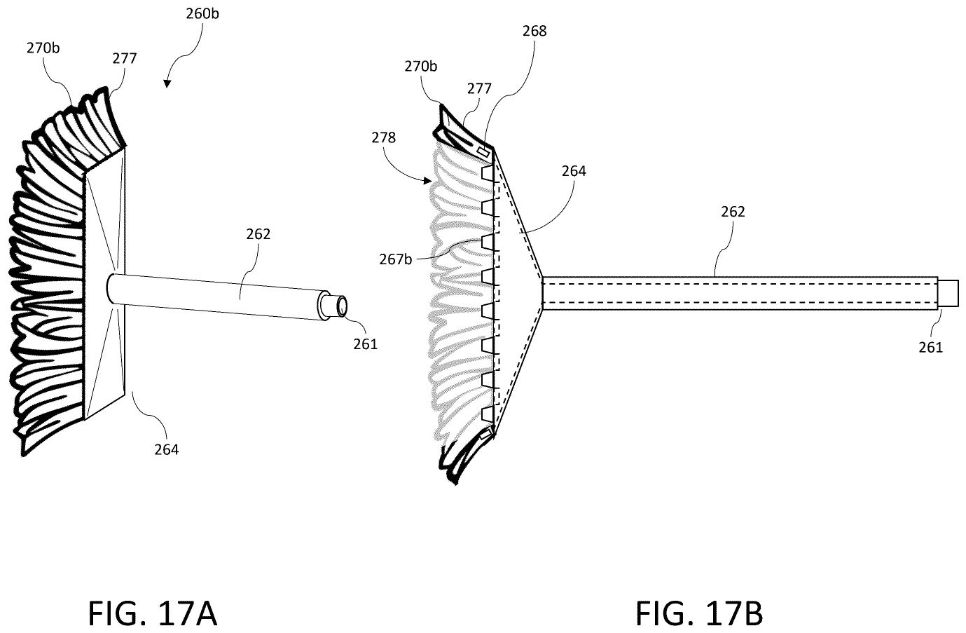

FIGS. 17A and 17B show another example of a passive applicator end effector 260b with a brush fluid applicator 270b. As shown, the fluid applicator 270b may include a plurality of bristles 277 to facilitate scrubbing of the window surface. In some implementations, the bristles 277 may be coupled to the periphery of the manifold 264, thus forming a cavity 278. The manifold 264, in this example, may include multiple nozzles 267b to directly spray cleaning fluid 332 to the surface of the window within the cavity. That way, as the end effector 260b is moved along the window surface, the cleaning fluid 332 is sprayed to the surface and thereafter scrubbed by the bristles 277 of the fluid applicator 270b. In this example, the end effector 260b may also include one or more contact pressures sensors 268 embedded into the bristles 277 or disposed at the base of the bristles 277.

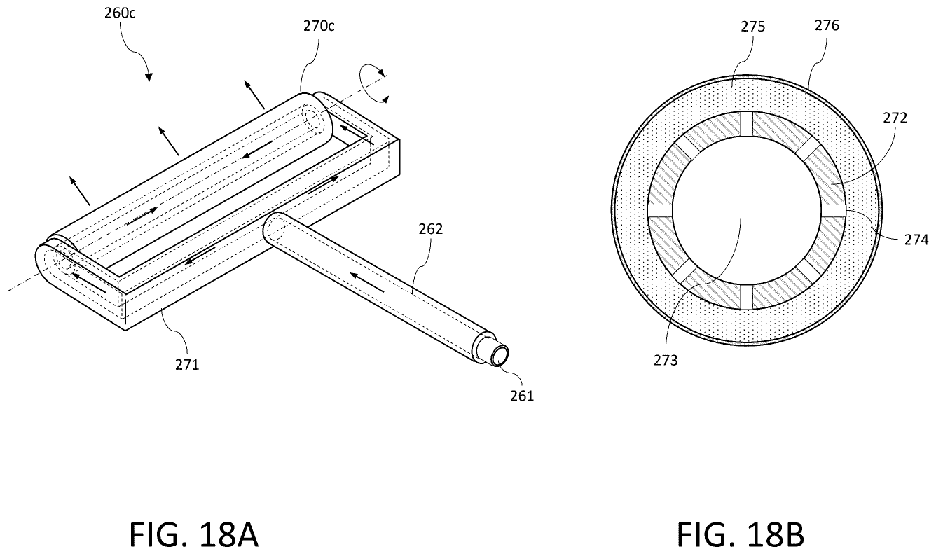

FIGS. 18A and 18B show another example of a passive applicator end effector 260c with a roller fluid applicator 270c. As shown, the end effector 260c includes a support tube 262, a support bracket 271 coupled to the support tube 262, and a roller 272 to support the roller fluid applicator 270c. The fluid applicator 270c may be rotatably coupled to the roller 272. Thus, as the end effector 260c is moved along a window surface, the fluid applicator 270c may rotate about the roller 272. The support bracket 271 and the support tube 262 may feed cleaning fluid 332 into a fluid conduit 273 of the roller 272. As shown in FIG. 18B, the roller 272 may include a plurality of openings 274 to disperse the cleaning fluid 332 radially outward to a sponge 275 in the fluid applicator 270c. In this manner, the cleaning fluid 332 may be uniformly dispersed across the surface of the fluid applicator 270c. The fluid applicator 270c may further include a porous scrubber 276 disposed on the outer surface of the sponge 275 to provide a scrub pad to remove detritus from the surface of the window. Although not shown, the roller fluid applicator 270c may also include one or more contact pressure sensors (e.g., sensor(s) 268).

FIGS. 19A-19C show an example of a passive squeegee end effector 260d with a relatively wide squeegee blade 290a and vacuum suction. The end effector 260d may include a support tube 282 coupled to a manifold 284, which, in turn, supports the squeegee blade 290a. Similar to above, the support tube 282 may include an end effector connector 281 to facilitate mechanical, fluidic, and electrical coupling to the aerobot 200, e.g., via a corresponding end effector connector 220 on the aerobot 200. For the squeegee end effector 260d, the support tube 282 may provide a fluid conduit 283 and the manifold 284 may provide a manifold cavity 285 to facilitate suction of waste fluid 341 collected by the squeegee blade 290a. Specifically, FIG. 19C shows the end of the manifold 284 may include an opening 292 proximate to the squeegee blade 290a. As the squeegee blade 290a removes waste fluid 341, the waste fluid 341 may be suctioned through the opening 292 and into the manifold cavity 285. FIG. 19B shows the manifold interface 286 of the manifold 284 may include multiple openings 287 disposed along the width of the squeegee blade 290a.

In some implementations, the squeegee blade 290a may include one or more contact pressure sensors 288. The sensors 288 may be embedded into the blade 290a or disposed on its surface. Thus, as the blade 290a deforms and bends, e.g., when in physical contact with the window surface, the contact pressure sensor 288 may measure this bending, which may be used to determine a corresponding contact pressure. The sensors 288 may be electrically coupled to a wire 289 in the manifold 284, which is routed to the electrical contacts of the end effector connector 281. In some implementations, the squeegee blade 290a may be a disposable component that is replaced after a period of use. Thus, the squeegee blade 290a may be removable from the manifold 284. To facilitate an electrical connection with the contact pressure sensors 288, the squeegee blade 290a may include electrical contacts (not shown) embedded at its base that are electrically connected to the sensors 288. The electrical contacts may physically contact corresponding electrical contacts (not shown) on the manifold 284 to maintain a persistent electrical connection when the squeegee blade 290a is installed.

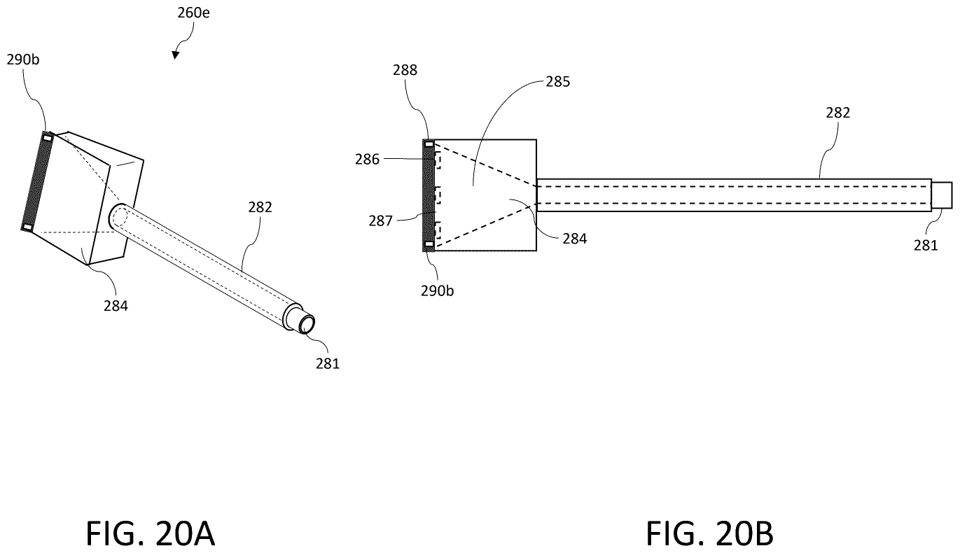

FIGS. 20A and 20B show another example of a passive squeegee end effector 260e with a relatively narrow squeegee blade 290b. This end effector 260e may operate in a similar manner as the squeegee end effector 260d of FIGS. 19A-19C. The narrower squeegee blade 260e may be used for operations that require more precise removal of waste fluid 341 from a window, such as around the edges of the window.

FIGS. 21A and 21B show an example of a combined applicator and squeegee end effector 260f to facilitate application of cleaning fluid 332, scrubbing of a window surface, and removal of waste fluid 341 in one operation. As shown, the end effector 260f may include a manifold 284 coupled to two support tubes 262 and 282. The support tube 262 may be mechanically coupled to the aerobot 200 via the end effector connector 261 and a corresponding end effector connector 220 on the aerobot 200. The support tube 282, however, may be coupled to the aerobot 200 by connecting a hose to the end effector connector 281 and another end effector connector 220 on the aerobot 200. For example, the hose may be compliant and include corresponding end effector connectors at each end to facilitate connection to the end effector connectors 281 and 220. The manifold 284 may include a first manifold cavity 285 to facilitate suction of waste fluid 341 collected by a squeegee blade 290c and a second manifold cavity 265 to deliver cleaning fluid 332 to a roller fluid applicator 270c. It should be appreciated that, in other implementations, this end effector 260f may include a sponge fluid applicator (see FIGS. 16A-16C) or a brush fluid applicator (see FIGS. 17A and 17B). The respective sensors 288 in the squeegee blade 290c and the roller fluid applicator 270c may be electrically coupled to the electrical port of one end effector connector (e.g., the end effector connector 261 on the first support tube 262).

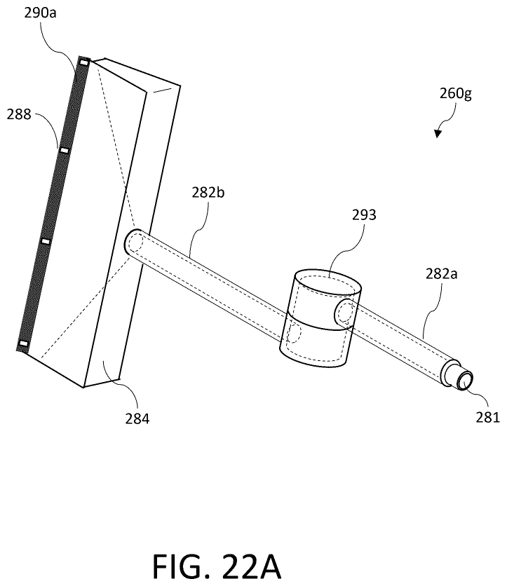

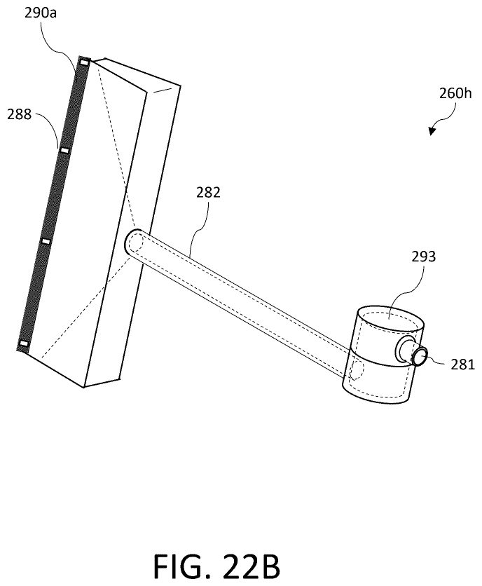

FIG. 22A shows an example of an active squeegee end effector 260g with one motorized rotary joint 293 to control one rotational degree of freedom. As shown, the rotary joint 293 may be coupled to two support tubes 282a and 282b where the support tube 282a is connected to the aerobot 200 via an end effector connector 281 and the support tube 282b is connected to the manifold 284. The end effector 260g shown may suction waste fluid 341 through the support tubes 282a and 282b and an interior cavity of the rotary joint 293. It should be appreciated that, in some implementations, the support tube 282a with the end effector connector 281 may include a separate fluid connector that couples to a corresponding fluid connector on the manifold 284 via a hose. That way, the support tubes 282a and 282b may provide mechanical support and/or an electrical conduit to any sensors in the squeegee blade 290a. FIG. 22B shows another example of an active squeegee end effector 260h where the motorized rotary joint 293 is disposed at the base of the end effector 260h so that any weight associated with the rotary joint 293 is located closer to the aerobot 200. In this example, the rotary joint 293 may include an end effector connector 281 and the end effector 260h may include a single support tube 282.

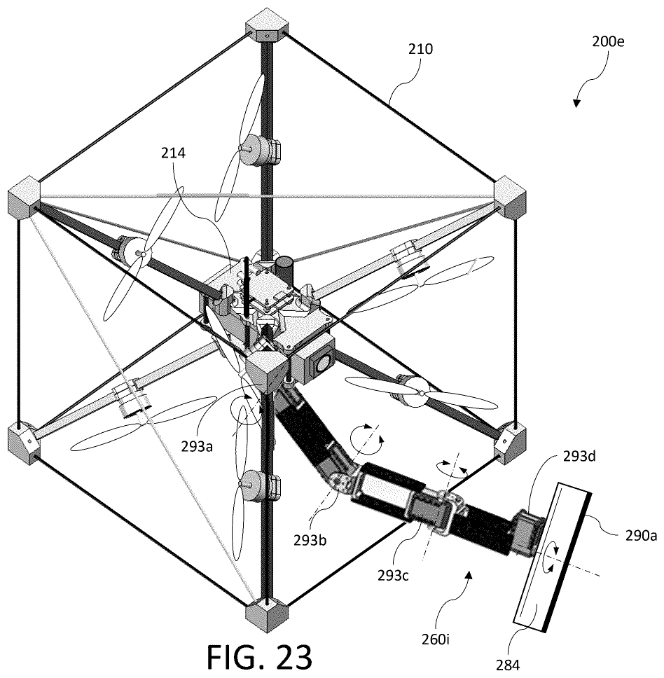

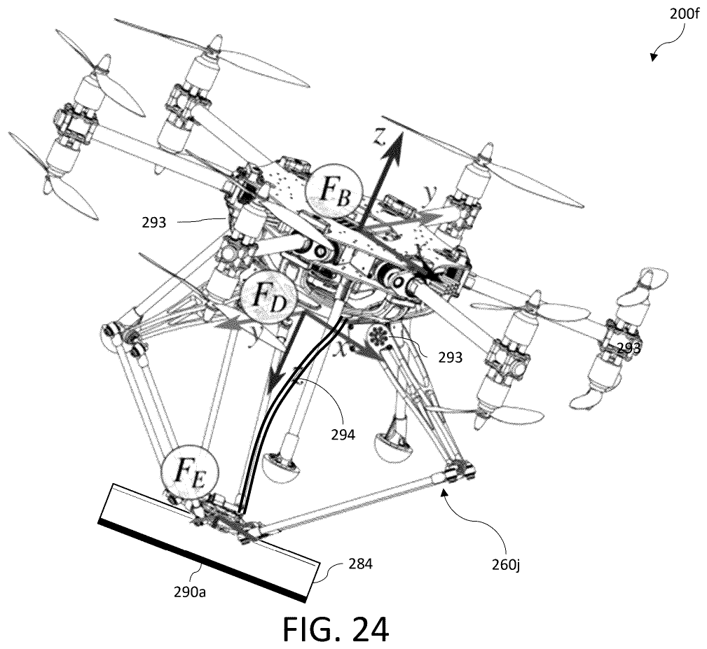

FIG. 23 shows an example aerobot 200e that includes an active squeegee end effector 260i with multiple motorized rotary joints arranged in a serial configuration. As shown, the end effector 260i may include four rotary joints 293a, 293b, 239c, and 239d to change the position and orientation of a manifold 284 with a squeegee blade 290a. In this example, the end effector 260i may be coupled to the inner frame 214 of the aerobot 200e rather than the corners of the outer frame 212. The aerobot 200e may be similar to the aerobots 200a-200c. FIG. 24 shows another example aerobot 200f that includes an active squeegee end effector 260j with multiple motorized rotary joints arranged in a parallel configuration. In particular, the end effector 260j may include multiple rotary joints 293 disposed at the base of the aerobot 200 that are each coupled to a manifold 284 with a squeegee blade 290a. This arrangement may allow for more precise control of the squeegee blade 290a by reducing or, in some instances, mitigating the accumulation of errors from multiple rotary joints arranged in a serial configuration. As shown, the manifold 284 may be fluidically coupled to the aerobot 200e via a hose 294 so that waste fluid 341 may be transported to the aerobot 200e.

Additional examples and details of active end effectors with one or more motorized joints may be found in Bodie et al., “An Omnidirectional Aerial Manipulation Platform for Contact-Based Inspection,” Proceedings of Robotics: Science and Systems, 2019, Bodie et al., “Dynamic End Effector Tracking With an Omnidirectional Parallel Aerial Manipulator,” in IEEE Robotics and Automation Letters, vol. 6, no. 4, pp. 8165-8172 October 2021, Breyer et al., “Volumetric Grasping Network: Real-time 6 DOF Grasp Detection in Clutter,” Proceedings of the 2020 Conference on Robot Learning, PMLR 155:1602-1611, 2021, and Ma et al., “A novel aerial manipulator system compensation control based on ADRC and backstepping.” Scientific Reports, 11, 22324, 2021. Each of the aforementioned references is incorporated by reference herein in its entirety.

FIGS. 25A and 25B show example end effector connectors 261 and 220 for an end effector 260 and the aerobot 200, respectively. As shown, a mechanical connection (e.g., a threaded fastener connection), a fluidic connection (e.g., tubing for waste fluid or cleaning fluid), and an electrical connection (e.g., electrical pins/sockets) are provided. FIG. 25A shows the end effector connector 261 may include tubing 295 to carry cleaning fluid 332 or waste fluid 341, threads 296 and a guide pin 297 to facilitate mechanical engagement with the end effector 220. The end effector connector 261 may further include an O-ring 298 to provide a fluidic seal. The end effector connector 261 may also include one or more spring-loaded electrical pins 299 to electrically couple the end effector to the aerobot 200. The end effector connector 220 includes tubing 221 to carry cleaning fluid 332 or waste fluid 341, a guide slot 222 to receive the guide pin 297, a captive sleeve 223 with threads 224 to mechanically engage the threads 296 and secure the end effector connector 220 to the end effector connector 261. The end effector connector 220 may further include one or more electrical sockets 225 to receive the electrical pins 299.

### 2.1.4 Example Components of the Aerobot

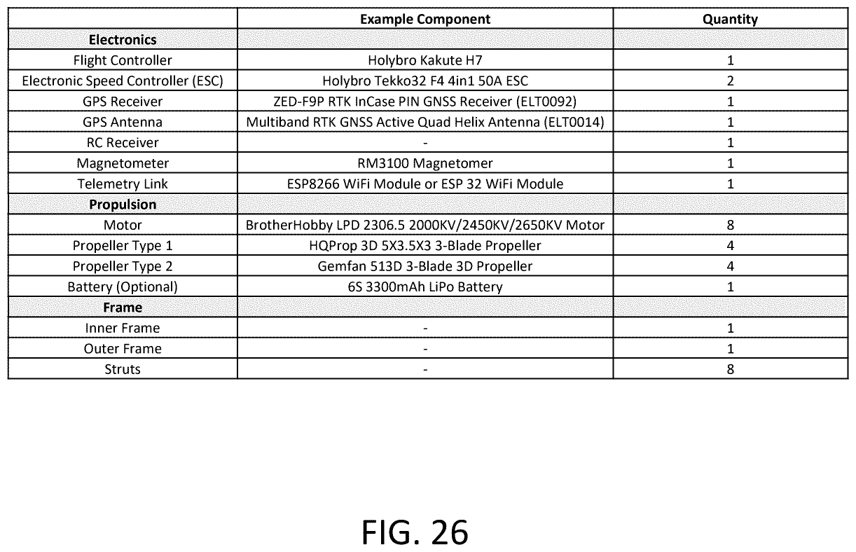

In some implementations, the aerobot 200a may include several off-the-shelf components. For example, the thrusters 230, the sensors 249, the communication subsystem 247, and/or any other onboard electrical components may be an off-the-shelf component. FIG. 26 shows a table with a list of example off-the-shelf components that may be used in the aerobot 200a.

### 2.2 Example Base Stations

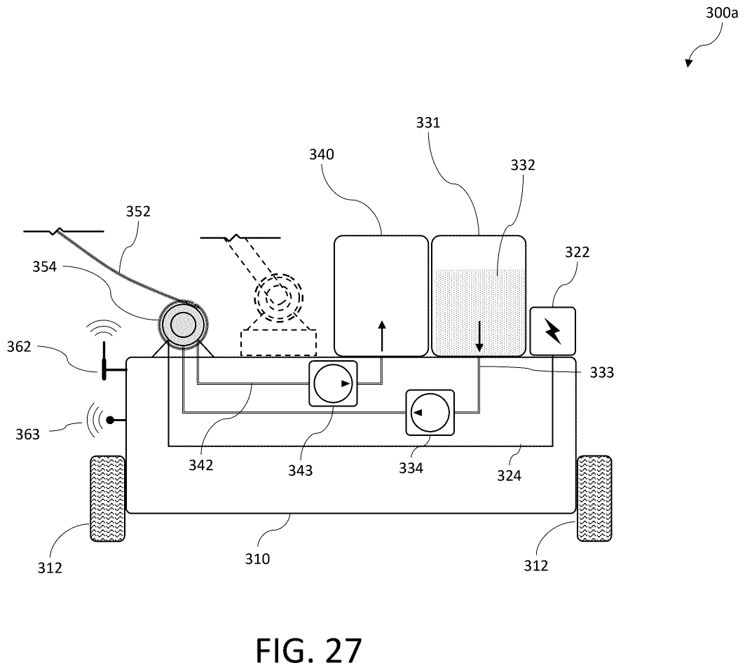

FIG. 27 shows a magnified view of the base station 300a.

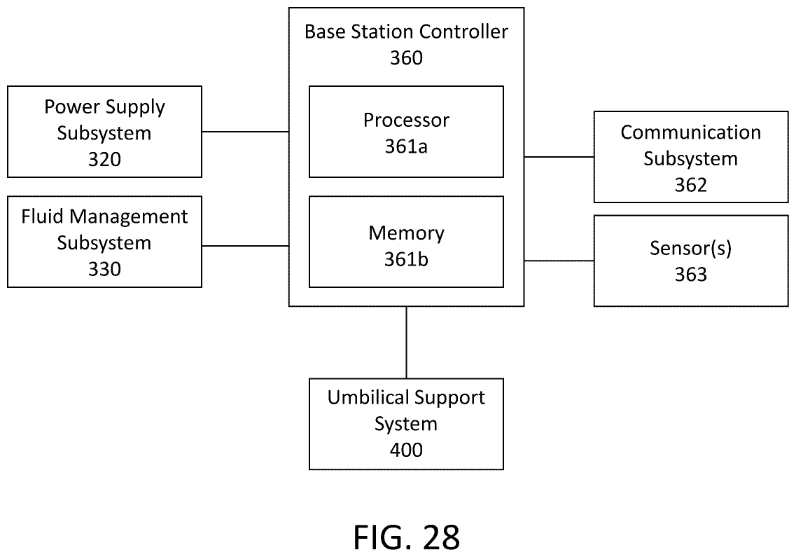

FIG. 28 shows a block diagram of a base station controller 360 to facilitate operation of the base stations 300 disclosed herein. For example, the base station controller 360 may be communicatively coupled to a communication subsystem 362, one or more sensors 363, a power supply subsystem 320 (e.g., to manage the electrical power supplied to an aerobot 200), and a fluid management subsystem 330 (e.g., to manage the pumps that transfer cleaning fluid to the aerobot 200 or waste fluid from the aerobot 200). Optionally, the base station controller 360 may also be communicatively coupled to an umbilical support system 400 if, for example, the umbilical support system 400 is directly mounted to the base station 300 and the base station controller 360 is responsible for facilitating operation of the umbilical support system 400.

### 2.3 Example Umbilical Support Systems

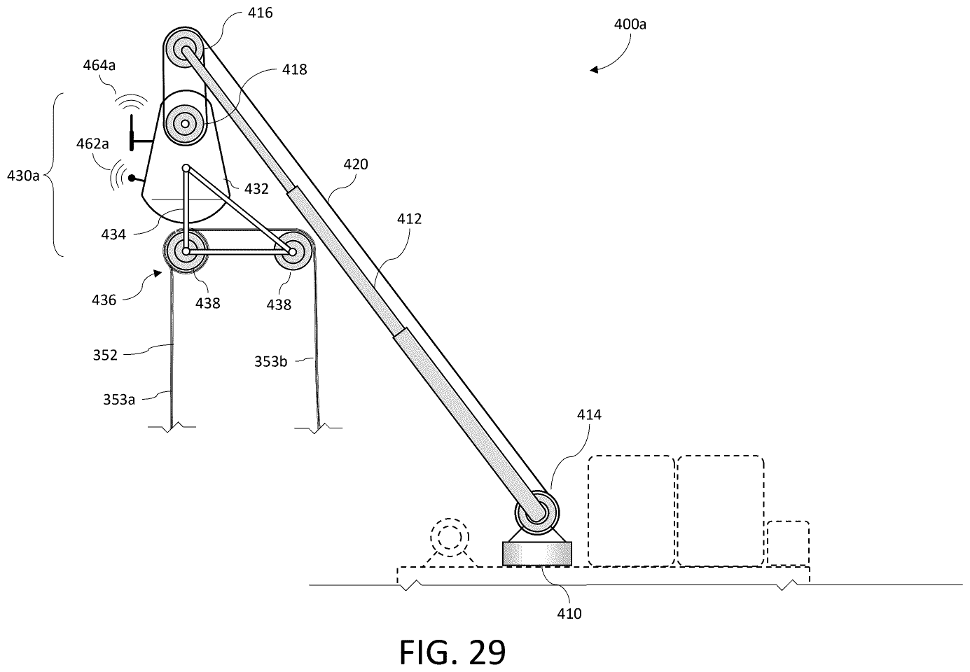

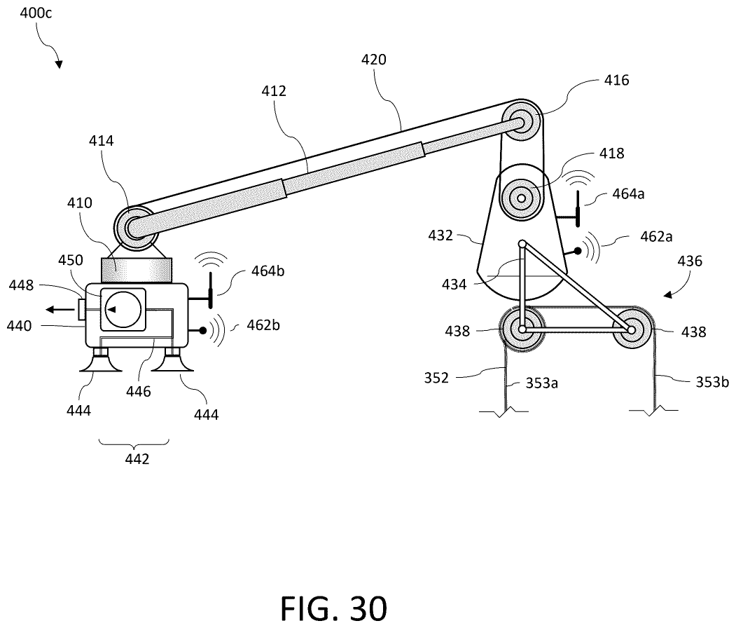

FIG. 29 shows a magnified view of the umbilical support system 400a.

FIG. 30 shows a magnified view of the umbilical support system 400c.

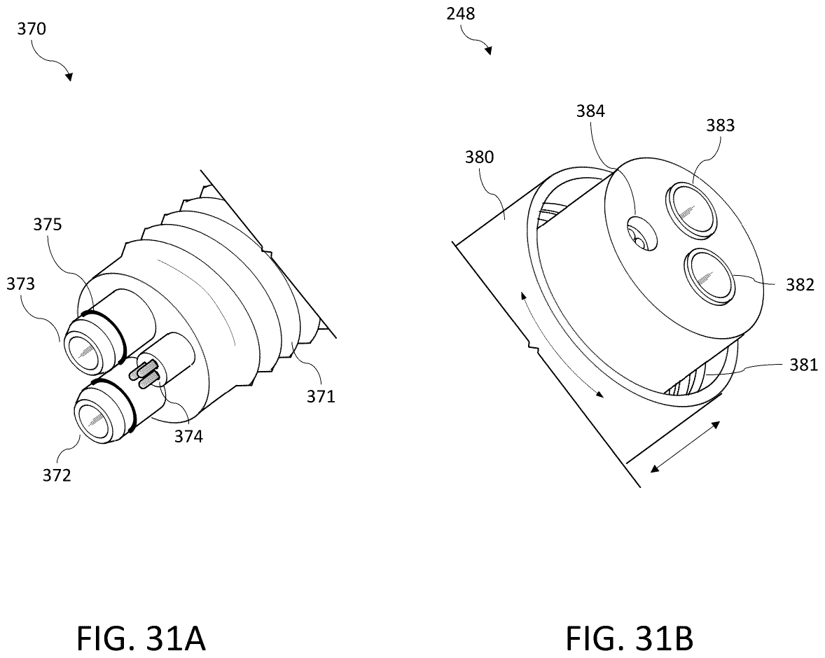

FIGS. 31A and 31B show example umbilical cord connectors 370 and 248 for the umbilical cord 352 and the aerobot 200/base station 300, respectively. As shown, a mechanical connection (e.g., a threaded fastener connection), a fluidic connection (e.g., tubing for waste fluid and cleaning fluid), and an electrical connection (e.g., electrical pins/sockets) are provided.

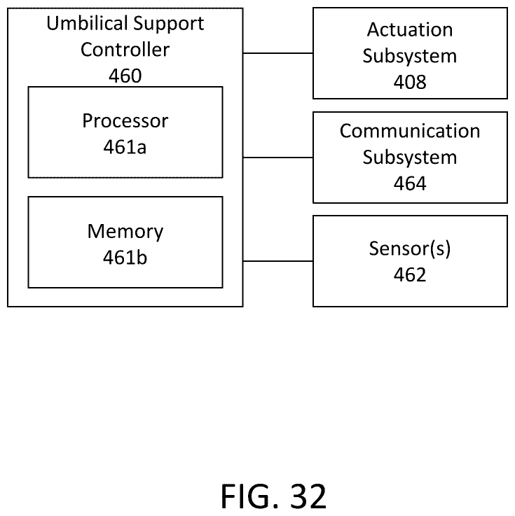

FIG. 32 shows a block diagram of an umbilical support controller 460 to facilitate operation of the umbilical support systems 400 disclosed herein. As shown, the umbilical support controller 460 may be communicatively coupled to a communication subsystem 464, one or more sensors 462, and an actuation subsystem 408 (e.g., the various controllable degrees of freedom of the umbilical support system 400 to position a support assembly relative to an aerobot 200).

### 2.4 Example Central Control Computer

As described above, the central control computer 110 may facilitate the execution of one or more operations by the window cleaning systems 100a-100h. This may be accomplished, in part, via a software application 111 on the central control computer 110. The software application 111 provides a user interface to display information on the window cleaning system (e.g., operating status, sensor readings, error notifications) to an operator and facilitates receipt of instructions from the operator. Generally, the central control computer 110 may be communicatively coupled to one or more window cleaning systems. For example, multiple window cleaning systems 100a may be deployed at a particular work site to clean several windows in parallel. Each of the window cleaning systems 100a may be managed by one central control computer 110. The central control computer 110 may also assist the operator in performing other functions, such as mapping a worksite to obtain data on the set of windows to be cleaned, or generating a quote for customers regarding the cost of cleaning the set of windows.

The central control computer 110 may be any computing device including, but not limited to, a desktop computer, a laptop, a tablet, and a phone. The central control computer may be communicatively coupled directly to at least one of the aerobot 200a (e.g., the aerobot controller 240 via a communication subsystem 247 on the aerobot 200a), the base station 300a (e.g., the base station controller 360 via a communication subsystem 362 on the base station 300a), or the umbilical support system 400a (e.g., the umbilical support controller 460 via a communication subsystem 464 on the umbilical support system 400a). Communication between the central control computer 110 and the respective communication subsystems of the aerobot 200a, the base station 300a, and/or the umbilical support system 400a may be accomplished via a wired connection (e.g., an Ethernet cable, a Universal Serial Bus (USB) cable, and/or the like) and/or a wireless communication (e.g., LoRaWAN, WiSun, Zigbee, Bluetooth, 3G, 4G, 5G, and/or the like). In some implementations, the central control computer 110 may maintain a persistent connection with the window cleaning system 100a.

In some implementations, the central control computer 110 may be communicatively coupled to one or more servers (e.g., cloud servers), which may provide several functions including, but not limited to, remote backup storage of data related to the work plan, and data analysis (e.g., analyzing image maps of the work site to facilitate generation of a work plan or trajectories for the aerobot 200a to follow when cleaning different windows of a structure).

### 2.5 Example Computer Components

The aerobot controller 240, the base station controller 360, the umbilical support controller 460, and the central control computer 110 may each include one or more processors and memory. For example, the aerobot controller 240 may include a processor 241a and memory 241b. The base station controller 360 may include a processor 361a and memory 361b. The umbilical support controller 460 may include a processor 461a and memory 461b. The processors may be any suitable processing device configured to run and/or execute a set of instructions or code. Each processor may be, for example, a general-purpose processor, a Field Programmable Gate Array (FPGA), an Application Specific Integrated Circuit (ASIC), a Digital Signal Processor (DSP), and/or the like. The memory may encompass, for example, a random-access memory (RAM), a memory buffer, a hard drive, a database, an erasable programmable read-only memory (EPROM), an electrically erasable read-only memory (EEPROM), a read-only memory (ROM), Flash memory, and/or so forth. The memory may store instructions to cause the one or more processors, respectively, to execute processes and/or functions associated with the execution of a work plan and/or a particular operation at a particular work site.

### 3. EXAMPLE OPERATIONS AND METHODS

In some implementations, the operation of the window cleaning systems 100a-100h disclosed in Section 1 may be preceded by one or more processes to facilitate generation of a work plan by the central control computer 110 to clean a set of windows on a structure.

For example, a sales agent may visit a new customer work site to evaluate the work site and schedule a session for cleaning. During the visit, the sales agent may collect data on the work site. For example, the data may include a digital map of the interior and exterior surfaces of the windows. The digital map may include, for example, the coordinate locations of the windows relative to a global ground reference to facilitate navigation to each window, the shape of each window, the dimensions of each window, and the orientation of each window (e.g., vertical, inclined, horizontal). The data on the interior surfaces of the windows may be acquired via a 360-degree camera on a mast. The camera may be carried by the sales agent as they walk around the work site. The data on the exterior surfaces of the windows may be acquired by an aerobot 200 with an imaging system (e.g., a camera, a laser scanner (LiDAR), and/or the like).

During this visit, the customer may select a set of windows for cleaning, which may generally include at least one or, in some instances, all the windows of the structure. The customer may further choose to clean the interior surfaces of the windows, the exterior surfaces of the windows, or both. It should be appreciated that the set of windows selected for interior cleaning and exterior cleaning may be different. It should also be appreciated that the data collected may be stored and later retrieved, for example, when revisiting the work site for another cleaning service.

The cleaning of the interior surfaces and exterior surfaces of the set of windows may thereafter be scheduled separately and/or performed separately using different window cleaning systems 100 (e.g., the outer window cleaning systems 100a-100g, the indoor window cleaning system 100h). In some implementations, the cleaning service may be performed by a single human operator and one or more cleaning systems 100 (each with at least one aerobot 200) controlled by a single central control computer 110. For example, a human operator may manage five window cleaning systems 100 at a particular work site.

For an outdoor cleaning service, a work plan may be generated beforehand that specifies different sets of windows to be cleaned by different window cleaning systems 100 according to a planned schedule. The workplan may divide the windows amongst different window cleaning systems 100 based, in part, on the geometry of the building and/or the range of each aerobot 200, which may be limited by the total length of umbilical cord 352 available.

Based on the work plan, the operator may set up the base station 300 and/or the umbilical support system 400 for each window cleaning system 100 such that the aerobots 200 associated with that particular window cleaning system 100 have access to the assigned set of windows of the structure. Once the base station 300 is deployed, the operator may connect the umbilical cord 352 at one end to an umbilical port (e.g., the umbilical port 248) on the base station 300. Thereafter, the operator may attach the umbilical cord 351 to the umbilical support system 400 (e.g., the umbilical pulley assembly 436a, the clamp assembly 437). In doing so, the operator may set the umbilical cord 352 such that the first portion 353a of the umbilical cord 352 that is to be disposed between the aerobot 200 and the umbilical support system 400 has a length that falls within the ranges described above in Section 1. The other end of the umbilical cord 352 may be attached to a temporary anchor (e.g., on the ground) to prevent movement of the free end of the umbilical cord 352.

The umbilical support system 400 may then be activated. For example, an umbilical support system 400 with a boom arm 412 may raise the boom arm 412 upwards such that the support assembly 430 coupled to the boom arm 412 is suspended above the aerobot 200, which is still grounded. In another example, an umbilical support system 400 with a support AAV 470 may activate the support AAV 470 to fly above and hover over the grounded aerobot 200. In yet another example, an umbilical support system 400 with an aerostat 474 may inflate the balloon 476 of the aerostat 474 and deploy the aerostat 474 to hover over the grounded aerobot 200.

Lastly, the operator may equip the aerobot 200 with the desired end effectors 260 to clean the windows. The operator may then remove the umbilical cord 352 from the temporary anchor and attach the free end of the umbilical cord 352 to the umbilical port 248 of the aerobot 200. Once connected, the base station 300 may begin providing electrical power and cleaning fluid 332 to the aerobot 200 and/or suction to the aerobot 200 (for later removal of waste fluid 341). The aerobot 200 may initially close the onboard valves to prevent cleaning fluid 332 from being dispensed by an applicator end effector and/or suction from a squeegee end effector.

The aerobot 200 may then be launched by the operator. The aerobot controller 240 onboard the aerobot 200 may then receive instructions from the central control computer 110 corresponding to the work plan to be executed by the window cleaning system 100. The aerobot 200 may thereafter begin executing the work plan (e.g., by flying to the first window in the assigned set of windows). In some implementations, the window cleaning system 100 may operate autonomously thereafter with the aerobot 200 flying to different windows in the assigned set of windows until the work plan is complete. The umbilical support system 400 may also automatically adjust and/or reposition itself such that the umbilical pulley assembly 436a. 436b or clamp assembly 437 is disposed above the aerobot 200 and located in sufficient proximity to the aerobot 200 to maintain slack in the first portion of the umbilical cord 352. The operator may not be required to interact with the window cleaning system 100 during this period unless an error, interruption, or exception occurs.

In some implementations, the work plan may be designed to reduce the distance traveled by the aerobot 200. For high-rise buildings with roof-mounted base stations, the workplan may specify the aerobot t200 o clean windows in one vertical column beginning at the top first and progressively work downwards before moving laterally and moving back upwards to clean another adjacent column of windows. For ground-based base stations, the aerobot 200 may clean windows in one vertical column beginning at the bottom first and progressively work upwards before moving laterally and moving back downwards to clean another adjacent column of windows.

For an indoor cleaning service, the operator may deploy one window cleaning system 100 per room to clean the assigned set of windows in each room. In some implementations, the number of window cleaning systems 100 deployed by an operator may depend, in part, on the time spent by the operator to move and redeploy window cleaning systems 100 to different rooms. For example, if the amount of time typically required to launch an aerobot 200 in a room is equal to one-third of the time for an aerobot 200 to clean the room, then an operator may keep at most four aerobots 200 busy at all times. Thus, an indoor cleaning service may only include 3-4 window cleaning systems 100 per operator.

For both outdoor and indoor cleaning, the aerobot 20, when cleaning a window, may use one or more onboard sensors 249 (e.g., an imaging system) to identify individual glass panes and/or surrounding frame structures. Each glass pane may then be cleaned. For example, the aerobot 200 may start at one corner of the pane and thereafter move an applicator end effector across the entire pane to apply cleaning fluid 332 and scrub the surface of the window to agitate and release detritus on the surface of the window for suspension in the cleaning fluid 332. Once the pane is covered with cleaning fluid 332, the aerobot 200 may change its orientation to use a squeegee end effector to remove the resulting waste fluid 341 from the pane. Specifically, the aerobot 200 may move along the surface of the window with a squeegee blade to collect the waste fluid 341, which is suctioned into the aerobot 200 (and, in some instances, transferred to the base station 300). Once the panes of a window have been cleaned, the aerobot 200 may proceed to the next window in the set of windows and repeat the above process.

The key requirement in this motion is to keep the full length of the squeegee blade in continuous contact with the flat glass and to overlap sweeps, all so as to leave the glass completely clean with no streaks.

### 3.1 Example Trajectories

The translational and rotational motion of the aerobots 200 disclosed herein may generally be controlled over multiple degrees of freedom (e.g., six degrees of freedom), which allows for greater maneuverability of the aerobot 200 to perform various operations (e.g., contact treatment of elevated vertical or inclined surfaces) with sufficient precision. When performing an operation, the aerobot 200 may be instructed so as to control its translational and rotational motion (e.g., through operation of one or more thrusters) such that one or more end effectors 260 coupled to the aerobot 200 follow a particular treatment trajectory across/along a surface. For example, the treatment trajectory may be defined so that an end effector 260 of the aerobot 200 applies a cleaning fluid 332 onto at least a portion of a window or removes waste fluid 341 from at least a portion of the window. It should be appreciated that, for a given surface and type of contact treatment of the surface, different trajectories may be defined for an aerobot's motion depending on the end effector 260 used and the operation being performed. The following discussion provides multiple non-limiting examples of treatment trajectories that may be formulated and then executed by the aerobots disclosed herein.

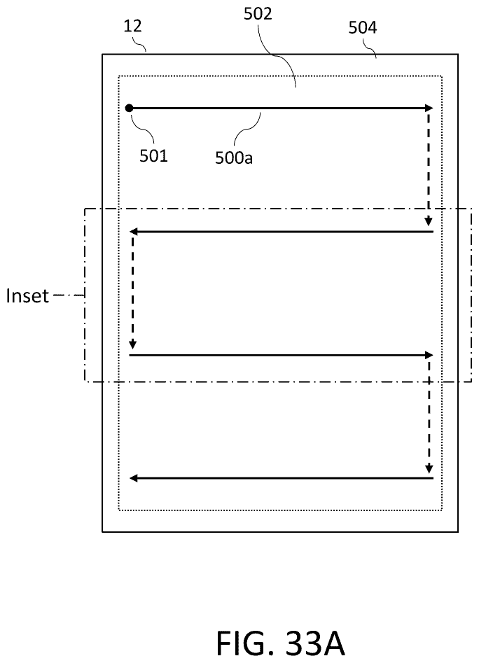

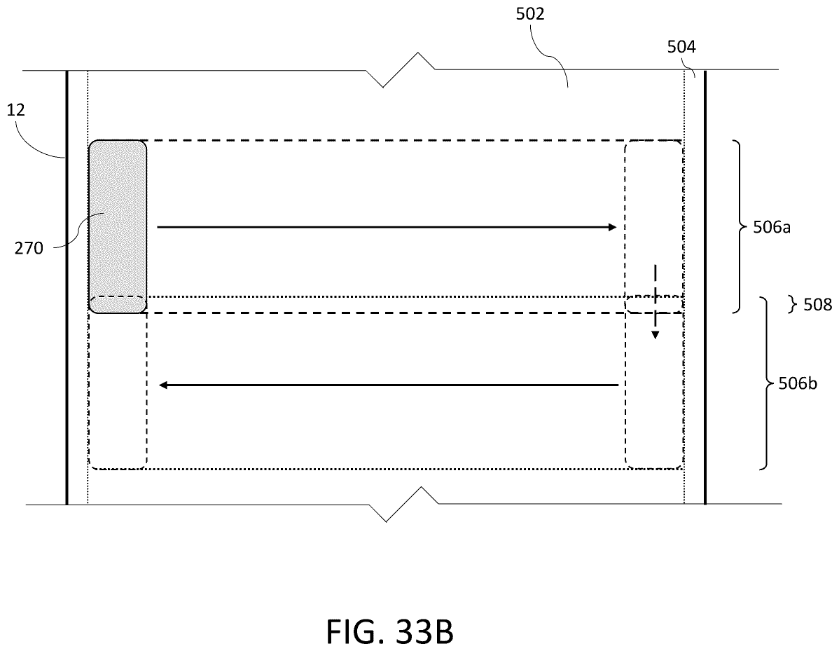

FIG. 33A shows an example trajectory 500a for an aerobot 200 to apply cleaning fluid 332 to a window 12 using an applicator end effector with a fluid applicator 270. The trajectory 500a begins at starting point 501. As shown, the trajectory 500a may be defined such that cleaning fluid 332 is applied to an operating zone 502 of the window 12 corresponding to a center portion of the window 12. The operating zone 502 may be surrounded by a buffer zone 504 corresponding to an outer portion of the window 12. In some implementations, cleaning fluid 332 is not applied to the buffer zone 504 deliberately to prevent cleaning fluid 332 from being applied to the surrounding frame of the window 12. FIG. 33B shows a magnified view of an applicator end effector 260a following a portion of the trajectory 500a of FIG. 33A. It should be appreciated that, in other example implementations, the translational and rotational motion of the aerobot 200 is controlled so as to apply cleaning fluid 332 using one or more different trajectories than that shown in FIGS. 33A and 33B; for example, the aerobot 200 may be controlled so as to first apply cleaning fluid 332 over a certain portion of the window using a first trajectory, and then scrubbing or otherwise agitating the applied cleaning fluid 332 using a second trajectory (which may at least partially overlap the first trajectory) so as to ensure sufficient suspension of particulates (e.g., releasing of detritus from the window surface) to form the waste fluid on the window. For example, FIG. 33B shows the fluid applicator 270 may follow a first sweep 506a across the window 12 followed by a second sweep 506b located directly below in the opposite direction. The first and second sweeps 506a and 506b may be arranged to provide an overlap 508 to ensure the window 12 is covered with cleaning fluid 332.

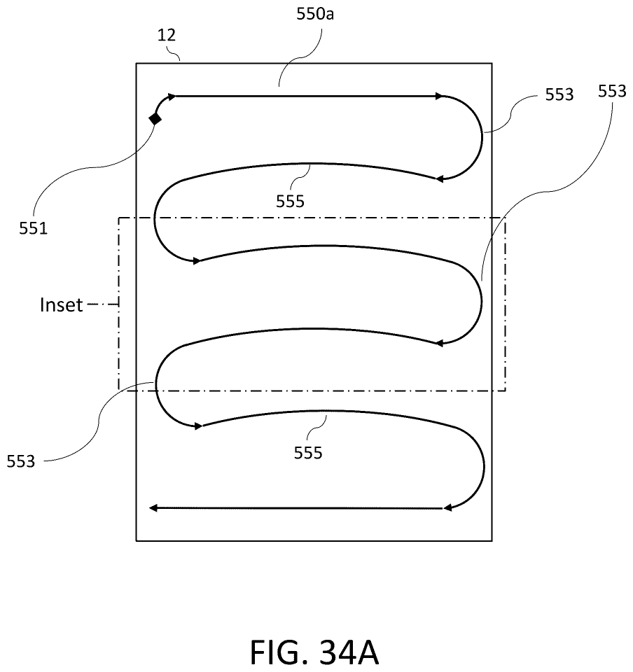

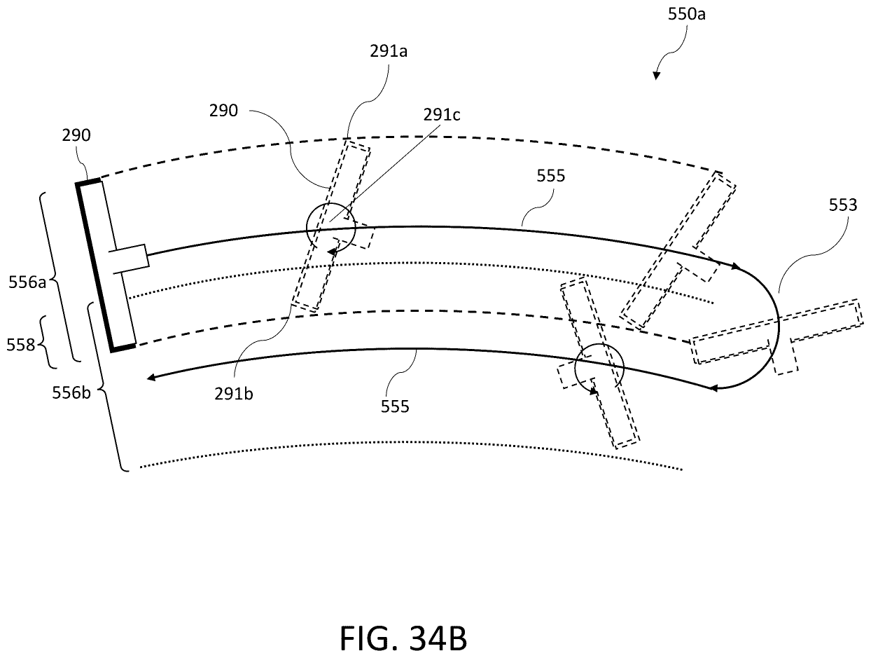

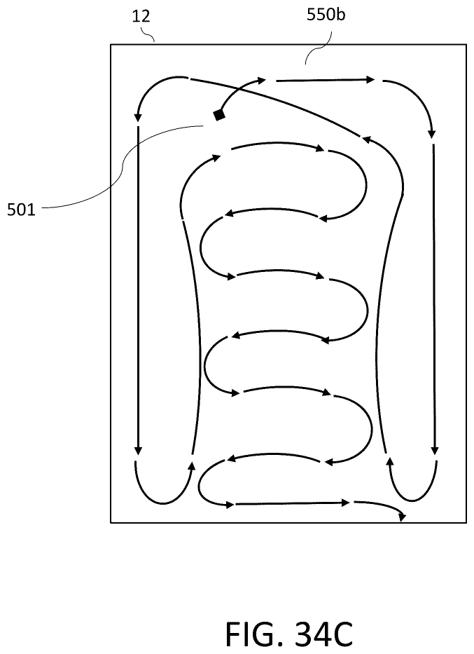

FIG. 34A shows a first example of a treatment trajectory 550a for an aerobot 200 to remove waste fluid 341 from a window 12 using a squeegee end effector with a squeegee blade 290. The treatment trajectory 550a shown in FIG. 34A is similar to that employed by human window washers, and is sometimes referred to as the “fanning technique” or the “S-technique” for window-washing using a squeegee (see e.g., www.youtube.com/watch?v=KQ5ssuTdVfQ and www.youtube.com/watch?v=0v7Xlfa3twQ). It should be appreciated that although this example treatment trajectory 550a of the “fanning technique” or the “S-technique” is advantageous for removal of waste fluid 341 using a squeegee, the example trajectory shown 550a in FIG. 34A (or similar trajectories) may be useful for other types of contact treatments of surfaces using other types of end-effectors 260.

With reference again to FIG. 34A, the fanning technique treatment trajectory 550a begins at starting point 501 and has two phases, namely, a “side-to-side” phase 555 and a “reverse-direction” phase 553. During the side-to-side phase 555, the trajectory 550a of squeegee movement is side-to-side (left-to-right and right-to-left) across the width of the window 12 (as opposed to up and down). Accordingly, the side-to-side phase 555 of the fanning technique treatment trajectory 550a has a significant horizontal component, and may be essentially linear or even somewhat curvilinear. The reverse-direction phase 553 occurs proximate to either side of the window 12, during which the trajectory 550a of squeegee movement gradually reverses direction via an arcuate or curvilinear path. As also illustrated in FIG. 34A, the fanning technique cleaning trajectory 550a generally proceeds from a top portion of the window 12 via a series of side-to-side/reverse direction phases 555 and 553, during which the squeegee blade 290 makes successive sweeps in opposite directions across the window 12 while gradually proceeding downward toward a bottom perimeter edge of the window 12.

FIG. 34B shows a magnified view (inset of FIG. 34A) of a squeegee end effector with a squeegee blade 290 proceeding along a portion of the fanning technique treatment trajectory 550a shown in FIG. 34A. FIG. 34B particularly illustrates the orientation of the squeegee blade 290 (i.e., the “contact profile” of the squeegee end effector) relative to the treatment trajectory 550a during respective phases of the trajectory 550a, and the concept of “overlapping sweeps” for proceeding along the treatment trajectory 550a. In particular, as illustrated in FIG. 34B, the squeegee blade 290 makes successive overlapping sweeps in opposite directions across the window 12 as it traverses the treatment trajectory 550a. During a given side-to-side phase 555, the squeegee blade 290 is oriented with respect to the treatment trajectory 550a at an acute angle 291c such that a top edge of the blade 291a leads a bottom edge of the blade 291b along a substantial portion of the side-to-side phase 555 (i.e., the top edge 291a of the blade is the “leading edge” and the bottom edge 291b of the blade is the “trailing edge”—the leading edge is always vertically above the trailing edge). During a reverse-direction phase 553, the squeegee blade 290 is gradually rotated such that the bottom edge 291b of the blade 290 during the previous side-to-side phase 555 (see first sweep 556a) becomes the “new” top edge 291a of the blade 290 during the next side-to-side phase 555 (see second sweep 556b), during which the “new” top edge 291a is the leading edge; additionally, this “new” top edge 291a is positioned such that the next sweep of the blade 290 during the next side-to-side 555 phase overlaps the previous sweep of the blade 290 during the previous side-to-side phase 555 (see overlap 558). In one aspect, the squeegee blade 290 optionally is in continuous contact with the window throughout the treatment trajectory 550a such that the squeegee blade 290 traverses most or all of the window 12 area without leaving the window 12. In another aspect of the treatment trajectory 550a, at no point is the squeegee 290a rotated in place; rather, any rotation of the squeegee 290 relative to the trajectory 550a occurs while the squeegee blade 290 is moving along the treatment trajectory 550a.

FIG. 34C shows a second example of a treatment trajectory 550b for an aerobot 200 to remove waste fluid 341 from a window 12 using a squeegee end effector. The treatment trajectory 550b shown in FIG. 34C is substantially similar to the fanning technique or S-technique shown in FIG. 34A and is sometimes referred to by human window washers as the “cutting down the mountain” technique (see e.g., www.youtube.com/watch?v=_PCIWGEmR1U). In essence, the trajectory 550b shown in FIG. 34C exaggerates the initial reverse-direction phases 553 of the fanning technique trajectory 550a shown in FIG. 34A so as to cover, at the beginning of the trajectory 550b, more significant portions of the window perimeter along the top and sides of the window 12. The trajectory 550b shown in FIG. 34C ultimately concludes with a series of more narrow side-to-side/reverse-direction phases 555 and 553 in a more central portion of the window 12 according to the fanning technique, again gradually proceeding downward in the central portion of the window 12 toward the bottom perimeter edge. In one aspect, the trajectory 550b shown in FIG. 34C may begin virtually anywhere on the window 12, with the proviso that it proceeds next to somewhere along the top perimeter edge of the window 12 and then proceeds thereafter in a given direction along the top perimeter toward one of the side perimeter edges of the window 12 to continue the trajectory 550b. In another aspect, as noted above, the squeegee blade 290 optionally is in continuous contact with the window 12 throughout the treatment trajectory 550b such that the squeegee blade 290 traverses most or all of the window area without leaving the window 12.

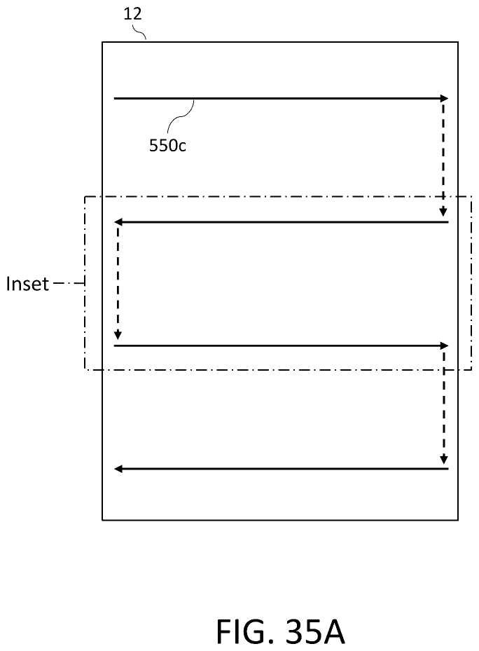

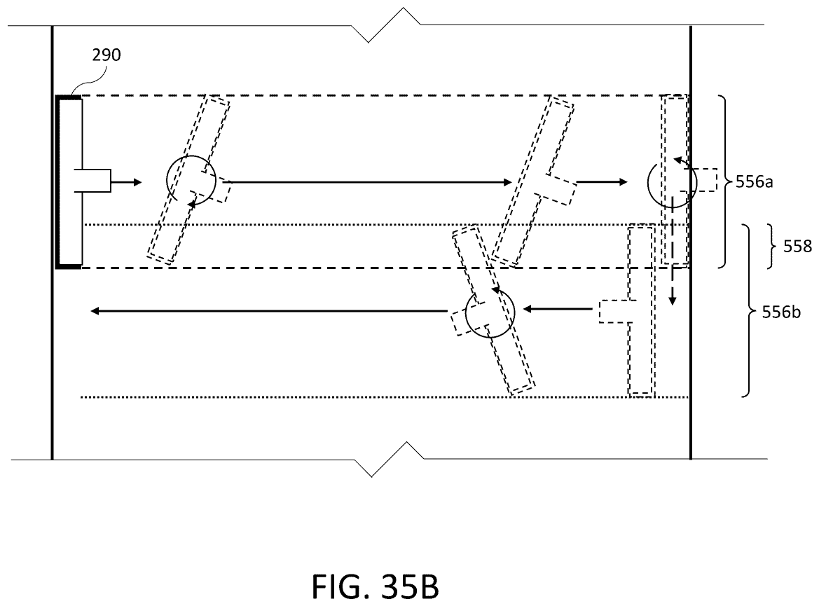

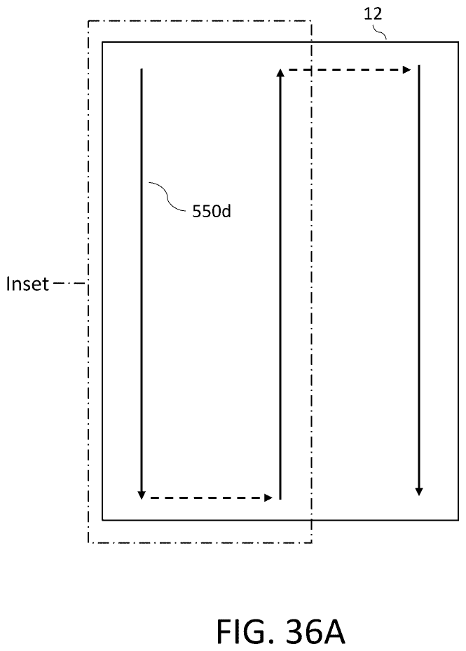

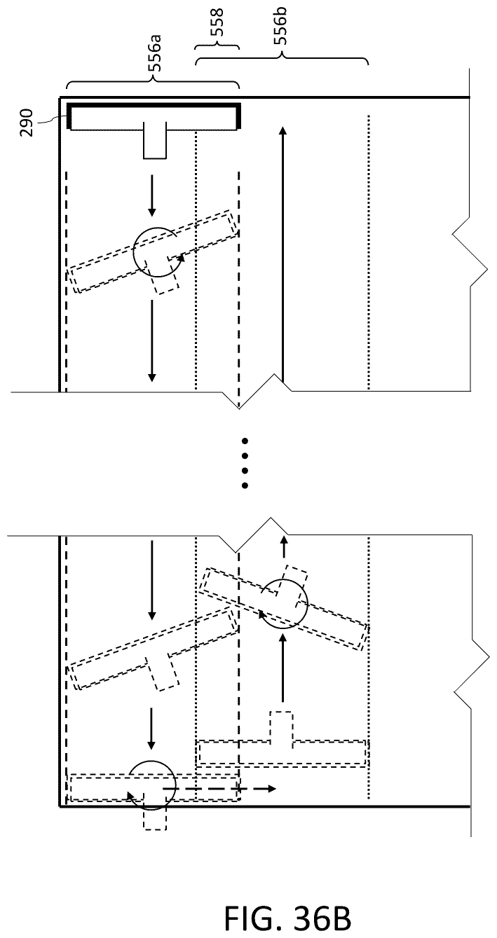

It should be appreciated that the trajectories discussed above in connection with FIGS. 34A, B and C are non-limiting examples and that the aerobot 200 may use other trajectories to remove waste fluid 341. For example, FIG. 35A shows an example trajectory 550c where a squeegee end effector removes waste fluid 341 by moving horizontally across the window 12. Once the squeegee end effector reaches one side, the aerobot 200 moves downwards and the squeegee end effector is rotated and moved in the opposite direction towards the opposing side. FIG. 35B shows a magnified view of a squeegee blade 290 of the squeegee end effector following a portion of the trajectory 550c of FIG. 35A. FIG. 36A shows another example trajectory 550d where a squeegee end effector removes waste fluid 341 by moving vertically across the window 12. For example, if the squeegee end effector is moved downwards, once it reaches the bottom side of the window 12, the aerobot 200 moves horizontally and the squeegee end effector is rotated and moved upwards to the top side of the window 12. The upward motion of the squeegee 290 may be facilitated, in part, by the presence of vacuum suction to remove waste fluid 341. FIG. 36B shows a magnified view of a squeegee blade 290 of the squeegee end effector following a portion of the trajectory 550d of FIG. 36A.

### 3.2 Example Control Loop Systems

The operation of the aerobot 200 and the umbilical support system 400 may be facilitated, in part, by use of a closed loop feedback control system.

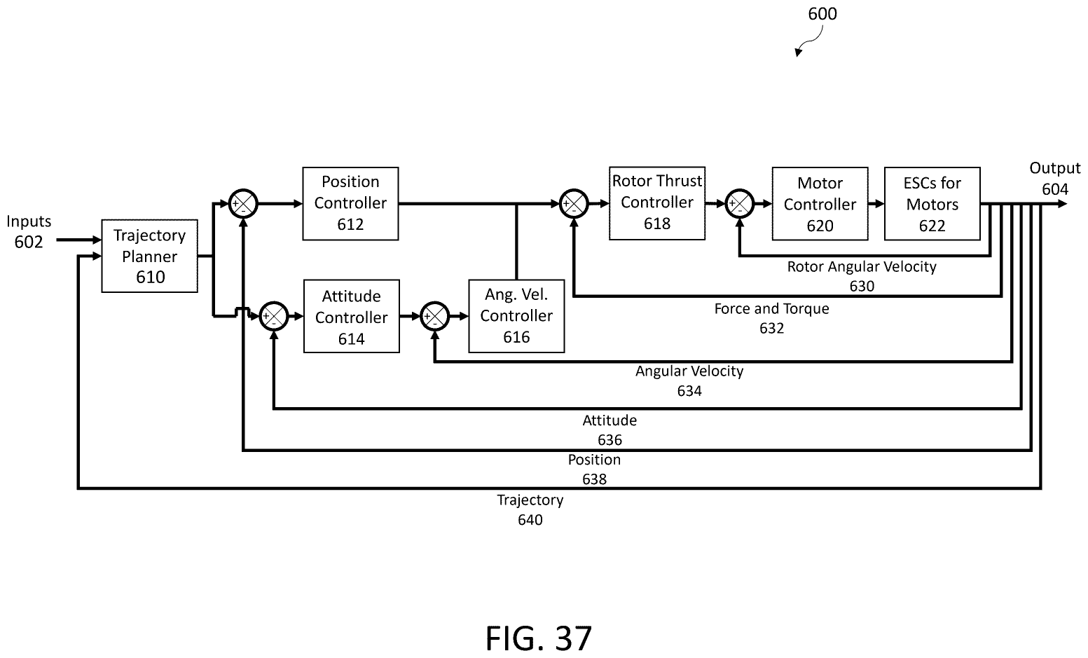

FIG. 37 shows an example control loop diagram 600 for the aerobot 200.

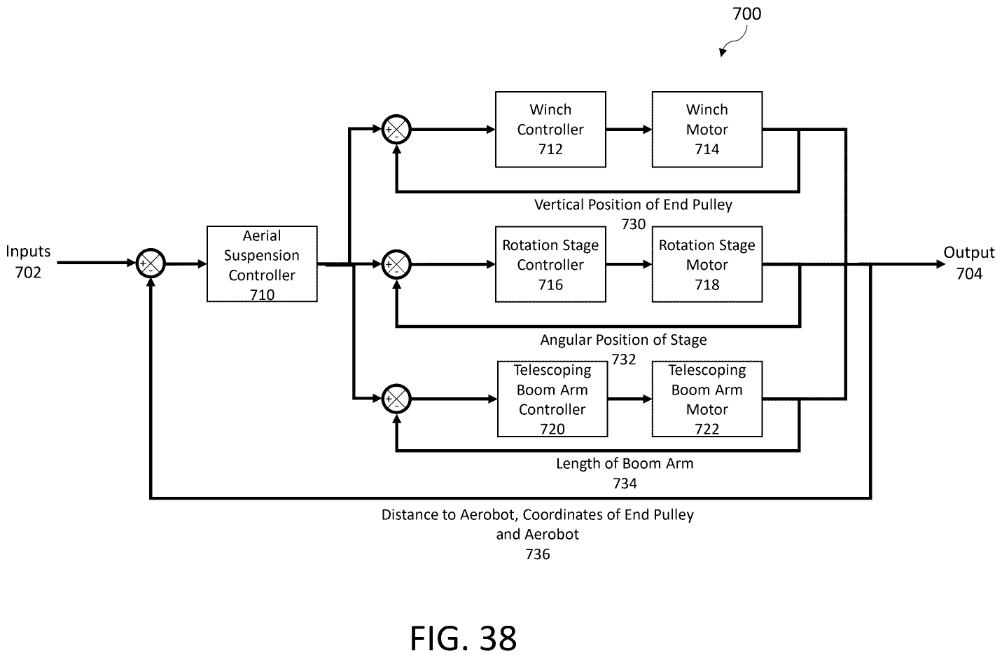

FIG. 38 shows an example control loop diagram 700 for the base station 300a and 300b. It should be appreciated a similar control loop may be used to actuate other mechanisms that affect the position or orientation of an umbilical pulley assembly 436a, 436b or clamp assembly 437, such as the rotors of a support AAV 470 and an aerostat 474, or the pump mechanism of the aerostat 474.

### 3.3 Example Methods

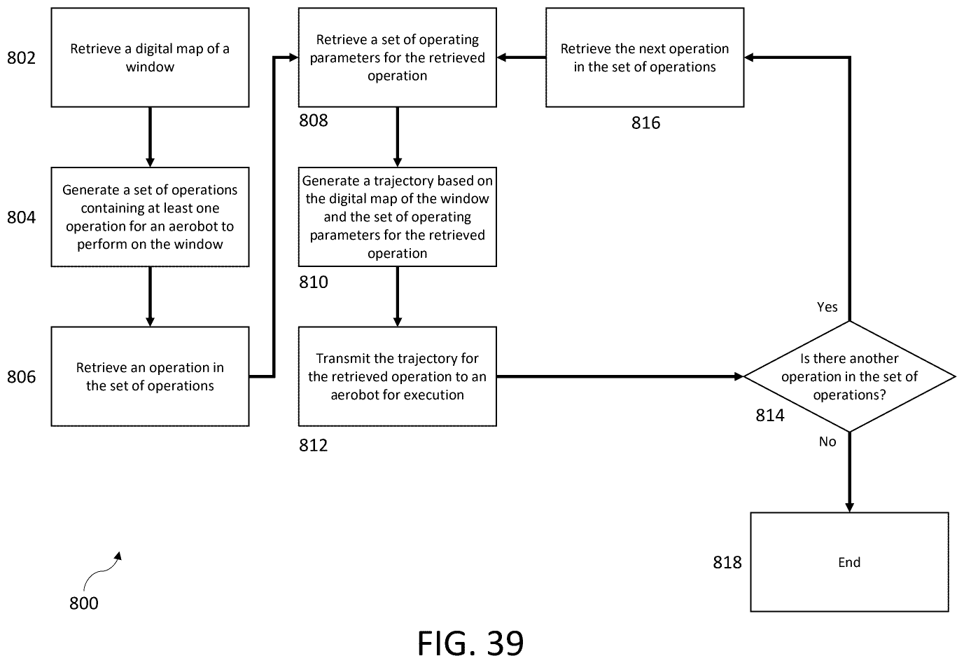

FIG. 39 shows an example method 800 for generating a set of operations for an aerobot 200 to perform on a particular window. The operations may include, but are not limited to, applying cleaning fluid 332 to the window and removing waste fluid 341 from the window.

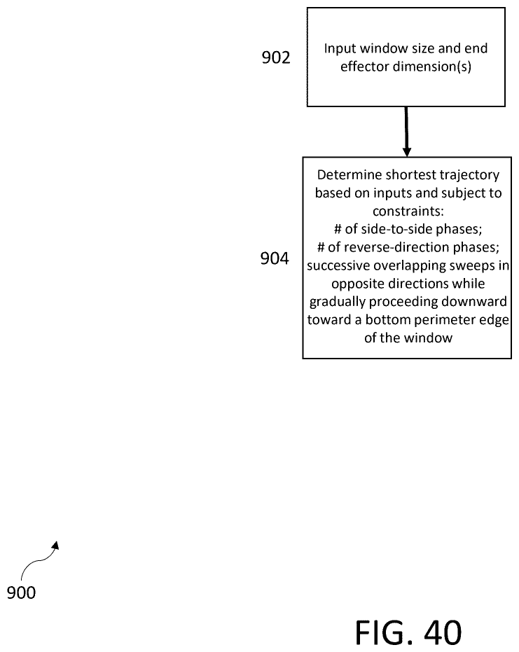

FIG. 40 shows a flow chart diagram 900 for determining a treatment trajectory similar to those shown in FIGS. 34A, B and C.

### 4. CONCLUSION

All parameters, dimensions, materials, and configurations described herein are meant to be example and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the example implementations without departing from the scope of the present disclosure. The use of a numerical range does not preclude equivalents that fall outside the range that fulfill the same function, in the same way, to produce the same result.

The above-described embodiments can be implemented in multiple ways. For example, embodiments may be implemented using hardware, software or a combination thereof. When implemented in software, the software code can be executed on a suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electrical device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in a suitable form, including a local area network or a wide area network, such as an enterprise network, an intelligent network (IN) or the Internet. Such networks may be based on a suitable technology, may operate according to a suitable protocol, and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Some implementations may specifically employ one or more of a particular operating system or platform and a particular programming language and/or scripting tool to facilitate execution.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A roof-based system for washing windows, the system comprising:
an aerial vehicle configured for translational and rotational motion in air with multiple degrees of freedom, the aerial vehicle including a communication subsystem;
at least one end effector coupled to the aerial vehicle to facilitate cleaning of a vertical or inclined window;
an umbilical cord coupled to the aerial vehicle and the at least one end effector to carry at least electrical power to the aerial vehicle and a cleaning fluid to the at least one end effector;
a base station coupled to the umbilical cord and configured to be deployed on a roof of a structure that includes the vertical or inclined window, the base station comprising at least one pump to supply at least the cleaning fluid to the at least one end effector;
an umbilical support system, coupled to the base station, to support the umbilical cord in the air, the umbilical support system including at least one first sensor to obtain first sensor data; and
at least one controller, disposed separately from the aerial vehicle, communicatively coupled to the at least one first sensor and to the aerial vehicle via the communication subsystem, to transmit at least one command to the aerial vehicle to perform at least one action to facilitate the cleaning of the vertical or inclined window based at least in part on the first sensor data obtained by the at least one first sensor.

2. The system of claim 1, wherein the at least one end effector includes at least one of:
an applicator end effector to apply the cleaning fluid to the window; or
a squeegee end effector to remove waste fluid from the window.

3. The system of claim 1, wherein the umbilical support system comprises:
a telescoping boom arm; and
a support assembly coupled to a distal end of the telescoping boom arm to support the umbilical cord, wherein the support assembly includes the at least one first sensor.

4. The system of claim 3, wherein:
the support assembly includes an umbilical pulley assembly; and
the umbilical pulley assembly includes the at least one first sensor.

5. The system of claim 1, further comprising a central control computer, wherein:
the umbilical support system includes an umbilical support system controller;
the base station includes a base station controller; and
the at least one controller includes at least one of the umbilical support system controller, the base station controller, or the central control computer.

6. The system of claim 1, wherein the at least one first sensor comprises at least one of:
a first anemometer; or
a first location tracker.

7. The system of claim 6, wherein:
the at least one first sensor comprises the first anemometer; and
the at least one controller transmits the at least one command to the aerial vehicle to control the aerial vehicle to compensate for wind speed and direction.

8. The system of claim 6, wherein the at least one first sensor comprises the first location tracker, and wherein the first location tracker comprises at least one of:
a first global navigation satellite system (GNSS) receiver; or
a first laser range finder.

9. The system of claim 6, wherein:
the aerial vehicle includes at least one second sensor communicatively coupled to the at least one controller;
the at least one second sensor comprises a second location tracker;
the first location tracker measures a first set of coordinates corresponding to a first location of at least a portion of the umbilical support system; and
the second location tracker measures a second set of coordinates corresponding to a second location of the aerial vehicle.

10. The system of claim 9, wherein:
the at least one controller is communicatively coupled to the umbilical support system and adjusts a position of the umbilical support system relative to the aerial vehicle based at least in part on the first set of coordinates and the second set of coordinates.

11. The system of claim 9, wherein the at least one second sensor further comprises at least one of:
an inertial measurement unit (IMU);
an imaging system;
a temperature sensor;
a relative humidity sensor; or
a pressure sensor.

12. The system of claim 1, wherein the at least one first sensor comprises at least one of:
a first inertial measurement unit (IMU); or
a first imaging system.

13. The system of claim 12, wherein the umbilical support system comprises:
a telescoping boom arm; and
a support assembly coupled to a distal end of the telescoping boom arm to support the umbilical cord, wherein the support assembly includes the at least one first sensor.

14. The system of claim 13, further comprising a central control computer, wherein:
the umbilical support system includes an umbilical support system controller;
the base station includes a base station controller; and
the at least one controller includes at least one of the umbilical support system controller, the base station controller, or the central control computer.

15. A system, comprising:
an aerial vehicle configured for translational and rotational motion in air with multiple degrees of freedom, the aerial vehicle including a communication subsystem;
at least one end effector coupled to the aerial vehicle to facilitate treatment of a vertical or inclined surface;
an umbilical cord coupled to the aerial vehicle to carry at least electrical power to the aerial vehicle;
an umbilical support system to support the umbilical cord in air, the umbilical support system including at least one first sensor to obtain first sensor data; and
at least one controller, disposed separately from the aerial vehicle, communicatively coupled to the at least one first sensor and to the aerial vehicle via the communication subsystem, to transmit at least one command to the aerial vehicle to perform at least one action to facilitate the treatment of the vertical or inclined surface based at least in part on the first sensor data obtained by the at least one first sensor.

16. The system of claim 15, wherein the aerial vehicle comprises:
an autonomous aerial vehicle configured for translational and rotational motion with six degrees of freedom (6-DOF AAV).

17. The system of claim 15, wherein:
the vertical or inclined surface includes a window;
the treatment of the window includes cleaning the window;
the at least one end effector includes at least one of:
an applicator end effector to apply a cleaning fluid to the window; or
a squeegee end effector to remove waste fluid from the window; and
the umbilical cord is further coupled to the at least one end effector and carries the electrical power and the cleaning fluid to the aerial vehicle.

18. The system of claim 17, further comprising a base station coupled to the umbilical cord, the base station comprising at least one pump to supply at least the cleaning fluid to the applicator end effector.

19. The system of claim 18, wherein the umbilical support system is coupled to the base station.

20. The system of claim 18, further comprising a central control computer, wherein:
the umbilical support system includes an umbilical support system controller;
the base station includes a base station controller; and
the at least one controller includes at least one of the umbilical support system controller, the base station controller, or the central control computer.

21. The system of claim 15, wherein the at least one first sensor comprises at least one of:
a first anemometer; or
a first location tracker.

22. The system of claim 21, wherein:
the at least one first sensor comprises the first anemometer; and
the at least one controller transmits the at least one command to the aerial vehicle to control the aerial vehicle to compensate for wind speed and direction.

23. The system of claim 21, wherein the at least one first sensor comprises the first location tracker, and wherein the first location tracker comprises at least one of:
a first global navigation satellite system (GNSS) receiver; or
a first laser range finder.

24. The system of claim 21, wherein:
the aerial vehicle includes at least one second sensor communicatively coupled to the at least one controller;
the at least one second sensor comprises a second location tracker;
the first location tracker measures a first set of coordinates corresponding to a first location of at least a portion of the umbilical support system; and
the second location tracker measures a second set of coordinates corresponding to a second location of the aerial vehicle.

25. The system of claim 24, wherein:
the at least one controller is communicatively coupled to the umbilical support system and adjusts a position of the umbilical support system relative to the aerial vehicle based at least in part on the first set of coordinates and the second set of coordinates.

26. The system of claim 24, wherein the at least one second sensor further comprises at least one of:
an inertial measurement unit (IMU);
an imaging system;
a temperature sensor;
a relative humidity sensor; or
a pressure sensor.

27. The system of claim 15, wherein the at least one first sensor comprises at least one of:
a first inertial measurement unit (IMU); or
a first imaging system.

28. The system of claim 15, wherein the umbilical support system is configured carry and suspend the umbilical cord above the aerial vehicle during operation or the aerial vehicle.

29. The system of claim 28, wherein the umbilical support system comprises:
a telescoping boom arm; and
a support assembly coupled to a distal end of the telescoping boom arm to support the umbilical cord.

30. The system of claim 29, wherein the support assembly includes the at least one first sensor.

31. The system of claim 30, wherein:
the support assembly includes an umbilical pulley assembly; and
the umbilical pulley assembly includes the at least one first sensor.

32. The system of claim 30, wherein the at least one first sensor comprises at least one of:
an anemometer; or
a location tracker.

33. The system of claim 32, wherein the at least one first sensor comprises the location tracker, and wherein the location tracker comprises at least one of:
a global navigation satellite system (GNSS) receiver; or
a laser range finder.

34. The system of claim 30, wherein the at least one first sensor comprises at least one of:
an inertial measurement unit (IMU); or
an imaging system.

35. The system of claim 15, wherein the umbilical support system is coupled to a roof of a structure that includes the vertical or inclined surface.

36. The system of claim 35, wherein the umbilical support system comprises:
a telescoping boom arm; and
a support assembly coupled to a distal end of the telescoping boom arm to support the umbilical cord, wherein the support assembly includes the at least one first sensor.

37. The system of claim 36, wherein:
the vertical or inclined surface includes a window;
the treatment of the window includes cleaning the window;
the at least one end effector includes at least one of:
an applicator end effector to apply a cleaning fluid to the window; or
a squeegee end effector to remove waste fluid from the window; and
the umbilical cord is further coupled to the at least one end effector and carries the electrical power and the cleaning fluid to the aerial vehicle.

38. The system of claim 37, wherein the at least one first sensor comprises at least one of:
a first anemometer; or
a first location tracker.

39. The system of claim 38, wherein:
the at least one first sensor comprises the first anemometer; and
the at least one controller transmits the at least one command to the aerial vehicle to control the aerial vehicle to compensate for wind speed and direction.

40. The system of claim 38, wherein the at least one first sensor comprises the first location tracker, and wherein the first location tracker comprises at least one of:
a first global navigation satellite system (GNSS) receiver; or
a first laser range finder.

41. The system of claim 38, wherein:
the aerial vehicle includes at least one second sensor communicatively coupled to the at least one controller;
the at least one second sensor comprises a second location tracker;
the first location tracker measures a first set of coordinates corresponding to a first location of at least a portion of the umbilical support system; and
the second location tracker measures a second set of coordinates corresponding to a second location of the aerial vehicle.

42. The system of claim 41, wherein:
the at least one controller is communicatively coupled to the umbilical support system and adjusts a position of the umbilical support system relative to the aerial vehicle based at least in part on the first set of coordinates and the second set of coordinates.

43. The system of claim 41, wherein the at least one second sensor further comprises at least one of:
an inertial measurement unit (IMU);
an imaging system;
a temperature sensor;
a relative humidity sensor; or
a pressure sensor.

44. The system of claim 37, wherein the at least one first sensor comprises at least one of:
an inertial measurement unit (IMU); or
an imaging system.

45. The system of claim 37, further comprising a base station coupled to the umbilical cord, the base station comprising at least one pump to supply at least the cleaning fluid to the applicator end effector.

46. The system of claim 45, wherein:
the base station is disposed on the roof of the structure; and
the umbilical support system is coupled to the base station.

47. The system of claim 45, further comprising a central control computer, wherein:
the umbilical support system includes an umbilical support system controller;
the base station includes a base station controller, and
the at least one controller includes at least one of the umbilical support system controller, the base station controller, or the central control computer.
